(19) United States
(12) Patent Application Publication
(10) Pub. No.: US 2026/0113077 A1
(43) Pub. Date: Apr. 23, 2026

(54) POWER SAVING IN RECONFIGURABLE INTELLIGENT SURFACE (RIS) -BASED SENSING

(71) Applicant: QUALCOMM Incorporated, San Diego, CA (US)

(72) Inventors: Min HUANG, Beijing (CN); Chao WEI, Beijing (CN); Hao XU, Beijing (CN)

(21) Appl. No.: 19/114,399

(22) PCT Filed: Nov. 9, 2023
(86) PCT No.: PCT/CN2023/130766

§ 371 Date: Mar. 21, 2025

(30) Foreign Application Priority Data
Nov. 18, 2022 (WO) PCT/CN2022/132746

(51) Int. Cl. H04B 7/04; H04W 52/02

(52) U.S. Cl. CPC H04B 7/04013; H04W 52/0203

(57) ABSTRACT

Disclosed are systems, apparatuses, processes, and computer-readable media for wireless communications. For example, a reconfigurable intelligent surface (RIS) can receive a start RIS working mode configuration message comprising an indication to start a power saving mode. The RIS can configure, based on the power saving mode, a meta-element configuration for meta-elements of the RIS from a set of meta-element configurations.

### FIELD OF THE DISCLOSURE

The present disclosure generally relates to wireless communications. For example, aspects of the present disclosure relate to power saving in reconfigurable intelligent surface (RIS)-based sensing.

### BACKGROUND OF THE DISCLOSURE

Wireless communications systems are widely deployed to provide various types of communication content, such as voice, video, packet data, messaging, and broadcast. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). Some wireless communications systems may support communications between UEs, which may involve direct transmissions between two or more UEs.

Due to larger bandwidths being allocated for wireless cellular communications systems (e.g., including 5G and 5G beyond) and more use cases being introduced into the cellular communications systems, multiplexing sensing and communication signals for joint communications and sensing can be an essential feature for existing or future wireless communication systems, such as to enhance the overall spectral efficiency of the wireless communication networks.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for wireless communications. According to at least one example, a method of wireless communication at a reconfigurable intelligent surface (RIS) is provided. The method includes: receiving, by the RIS, a start RIS working mode configuration message comprising an indication to start a power saving mode; and configuring, by the RIS based on the power saving mode, a meta-element configuration for meta-elements of the RIS from a set of meta-element configurations.

In another illustrative example, a reconfigurable intelligent surface (RIS) for wireless communication is provided. The RIS includes at least one memory and at least one processor coupled to the at least one memory and configured to: receive a start RIS working mode configuration message comprising an indication to start a power saving mode; and configure, based on the power saving mode, a meta-element configuration for meta-elements of the RIS from a set of meta-element configurations.

In another illustrative example, a non-transitory computer-readable medium of a reconfigurable intelligent surface (RIS) is provided that includes stored thereon at least one instruction that, when executed by one or more processors, may cause the one or more processors to: receive a start RIS working mode configuration message comprising an indication to start a power saving mode; and configure, based on the power saving mode, a meta-element configuration for meta-elements of the RIS from a set of meta-element configurations.

In another illustrative example, an apparatus for wireless communications is provided. The apparatus includes: means for receiving a start RIS working mode configuration message comprising an indication to start a power saving mode; and means for configuring, based on the power saving mode, a meta-element configuration for meta-elements of a reconfigurable intelligent surface (RIS) from a set of meta-element configurations.

In another illustrative example, a method of wireless communication performed at a network device is provided. The method includes: receiving, by the network device, a capability report message from a reconfigurable intelligent surface (RIS); determining, by the network device, for the RIS to start a power saving mode based on the capability report message; and transmitting, by the network device, a start RIS working mode configuration message comprising an indication to the RIS to start the power saving mode.

In another illustrative example, a network device for wireless communication is provided. The network device includes at least one memory and at least one processor coupled to the at least one memory and configured to: receive a capability report message from a reconfigurable intelligent surface (RIS); determine for the RIS to start a power saving mode based on the capability report message; and output for transmission a start RIS working mode configuration message comprising an indication to the RIS to start the power saving mode.

In another illustrative example, a non-transitory computer-readable medium of a network device is provided that includes stored thereon at least one instruction that, when executed by one or more processors, may cause the one or more processors to: receive a capability report message from a reconfigurable intelligent surface (RIS); determine for the RIS to start a power saving mode based on the capability report message; and output for transmission a start RIS working mode configuration message comprising an indication to the RIS to start the power saving mode.

In another illustrative example, an apparatus for wireless communications is provided. The apparatus includes: means for receiving a capability report message from a reconfigurable intelligent surface (RIS); means for determining for the RIS to start a power saving mode based on the capability report message; and means for transmitting a start RIS working mode configuration message comprising an indication to the RIS to start the power saving mode.

In some aspects, the network devices or apparatuses described herein is, is part of, and/or includes a UE, such as a wearable device, an extended reality (XR) device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a diagram illustrating an example wireless communications system, which may be employed by the disclosed systems and techniques for power saving in RIS-based sensing, in accordance with some aspects of the present disclosure.

FIG. 2 is a diagram illustrating an example of a disaggregated base station architecture, which may be employed by the disclosed systems and techniques for power saving in RIS-based sensing, in accordance with some aspects of the present disclosure.

FIG. 3 is a diagram illustrating an example of a frame structure, which may be employed by the disclosed systems and techniques for power saving in RIS-based sensing, in accordance with some aspects of the present disclosure.

FIG. 4 is a block diagram illustrating an example of a computing system of an electronic device that may be employed by the disclosed systems and techniques for power saving in RIS-based sensing, in accordance with some aspects of the present disclosure.

FIG. 5 is a diagram illustrating an example of a wireless device utilizing radio frequency (RF) monostatic sensing techniques, which may be employed by the disclosed systems and techniques described herein to determine one or more characteristics of a target object, in accordance with some aspects of the present disclosure.

FIG. 6 is a diagram illustrating an example of a receiver utilizing RF bistatic sensing techniques with one transmitter, which may be employed by the disclosed systems and techniques described herein to determine one or more characteristics of a target object, in accordance with some aspects of the present disclosure.

FIG. 7 is a diagram illustrating an example of a receiver utilizing RF bistatic sensing techniques with multiple transmitters, which may be employed by the disclosed systems and techniques described herein to determine one or more characteristics of a target object, in accordance with some aspects of the present disclosure.

FIG. 8 is a diagram illustrating an example geometry for bistatic (or monostatic) sensing, in accordance with some aspects of the present disclosure.

FIG. 9 is a diagram illustrating a bistatic range of bistatic sensing, in accordance with some aspects of the present disclosure.

FIG. 10A is a diagram illustrating an example of a system for performing RIS-assisted communication, in accordance with some aspects of the present disclosure.

FIG. 10B is a diagram illustrating an example of a system for performing RIS-assisted sensing, in accordance with some aspects of the present disclosure.

FIG. 11A is a diagram illustrating an example of a system for sensing with a line of sight (LOS) blockage, in accordance with some aspects of the present disclosure.

FIG. 11B is a diagram illustrating an example of a system for sensing with insufficient coverage, in accordance with some aspects of the present disclosure.

FIG. 11C is a diagram illustrating an example of a system for sensing with insufficient reference anchor points, in accordance with some aspects of the present disclosure.

FIG. 11D is a diagram illustrating an example of a system for sensing with insufficient spatial resolution, in accordance with some aspects of the present disclosure.

FIG. 12A is a diagram illustrating an example of a system for power saving in RIS-based sensing overcoming a LOS blockage, in accordance with some aspects of the present disclosure.

FIG. 12B is a diagram illustrating an example of a system for power saving in RIS-based sensing with sufficient coverage, in accordance with some aspects of the present disclosure.

FIG. 12C is a diagram illustrating an example of a system for power saving in RIS-based sensing with sufficient reference anchor points, in accordance with some aspects of the present disclosure.

FIG. 12D is a diagram illustrating an example of a system for power saving in RIS-based sensing with sufficient spatial resolution, in accordance with some aspects of the present disclosure.

FIG. 13A is a diagram illustrating an example of general model for a RIS that may be employed by the disclosed systems and techniques for power saving in RIS-based sensing, in accordance with some aspects of the present disclosure.

FIG. 13B is a diagram illustrating an example of far-field model for the RIS of FIG. 13A, in accordance with some aspects of the present disclosure.

FIG. 13C is a table illustrating example phase shifts and magnitude responses for different configurations of the RIS of FIGS. 13A and 13B, in accordance with some aspects of the present disclosure.

FIG. 13D is a diagram illustrating an example of a scene in which a refractive RIS is used to direct a communication signal from a network device to a first target object and a second target object, in accordance with some aspects of the present disclosure.

FIG. 13E is a diagram illustrating an example of far-field model for a refractive (or transmissive) RIS, in accordance with some aspects of the present disclosure.

FIG. 13F is a diagram illustrating an example of near-field model for a refractive (or transmissive) RIS, in accordance with some aspects of the present disclosure.

FIG. 13G is an example of a refractive/transmissive RIS used as an outside radar to sense an object on the inside of a building, in accordance with some aspects of the present disclosure.

FIG. 13H and FIG. 13I are diagrams illustrating differences between reflective and refractive/transmissive RISs, in accordance with some aspects of the present disclosure.

FIG. 14 is table illustrating example states (e.g., ON-state and OFF-state) of PIN diodes for different configurations of the RIS of FIGS. 13A and 13B, in accordance with some aspects of the present disclosure.

FIG. 15 is a diagram showing an example of signaling that may be utilized for a system for power saving in RIS-based sensing, where the signaling is for starting a RIS power saving mode, in accordance with some aspects of the present disclosure.

FIG. 16 is a diagram showing an example of signaling that may be utilized for a system for power saving in RIS-based sensing, where the signaling is for stopping the RIS power saving mode, in accordance with some aspects of the present disclosure.

FIG. 17 is a diagram showing an example of signaling that may be utilized for a system for power saving in RIS-based sensing, where the signaling is for configuring a maximum percentage threshold, in accordance with some aspects of the present disclosure.

FIG. 18A is a flow chart illustrating an example of a process for wireless communications at a RIS utilizing methods for power saving in RIS-based sensing, in accordance with some aspects of the present disclosure.

FIG. 18B is a flow chart illustrating an example of a process for wireless communications at a network device based on methods for power saving in RIS-based sensing, in accordance with some aspects of the present disclosure.

FIG. 19 is a block diagram illustrating an example of a computing system, which may be employed by the disclosed systems and techniques for power saving in RIS-based sensing, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Radar sensing systems use radio frequency (RF) waveforms to perform RF sensing to determine or estimate one or more characteristics of a target object, such as the distance, angle, and/or velocity of the target object. A target object may include a vehicle, an obstruction, a user, a building, or other object. A typical radar system includes at least one transmitter, at least one receiver, and at least one processor. A radar sensing system may perform monostatic sensing when one receiver is employed that is co-located with a transmitter. A radar system may perform bistatic sensing when one receiver of a first device is employed that is located remote from a transmitter of a second device. Similarly, a radar system may perform multi-static sensing when multiple receivers of multiple devices are employed that are all located remotely from at least one transmitter of at least one device.

During operation of a radar sensing system, a transmitter transmits an electromagnetic (EM) signal in the RF domain towards a target object. The signal reflects off of the target object to produce one or more reflection signals, which provides information or properties regarding the target, such as target object's location and speed. At least one receiver receives the one or more reflection signals and at least one processor, which may be associated with at least one receiver, utilizes the information from the one or more reflection signals to determine information or properties of the target object. A target object can also be referred herein as a target.

Generally, RF sensing involves monitoring moving targets with different motions (e.g., a moving car or pedestrian, a body motion of a person, such as breathing, and/or other micro-motions related to a target). Doppler, which measures the phase variation in a signal and is indicative of motion, is an important characteristic for sensing of a target.

In some cases, the radar sensing signals, which can be referred to as radar reference signals (RSs), such as sensing reference signals (S-RS), may be designed for and used for sensing purposes. Radar RSs do not contain any communications information. Conversely, communication RSs, such as demodulation reference signals (DMRSs), are typically designed for and solely used for communications purposes, such as estimating channel parameters for communications.

Cellular communications systems are designed to transmit communication signals on designated communication frequency bands (e.g., 23 gigahertz (GHz), 3.5 GHz, etc. for 5G/NR, 2.2 GHz for LTE, among others). RF sensing systems are designed to transmit RF sensing signals on designated radar RF frequency bands (e.g., 77 GHz for autonomous driving). The spectrum for communications and sensing is very likely to be shared in future cellular communication systems, in which case the communications and sensing should be jointly considered.

In some cases, due to larger bandwidths being allocated for wireless communications systems (e.g., including cellular communications systems such as 4G/LTE, 5G/NR, and beyond) and more use cases being introduced into the wireless communications systems, multiplexing (e.g., via time division multiplexing and/or frequency division multiplexing) sensing and communication signals for joint communications and sensing can be an essential feature for existing or future wireless communication systems. Simultaneously performing wireless communications and radar sensing can provide for a cost-efficient deployment for both radar and communication systems.

Joint communications and radar sensing can provide for mutual performance gains. For example, sensing information, such as Doppler measurements, can be used to improve communication link quality (e.g., Sensing-assisted Communications). Also, cooperative sensing can be more feasible with wireless communication networks (e.g., Communication-assisted Sensing).

Integrated sensing and communication (ISAC), which uses multiplexed sensing and communication signals, can be regarded as a key 5G, as well as sixth generation (6G), feature by the cellular industry. ISAC can provide cost effectiveness by utilizing shared RF, and possibly baseband, hardware (HW) for both sensing and communications. ISAC can also provide spectrum effectiveness by providing an always-on availability of the spectrum for both sensing and communications use cases. ISAC can be utilized for a variety of different use cases including, but not limited to, macro sensing (e.g., meteorological monitoring; autonomous driving; dynamic mapping; low-altitude airspace, such as an unmanned air vehicle, management; and intruder detection), micro sensing (e.g., gesture recognition, vital sign detection, and high-resolution imaging using terahertz signals), and sensing-assisted communication (e.g., beam management). Some contributions in 3GPP for ISAC have already been made. For example, some companies have proposed some requirements and network architecture for ISAC in 3GPP standalone 1 (SA1). In addition, in China, international mobile telecommunications (IMT)-2020 and IMT-2030 are promoting ISAC for 5G-A and 6G.

A reconfigurable intelligent surface (RIS) may be employed for sensing and/or communications. Traditionally, reconfigurable intelligent surfaces (RISs) have been utilized for communications. However, RISs may also be employed to assist in sensing of one or more objects (e.g., to determine a position, location, and/or other characteristic of the one or more object) for ISAC systems. RIS-assisted sensing may require a higher accuracy (e.g., higher precision) of the RIS position than needed for RIS-assisted communications.

RISs can shape the wireless environment to a desirable form at low cost. In practice, RISs have three types of implementations, which include reflective (e.g., where signals can be reflected by the RIS), transmissive (e.g., where signals can penetrate the RIS), and hybrid (e.g., where the RIS may have a dual function of reflection and transmission).

A RIS is a programmable array structure that can be used to control the propagation of electromagnetic (EM) waves (e.g., steering the RF beam) by changing the electric and magnetic properties of the surface of the RIS. The RIS includes an array of metamaterial RIS elements (e.g., which may be referred to as meta-elements), which are composed of ultra-thin surfaces inlaid with multiple wavelength scatters. The electromagnetic properties of the RIS elements can be dynamically controlled by applying a control signal to tunable elements (e.g., PIN diodes, varactor diodes, and/or other tunable elements) on the RIS elements, which can enable active and intelligent modulation of electromagnetic waves in a programmable manner to form electromagnetic fields with controllable amplitude, phase, polarization, and/or frequency. For example, an electromagnetic response (e.g., a phase shift, which steers the RF beam) of the RIS elements can be controlled by programmable PIN diodes.

Traditional sensing without the use of a RIS can present many challenges, which may include, but are not limited to, a limited coverage distance due to an in-return transmission, a coverage hole (e.g., a hole in the coverage area) when there is no line of sight (LOS) link between the network device (e.g., a base station) and the target, and an insufficient number of positioning reference points because one network device (e.g., a base station) can only provide a single reference point. Employing a RIS to assist in sensing (e.g., RIS-based sensing) can provide many benefits including, but not limited to, extending the coverage distance by using RIS beamforming, eliminating a coverage hole by the RIS operating as a relay (e.g., the RIS may be flexibly deployed to have a LOS link to the coverage hole of the base station), and adding an additional reference point for the position of the RIS.

As previously mentioned, a RIS may operate as a relay that reflects and/or refracts sensing signals (e.g., originally radiated from a transmitter, such as a base station) to produce reflection (for reflective or hybrid RISs) and/or refraction (for refractive or hybrid RISs) beams that are directed towards the target objects for the sensing by a receiver (e.g., user equipment) of those target objects. For a reflective RIS, reflection coefficients of the meta-elements of the RIS can control the direction of the propagation of the reflection beams. For a refractive RIS, refractive coefficients (also referred to as transmissive coefficients) of the meta-elements of the RIS can control the direction of the refraction/transmission of the refractive beams. The amplitude and phase of a reflection coefficient and/or a refractive coefficient at each meta-element can vary with frequency. The amplitude/phase of the reflection and/or refractive coefficients versus the frequency characteristics can depend upon the RIS hardware structure (e.g., a RIS including meta-elements realized by PIN diodes or varactor diodes).

A RIS may operate as a passive device (e.g., where the RIS does not consume power in active radio wave radiation). Although the RIS may operate as a passive device, the RIS may consume power in meta-element operations. A varactor-diode-based meta-element (e.g., a unit cell) consumes almost no power. However, a PIN-diode-based meta-element may consume power dependent upon the PIN diode state (e.g., an ON-state or an OFF-state). When the PIN diode state is OFF (e.g., OFF-state), the consumed power may be negligible for each meta-element. When the PIN diode state is ON (e.g., ON-state), the consumed power can be approximately 0.33 milliwatts (mW) per meta-element.

For purposes of “green communication” (e.g., for reducing carbon emissions) or to extend the battery usage time, a “power-saving mode” should be configured for RIS-based sensing. Traditional power saving in an antenna array panel involves using less antenna elements than the total number of antenna elements in the antenna array panel (e.g., by switching off some of the antenna elements within the antenna array panel). However, employing a similar power saving approach in a RIS (e.g., using less meta-elements in the RIS panel, for example, by switching off some of the meta-elements in the RIS) would greatly reduce the beamforming gain (e.g., reduce the beamforming gain by 3 decibels (dB) for every decreasing half of the meta-elements).

In one or more aspects of the present disclosure, systems, apparatuses, methods (also referred to as processes), and computer-readable media (collectively referred to herein as “systems and techniques”) are described herein that provide solutions for power saving in RIS-based sensing. The solutions can provide a power saving method for meta-elements (e.g., PIN-diode-based meta-elements) of a RIS. This power saving method allows for all of the meta-elements to be utilized, while avoiding a large beamforming gain loss.

In some examples of these solutions, in RIS-based sensing, where the RIS is constructed of diode-based meta-elements (e.g., PIN-diode-based meta-elements), each meta-element can have two working modes (e.g., a normal mode and a power saving mode) based on power consumption values. In the normal mode, all configurations for the meta-elements of the RIS are available. For example, the normal mode may be used in a target object position measurement phase. In the power saving mode, one set of configurations for the meta-elements with a small number (or percentage) of ON-state PIN diodes are available, while another set of configurations with a large number (or percentage) of ON-state PIN diodes are unavailable. For example, the power saving mode may be used in a target object existence detection phase.

The systems and techniques thus provide a RIS power saving working mode (e.g., only using low-power configurations with a small number or percentage of ON-state PIN diodes) for each meta-element of the RIS. Protocol and signaling designs are provided for this RIS power saving working mode. Operating a RIS using this RIS power saving working mode can greatly reduce the RIS power consumption with only a slight beamforming gain loss (e.g., reflection beamforming gain loss).

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical Transmission-Reception Point (TRP) or to multiple physical Transmission-Reception Points (TRPs) that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal includes an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

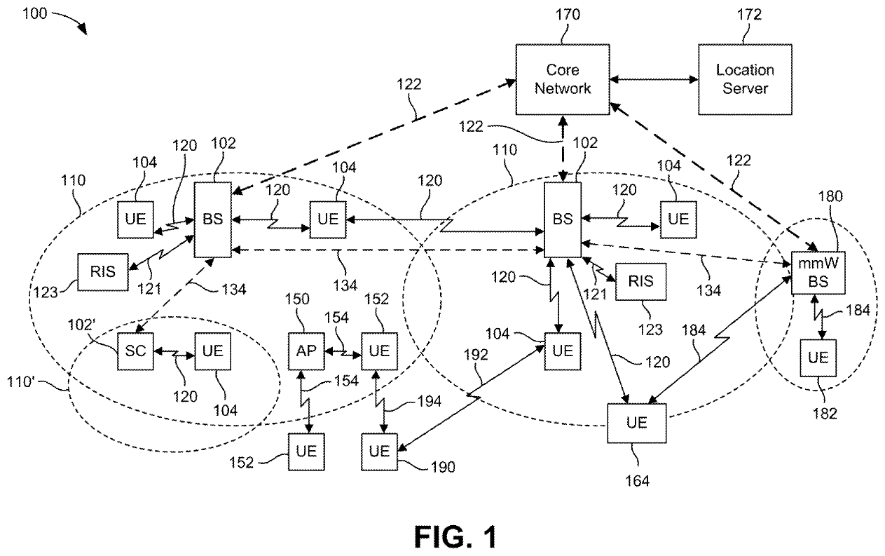

According to various aspects, FIG. 1 illustrates an exemplary wireless communications system 100, which may be employed by the disclosed systems and techniques described herein for power saving in RIS-based sensing. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The base stations 102 may communicate with one or more reconfigurable intelligent surfaces (RISs) 123 via a communications link 121. As described herein, a RIS can be employed for communications and/or for sensing (e.g., to determine a position, location, and/or other characteristic of the one or more object). The RIS 123 can include a programmable array structure that can be used to control the propagation of electromagnetic (EM) waves (e.g., by steering RF beams from the base stations 102) by changing the electric and magnetic properties of the surface of the RIS 123. For instance, the RIS 123 can include an array of metamaterial RIS elements (or meta-elements) that are made up of ultra-thin surfaces inlaid with multiple wavelength scatters. The electromagnetic properties of the RIS elements can be dynamically controlled by applying a control signal to tunable elements (e.g., PIN diodes, varactor diodes, and/or other tunable elements) on the RIS elements, which can enable active and intelligent modulation of electromagnetic waves in a programmable manner to form electromagnetic fields with controllable amplitude, phase, polarization, and/or frequency. For example, an electromagnetic response (e.g., a phase shift, which steers the RF beam) of the RIS elements can be controlled by programmable PIN diodes.

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on. As noted above, UE 104 and UE 190 can be configured to communicate using sidelink communications. In some cases, a sidelink transmission can include a request for feedback (e.g., a hybrid automatic repeat request (HARQ)) from the receiving UE.

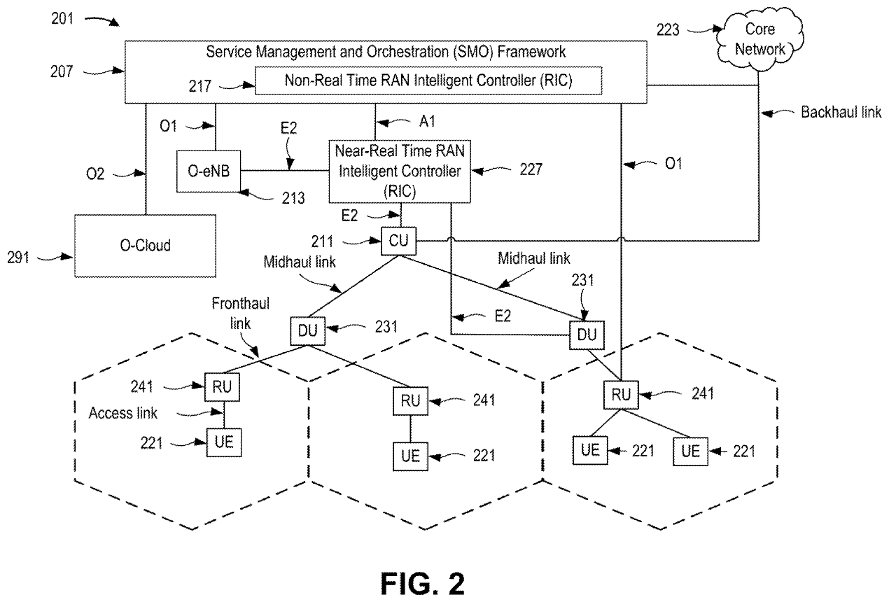

FIG. 2 is a diagram illustrating an example of a disaggregated base station architecture, which may be employed by the disclosed systems and techniques for power saving in RIS-based sensing. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 2 shows a diagram illustrating an example disaggregated base station 201 architecture. The disaggregated base station 201 architecture may include one or more central units (CUs) 211 that can communicate directly with a core network 223 via a backhaul link, or indirectly with the core network 223 through one or more disaggregated base station units (such as a Near-Real Time (Near-RT) RAN Intelligent Controller (RIC) 227 via an E2 link, or a Non-Real Time (Non-RT) RIC 217 associated with a Service Management and Orchestration (SMO) Framework 207, or both). A CU 211 may communicate with one or more distributed units (DUs) 231 via respective midhaul links, such as an F1 interface. The DUs 231 may communicate with one or more radio units (RUS) 241 via respective fronthaul links. The RUs 241 may communicate with respective UEs 221 via one or more RF access links. In some implementations, the UE 221 may be simultaneously served by multiple RUs 241.

Each of the units, i.e., the CUS 211, the DUs 231, the RUs 241, as well as the Near-RT RICs 227, the Non-RT RICs 217 and the SMO Framework 207, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 211 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 211. The CU 211 may be configured to handle user plane functionality (i.e., Central Unit-User Plane (CU-UP)), control plane functionality (i.e., Central Unit-Control Plane (CU-CP)), or a combination thereof. In some implementations, the CU 211 can be logically split into one or more CU-UP units and one or more CU-CP units. The CU-UP unit can communicate bidirectionally with the CU-CP unit via an interface, such as the E1 interface when implemented in an O-RAN configuration. The CU 211 can be implemented to communicate with the DU 231, as necessary, for network control and signaling.

The DU 231 may correspond to a logical unit that includes one or more base station functions to control the operation of one or more RUs 241. In some aspects, the DU 231 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 231 may further host one or more low PHY layers. Each layer (or module) can be implemented with an interface configured to communicate signals with other layers (and modules) hosted by the DU 231, or with the control functions hosted by the CU 211.

Lower-layer functionality can be implemented by one or more RUs 241. In some deployments, an RU 241, controlled by a DU 231, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 241 can be implemented to handle over the air (OTA) communication with one or more UEs 221. In some implementations, real-time and non-real-time aspects of control and user plane communication with the RU(s) 241 can be controlled by the corresponding DU 231. In some scenarios, this configuration can enable the DU(s) 231 and the CU 211 to be implemented in a cloud-based RAN architecture, such as a vRAN architecture.

The SMO Framework 207 may be configured to support RAN deployment and provisioning of non-virtualized and virtualized network elements. For non-virtualized network elements, the SMO Framework 207 may be configured to support the deployment of dedicated physical resources for RAN coverage requirements which may be managed via an operations and maintenance interface (such as an O1 interface). For virtualized network elements, the SMO Framework 207 may be configured to interact with a cloud computing platform (such as an open cloud (O-Cloud) 291) to perform network element life cycle management (such as to instantiate virtualized network elements) via a cloud computing platform interface (such as an O2 interface). Such virtualized network elements can include, but are not limited to, CUs 211, DUs 231, RUs 241 and Near-RT RICs 227. In some implementations, the SMO Framework 207 can communicate with a hardware aspect of a 4G RAN, such as an open eNB (O-eNB) 213, via an O1 interface. Additionally, in some implementations, the SMO Framework 207 can communicate directly with one or more RUs 241 via an O1 interface. The SMO Framework 207 also may include a Non-RT RIC 217 configured to support functionality of the SMO Framework 207.

The Non-RT RIC 217 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 227. The Non-RT RIC 217 may be coupled to or communicate with (such as via an A1 interface) the Near-RT RIC 227. The Near-RT RIC 227 may be configured to include a logical function that enables near-real-time control and optimization of RAN elements and resources via data collection and actions over an interface (such as via an E2 interface) connecting one or more CUs 211, one or more DUs 231, or both, as well as an O-eNB 213, with the Near-RT RIC 227.

In some implementations, to generate AI/ML models to be deployed in the Near-RT RIC 227, the Non-RT RIC 217 may receive parameters or external enrichment information from external servers. Such information may be utilized by the Near-RT RIC 227 and may be received at the SMO Framework 207 or the Non-RT RIC 217 from non-network data sources or from network functions. In some examples, the Non-RT RIC 217 or the Near-RT RIC 227 may be configured to tune RAN behavior or performance. For example, the Non-RT RIC 217 may monitor long-term trends and patterns for performance and employ AI/ML models to perform corrective actions through the SMO Framework 207 (such as reconfiguration via O1) or via creation of RAN management policies (such as A1 policies).

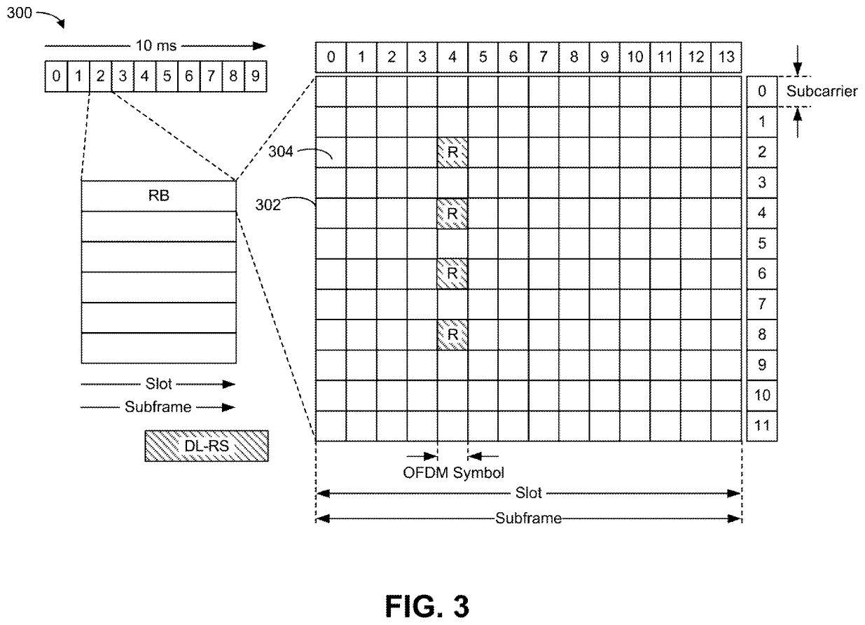

Various radio frame structures may be used to support downlink, uplink, and sidelink transmissions between network nodes (e.g., base stations and UEs). FIG. 3 is a diagram 300 illustrating an example of a frame structure, which may be employed by the disclosed systems and techniques for power saving in RIS-based sensing. Other wireless communications technologies may have different frame structures and/or different channels.

NR (and LTE) utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing, symbol length, etc.). In contrast, NR may support multiple numerologies (p). For example, subcarrier spacing (SCS) of 15 kHz, 30 kHz, 60 kHz, 120 kHz, and 240 kHz or greater may be available. Table 1 provided below lists some various parameters for different NR numerologies.

TABLE 1

| | | | | | | | Max. nominal |
|---|---|---|---|---|---|---|---|
| | | | | | Slot | Symbol | system BW |
| | SCS | Symbols/ | Slots/ | Slots/ | Duration | Duration | (MHz) with |
| | (kHz) | Sot | Subframe | Frame | (ms) | (μs) | 4K FFT size |
| 0 | 15 | 14 | 1 | 10 | 1 | 66.7 | 50 |
| 1 | 30 | 14 | 2 | 20 | 0.5 | 33.3 | 100 |
| 2 | 60 | 14 | 4 | 40 | 0.25 | 16.7 | 100 |
| 3 | 120 | 14 | 8 | 80 | 0.125 | 8.33 | 400 |
| 4 | 240 | 14 | 16 | 160 | 0.0625 | 4.17 | 800 |

In one example, a numerology of 15 kHz is used. Thus, in the time domain, a 10 millisecond (ms) frame is divided into 10 equally sized subframes of 1 ms each, and each subframe includes one time slot. In FIG. 3, time is represented horizontally (e.g., on the X axis) with time increasing from left to right, while frequency is represented vertically (e.g., on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. FIG. 3 illustrates an example of a resource block (RB) 302. Data or information for joint communications and sensing may be included in one or more RBs 302. The RB 302 is arranged with the time domain on the horizontal (or x-) axis and the frequency domain on the vertical (or y-) axis. As shown, the RB 302 may be 180 kilohertz (kHz) wide in frequency and one slot long in time (with a slot being 1 milliseconds (ms) in time). In some cases, the slot may include fourteen symbols (e.g., in a slot configuration 0). The RB 302 includes twelve subcarriers (along the y-axis) and fourteen symbols (along the x-axis).

An intersection of a symbol and subcarrier can be referred to as a resource element (RE) 304 or tone. The RB 302 of FIG. 3 includes multiple REs, including the resource element (RE) 304. For instance, a RE 304 is 1 subcarrier x 1 symbol (e.g., OFDM symbol), and is the smallest discrete part of the subframe. A RE 304 includes a single complex value representing data from a physical channel or signal. The number of bits carried by each RE 304 depends on the modulation scheme.

In some aspects, some REs 304 can be used to transmit downlink reference (pilot) signals (DL-RS). The DL-RS can include Positioning Reference Signal (PRS), Tracking Reference Signal (TRS), Phase Tracking Reference Signal (PTRS), Channel State Information Reference Signal (CSI-RS), Demodulation Reference Signal (DMRS), Primary Synchronization Signal (PSS), Secondary Synchronization Signal (SSS), etc. The resource grid if FIG. 3 illustrates exemplary locations of REs 304 used to transmit DL-RS (labeled “R”).

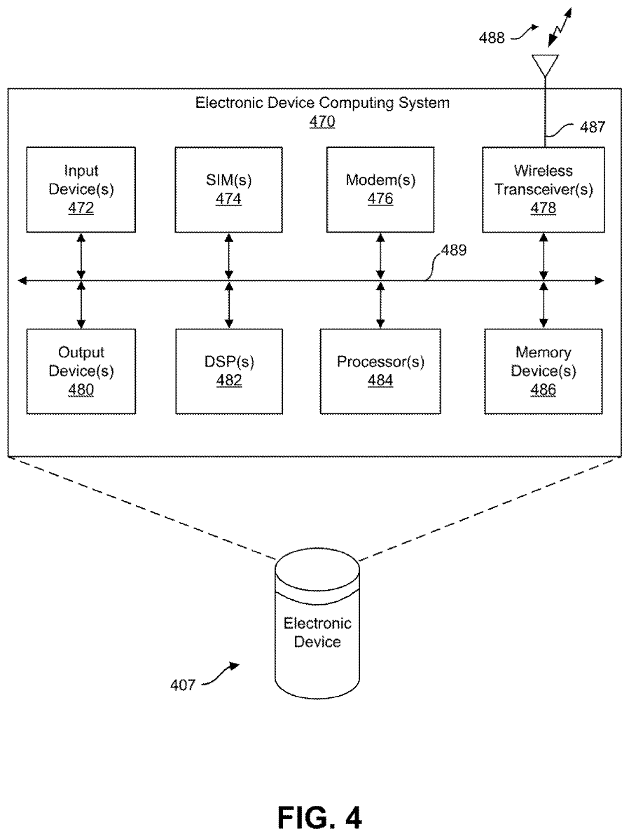

FIG. 4 is a block diagram illustrating an example of a computing system 470 of an electronic device 407, which may be employed by the disclosed systems and techniques for power saving in RIS-based sensing. The electronic device 407 is an example of a device that can include hardware and software for the purpose of connecting and exchanging data with other devices and systems using a communications network (e.g., a 3rd Generation Partnership network, such as a 5th Generation (5G)/New Radio (NR) network, a 4th Generation (4G)/Long Term Evolution (LTE) network, a WiFi network, or other communications network). For example, the electronic device 407 can include, or be a part of, a mobile device (e.g., a mobile telephone), a wearable device (e.g., a network-connected or smart watch), an extended reality device (e.g., a virtual reality (VR) device, an augmented reality (AR) device, or a mixed reality (MR) device), a personal computer, a laptop computer, a tablet computer, an Internet-of-Things (IoT) device, a wireless access point, a router, a vehicle or component of a vehicle, a server computer, a robotics device, and/or other device used by a user to communicate over a wireless communications network. In some cases, the device 407 can be referred to as user equipment (UE), such as when referring to a device configured to communicate using 5G/NR, 4G/LTE, or other telecommunication standard. In some cases, the device can be referred to as a station (STA), such as when referring to a device configured to communicate using the Wi-Fi standard.

The computing system 470 includes software and hardware components that can be electrically or communicatively coupled via a bus 489 (or may otherwise be in communication, as appropriate). For example, the computing system 470 includes one or more processors 484. The one or more processors 484 can include one or more CPUs, ASICS, FPGAs, APs, GPUs, VPUs, NSPs, microcontrollers, dedicated hardware, any combination thereof, and/or other processing device/s and/or system/s. The bus 489 can be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone or a microphone array, and/or the like), and one or more output devices 480 (e.g., a display, a speaker, a printer, and/or the like).

The one or more wireless transceivers 478 can receive wireless signals (e.g., signal 488) via antenna 487 from one or more other devices, such as other user devices, network devices (e.g., base stations such as evolved Node Bs (eNBs) and/or gNodeBs (gNBs), WiFi access points (APs) such as routers, range extenders or the like, etc.), cloud networks, and/or the like. In some examples, the computing system 470 can include multiple antennas or an antenna array that can facilitate simultaneous transmit and receive functionality. Antenna 487 can be an omnidirectional antenna such that RF signals can be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 488 into a baseband or intermediate frequency and can convert the RF signals to the digital domain.

In some cases, the computing system 470 can include a coding-decoding device (or CODEC) configured to encode and/or decode data transmitted and/or received using the one or more wireless transceivers 478. In some cases, the computing system 470 can include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 478.

The one or more SIMs 474 can each securely store an international mobile subscriber identity (IMSI) number and related key assigned to the user of the electronic device 407. The IMSI and key can be used to identify and authenticate the subscriber when accessing a network provided by a network service provider or operator associated with the one or more SIMs 474. The one or more modems 476 can modulate one or more signals to encode information for transmission using the one or more wireless transceivers 478. The one or more modems 476 can also demodulate signals received by the one or more wireless transceivers 478 in order to decode the transmitted information. In some examples, the one or more modems 476 can include a WiFi modem, a 4G (or LTE) modem, a 5G (or NR) modem, and/or other types of modems. The one or more modems 476 and the one or more wireless transceivers 478 can be used for communicating data for the one or more SIMs 474.

The computing system 470 can also include (and/or be in communication with) one or more non-transitory machine-readable storage media or storage devices (e.g., one or more memory devices 486), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 can also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

In some aspects, the electronic device 407 can include means for performing operations described herein. The means can include one or more of the components of the computing system 470. For example, the means for performing operations described herein may include one or more of input device(s) 472, SIM(s) 474, modems(s) 476, wireless transceiver(s) 478, output device(s) 480, DSP(s) 482, processors 484, memory device(s) 486, and/or antenna(s) 487.

In some aspects, the electronic device 407 can include means for providing joint communications and sensing and/or a means for power saving in RIS-based sensing. In some examples, any or all of these means can include the one or more wireless transceivers 478, the one or more modems 476, the one or more processors 484, the one or more DSPs 482, the one or more memory devices 486, any combination thereof, or other component(s) of the electronic device 407.

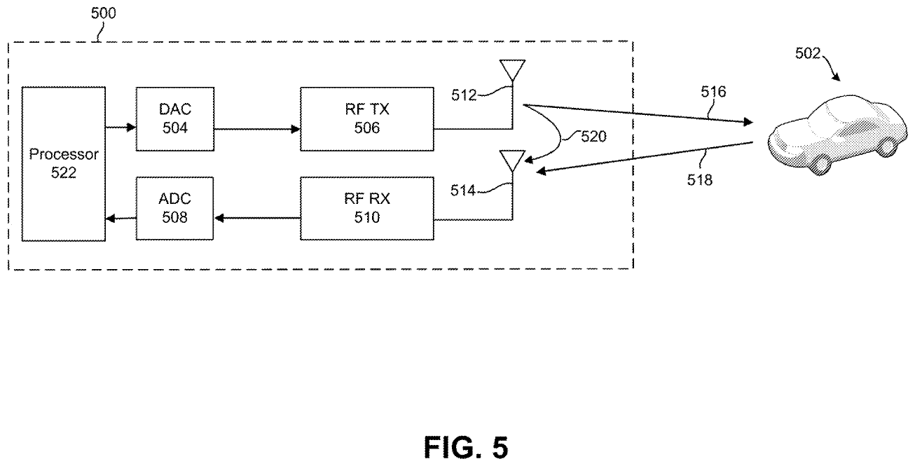

FIG. 5 is a diagram illustrating an example of a wireless device 500 utilizing RF monostatic sensing technique for determining one or more characteristics (e.g., location, speed or velocity, heading, etc.) of a target 502 object. In particular, FIG. 5 is a diagram illustrating an example of a wireless device 500 (e.g., a transmit/receive sensing node) that utilizes RF sensing techniques (e.g., monostatic sensing) to perform one or more functions, such as detecting a presence and location of a target 502 (e.g., an object, user, or vehicle), which in this figure is illustrated in the form of a vehicle.

In some examples, the wireless device 500 can be a mobile phone, a tablet computer, a wearable device, a vehicle, an extending reality (XR) device, a computing device or component of a vehicle, or other device (e.g., device 407 of FIG. 4) that includes at least one RF interface. In some examples, the wireless device 500 can be a device that provides connectivity for a user device (e.g., for electronic device 407 of FIG. 4), such as a base station (e.g., a gNB, eNB, etc.), a wireless access point (AP), or other device that includes at least one RF interface.

In some aspects, wireless device 500 can include one or more components for transmitting an RF signal. The wireless device 500 can include at least one processor 522 for generating a digital signal or waveform. The wireless device 500 can also include a digital-to-analog converter (DAC) 504 that is capable of receiving the digital signal or waveform from the processor(s) 522 (e.g., a microprocessor), and converting the digital signal or waveform to an analog waveform. The analog signal that is the output of the DAC 504 can be provided to RF transmitter 506 for transmission. The RF transmitter 506 can be a Wi-Fi transmitter, a 5G/NR transmitter, a Bluetooth™ transmitter, or any other transmitter capable of transmitting an RF signal.

RF transmitter 506 can be coupled to one or more transmitting antennas such as Tx antenna 512. In some examples, transmit (Tx) antenna 512 can be an omnidirectional antenna that is capable of transmitting an RF signal in all directions. For example, Tx antenna 512 can be an omnidirectional Wi-Fi antenna that can radiate Wi-Fi signals (e.g., 2.4 GHz, 5 GHZ, 6 GHZ, etc.) in a 360-degree radiation pattern. In another example, Tx antenna 512 can be a directional antenna that transmits an RF signal in a particular direction.

In some examples, wireless device 500 can also include one or more components for receiving an RF signal. For example, the receiver lineup in wireless device 500 can include one or more receiving antennas such as a receive (Rx) antenna 514. In some examples, Rx antenna 514 can be an omnidirectional antenna capable of receiving RF signals from multiple directions. In other examples, Rx antenna 514 can be a directional antenna that is configured to receive signals from a particular direction. In further examples, the Tx antenna 512 and/or the Rx antenna 514 can include multiple antennas (e.g., elements) configured as an antenna array (e.g., a phase antenna array).

Wireless device 500 can also include an RF receiver 510 that is coupled to Rx antenna 514. RF receiver 510 can include one or more hardware components for receiving an RF waveform such as a Wi-Fi signal, a Bluetooth™ signal, a 5G/NR signal, or any other RF signal. The output of RF receiver 510 can be coupled to an analog-to-digital converter (ADC) 508. ADC 508 can be configured to convert the received analog RF waveform into a digital waveform. The digital waveform that is the output of the ADC 508 can be provided to the processor(s) 522 for processing. The processor(s) 522 (e.g., a digital signal processor (DSP)) can be configured for processing the digital waveform.

In one example, wireless device 500 can implement RF sensing techniques, for example monostatic sensing techniques, by causing a Tx waveform 516 to be transmitted from Tx antenna 512. Although Tx waveform 516 is illustrated as a single line, in some cases, Tx waveform 516 can be transmitted in all directions by an omnidirectional Tx antenna 512. In one example, Tx waveform 516 can be a Wi-Fi waveform that is transmitted by a Wi-Fi transmitter in wireless device 500. In some cases, Tx waveform 516 can correspond to a Wi-Fi waveform that is transmitted at or near the same time as a Wi-Fi data communication signal or a Wi-Fi control function signal (e.g., a beacon transmission). In some examples, Tx waveform 516 can be transmitted using the same or a similar frequency resource as a Wi-Fi data communication signal or a Wi-Fi control function signal (e.g., a beacon transmission). In some aspects, Tx waveform 516 can correspond to a Wi-Fi waveform that is transmitted separately from a Wi-Fi data communication signal and/or a Wi-Fi control signal (e.g., Tx waveform 516 can be transmitted at different times and/or using a different frequency resource).

In some examples, Tx waveform 516 can correspond to a 5G NR waveform that is transmitted at or near the same time as a 5G NR data communication signal or a 5G NR control function signal. In some examples, Tx waveform 516 can be transmitted using the same or a similar frequency resource as a 5G NR data communication signal or a 5G NR control function signal. In some aspects, Tx waveform 516 can correspond to a 5G NR waveform that is transmitted separately from a 5G NR data communication signal and/or a 5G NR control signal (e.g., Tx waveform 516 can be transmitted at different times and/or using a different frequency resource).

In some aspects, one or more parameters associated with Tx waveform 516 can be modified that may be used to increase or decrease RF sensing resolution. The parameters may include frequency, bandwidth, number of spatial streams, the number of antennas configured to transmit Tx waveform 516, the number of antennas configured to receive a reflected RF signal (e.g., Rx waveform 518) corresponding to Tx waveform 516, the number of spatial links (e.g., number of spatial streams multiplied by number of antennas configured to receive an RF signal), the sampling rate, or any combination thereof. The transmitted waveform (e.g., Tx waveform 516) and the received waveform (e.g., Rx waveform 518) can include one or more RF sensing signals, which are also referred to as radar reference signals (RSs).

In further examples, Tx waveform 516 can be implemented to have a sequence that has perfect or almost perfect autocorrelation properties. For instance, Tx waveform 516 can include single carrier Zadoff sequences or can include symbols that are similar to orthogonal frequency-division multiplexing (OFDM) Long Training Field (LTF) symbols. In some cases, Tx waveform 516 can include a chirp signal, as used, for example, in a Frequency-Modulated Continuous-Wave (FM-CW) radar system. In some configurations, the chirp signal can include a signal in which the signal frequency increases and/or decreases periodically in a linear and/or an exponential manner.

In some aspects, wireless device 500 can implement RF sensing techniques by performing alternating transmit and receive functions (e.g., performing a half-duplex operation). For example, wireless device 500 can alternately enable its RF transmitter 506 to transmit the Tx waveform 516 when the RF receiver 510 is not enabled to receive (i.e. not receiving), and enable its RF receiver 510 to receive the Rx waveform 518 when the RF transmitter 506 is not enabled to transmit (i.e. not transmitting). When the wireless device 500 is performing a half-duplex operation, the wireless device 500 may transmit Tx waveform 516, which may be a radar RS (e.g., sensing signal).

In other aspects, wireless device 500 can implement RF sensing techniques by performing concurrent transmit and receive functions (e.g., performing a sub-band or full-band full-duplex operation). For example, wireless device 500 can enable its RF receiver 510 to receive at or near the same time as it enables RF transmitter 506 to transmit Tx waveform 516. When the wireless device 500 is performing a full-duplex operation (e.g., either sub-band full-duplex or full-band full-duplex), the wireless device 500 may transmit Tx waveform 516, which may be a radar RS (e.g., sensing signal).

In some examples, transmission of a sequence or pattern that is included in Tx waveform 516 can be repeated continuously such that the sequence is transmitted a certain number of times or for a certain duration of time. In some examples, repeating a pattern in the transmission of Tx waveform 516 can be used to avoid missing the reception of any reflected signals if RF receiver 510 is enabled after RF transmitter 506. In one example implementation, Tx waveform 516 can include a sequence having a sequence length L that is transmitted two or more times, which can allow RF receiver 510 to be enabled at a time less than or equal to L in order to receive reflections corresponding to the entire sequence without missing any information.

By implementing alternating or simultaneous transmit and receive functionality (e.g. half-duplex or full-duplex operation), wireless device 500 can receive signals that correspond to Tx waveform 516. For example, wireless device 500 can receive signals that are reflected from objects or people that are within range of Tx waveform 516, such as Rx waveform 518 reflected from target 502. Wireless device 500 can also receive leakage signals (e.g., Tx leakage signal 520) that are coupled directly from Tx antenna 512 to Rx antenna 514 without reflecting from any objects. For example, leakage signals can include signals that are transferred from a transmitter antenna (e.g., Tx antenna 512) on a wireless device to a receive antenna (e.g., Rx antenna 514) on the wireless device without reflecting from any objects. In some cases, Rx waveform 518 can include multiple sequences that correspond to multiple copies of a sequence that are included in Tx waveform 516. In some examples, wireless device 500 can combine the multiple sequences that are received by RF receiver 510 to improve the signal to noise ratio (SNR).

Wireless device 500 can further implement RF sensing techniques by obtaining RF sensing data associated with each of the received signals corresponding to Tx waveform 516. In some examples, the RF sensing data can include channel state information (CSI) data relating to the direct paths (e.g., leakage signal 520) of Tx waveform 516 together with data relating to the reflected paths (e.g., Rx waveform 518) that correspond to Tx waveform 516.

In some aspects, RF sensing data (e.g., CSI data) can include information that can be used to determine the manner in which an RF signal (e.g., Tx waveform 516) propagates from RF transmitter 506 to RF receiver 510. RF sensing data can include data that corresponds to the effects on the transmitted RF signal due to scattering, fading, and/or power decay with distance, or any combination thereof. In some examples, RF sensing data can include imaginary data and real data (e.g., I/Q components) corresponding to each tone in the frequency domain over a particular bandwidth.

In some examples, RF sensing data can be used by the processor(s) 522 to calculate distances and angles of arrival that correspond to reflected waveforms, such as Rx waveform 518. In further examples, RF sensing data can also be used to detect motion, determine location, detect changes in location or motion patterns, or any combination thereof. In some cases, the distance and angle of arrival of the reflected signals can be used to identify the size, position, movement, and/or orientation of targets (e.g., target 502) in the surrounding environment in order to detect target presence/proximity.

The processor(s) 522 of the wireless device 500 can calculate distances and angles of arrival corresponding to reflected waveforms (e.g., the distance and angle of arrival corresponding to Rx waveform 518) by utilizing signal processing, machine learning algorithms, any other suitable technique, or any combination thereof. In other examples, wireless device 500 can transmit or send the RF sensing data to at least one processor of another computing device, such as a server or base station, that can perform the calculations to obtain the distance and angle of arrival corresponding to Rx waveform 518 or other reflected waveforms.

In one example, the distance of Rx waveform 518 can be calculated by measuring the difference in time from reception of the leakage signal to the reception of the reflected signals. For example, wireless device 500 can determine a baseline distance of zero that is based on the difference from the time the wireless device 500 transmits Tx waveform 516 to the time it receives leakage signal 520 (e.g., propagation delay). The processor(s) 522 of the wireless device 500 can then determine a distance associated with Rx waveform 518 based on the difference from the time the wireless device 500 transmits Tx waveform 516 to the time it receives Rx waveform 518 (e.g., time of flight, which is also referred to as round trip time (RTT)), which can then be adjusted according to the propagation delay associated with leakage signal 520. In doing so, the processor(s) 522 of the wireless device 500 can determine the distance traveled by Rx waveform 518 which can be used to determine the presence and movement of a target (e.g., target 502) that caused the reflection.

In further examples, the angle of arrival of Rx waveform 518 can be calculated by the processor(s) 522 by measuring the time difference of arrival of Rx waveform 518 between individual elements of a receive antenna array, such as antenna 514. In some examples, the time difference of arrival can be calculated by measuring the difference in received phase at each element in the receive antenna array.

In some cases, the distance and the angle of arrival of Rx waveform 518 can be used by processor(s) 522 to determine the distance between wireless device 500 and target 502 as well as the position of the target 502 relative to the wireless device 500. The distance and the angle of arrival of Rx waveform 518 can also be used to determine presence, movement, proximity, identity, or any combination thereof, of target 502. For example, the processor(s) 522 of the wireless device 500 can utilize the calculated distance and angle of arrival corresponding to Rx waveform 518 to determine that the target 502 is moving towards wireless device 500.

As noted above, wireless device 500 can include mobile devices (e.g., IoT devices, smartphones, laptops, tablets, etc.) or other types of devices. In some examples, wireless device 500 can be configured to obtain device location data and device orientation data together with the RF sensing data. In some instances, device location data and device orientation data can be used to determine or adjust the distance and angle of arrival of a reflected signal such as Rx waveform 518. For example, wireless device 500 may be set on the ground facing the sky as a target 502 (e.g., a vehicle) moves towards it during the RF sensing process. In this instance, wireless device 500 can use its location data and orientation data together with the RF sensing data to determine the direction that the target 502 is moving.

In some examples, device position data can be gathered by wireless device 500 using techniques that include RTT measurements, time of arrival (TOA) measurements, time difference of arrival (TDOA) measurements, passive positioning measurements, angle of arrival (AOA) measurements, angle of departure (AoD) measurements, received signal strength indicator (RSSI) measurements, CSI data, using any other suitable technique, or any combination thereof. In further examples, device orientation data can be obtained from electronic sensors on the wireless device 500, such as a gyroscope, an accelerometer, a compass, a magnetometer, a barometer, any other suitable sensor, or any combination thereof.

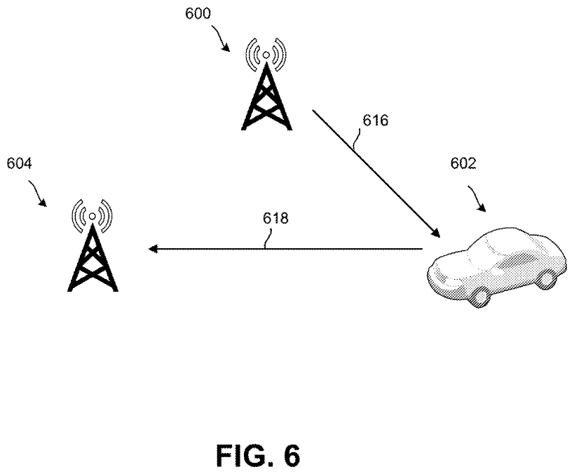

FIG. 6 is a diagram illustrating an example of a receiver 604 utilizing RF bistatic sensing techniques with one transmitter 600 for determining one or more characteristics (e.g., location, speed or velocity, heading, etc.) of a target 602 object. For example, the receiver 604 can use the RF bistatic sensing to detect a presence and location of a target 602 (e.g., an object, user, or vehicle), which is illustrated in the form of a vehicle in FIG. 6. In one example, the receiver 604 may be in the form of a base station, such as a gNB.

The bistatic radar system of FIG. 6 includes a transmitter 600 (e.g., a transmit sensing node), which in this figure is depicted to be in the form of a base station (e.g., gNB), and a receiver 604 (e.g., a receive sensing node) that are separated by a distance comparable to the expected target distance. As compared to the monostatic system of FIG. 5, the transmitter 600 and the receiver 604 of the bistatic radar system of FIG. 6 are located remote from one another. Conversely, monostatic radar is a radar system (e.g., the system of FIG. 5) comprising a transmitter (e.g., the RF transmitter 506 of wireless device 500 of FIG. 5) and a receiver (e.g., the RF receiver 510 of wireless device 500 of FIG. 5) that are co-located with one another.

An advantage of bistatic radar (or more generally, multistatic radar, which has more than one receiver) over monostatic radar is the ability to collect radar returns reflected from a scene at angles different than that of a transmitted pulse. This can be of interest to some applications (e.g., vehicle applications, scenes with multiple objects, military applications, etc.) where targets may reflect the transmitted energy in many directions (e.g., where targets are specifically designed to reflect in many directions), which can minimize the energy that is reflected back to the transmitter. It should be noted that, in one or more examples, a monostatic system can coexist with a multistatic radar system, such as when the transmitter also has a co-located receiver.

In some examples, the transmitter 600 and/or the receiver 604 of FIG. 6 can be a mobile phone, a tablet computer, a wearable device, a vehicle, or other device (e.g., device 407 of FIG. 4) that includes at least one RF interface. In some examples, the transmitter 600 and/or the receiver 604 can be a device that provides connectivity for a user device (e.g., for IoT device 407 of FIG. 4), such as a base station (e.g., a gNB, eNB, etc.), a wireless access point (AP), or other device that includes at least one RF interface.

In some aspects, transmitter 600 can include one or more components for transmitting an RF signal. The transmitter 600 can include at least one processor (e.g., the at least one processor 522 of FIG. 5) that is capable of determining signals (e.g., determining the waveforms for the signals) to be transmitted. The transmitter 600 can also include an RF transmitter (e.g., the RF transmitter 506 of FIG. 5) for transmission of a Tx signal comprising Tx waveform 616. The RF transmitter can be a transmitter configured to transmit cellular or telecommunication signals (e.g., a transmitter configured to transmit 5G/NR signals, 4G/LTE signals, or other cellular/telecommunication signals, etc.), a Wi-Fi transmitter, a Bluetooth™ transmitter, any combination thereof, or any other transmitter capable of transmitting an RF signal.

The RF transmitter can be coupled to one or more transmitting antennas, such as a Tx antenna (e.g., the TX antenna 512 of FIG. 5). In some examples, a Tx antenna can be an omnidirectional antenna that is capable of transmitting an RF signal in all directions, or a directional antenna that transmits an RF signal in a particular direction. In some examples, the Tx antenna may include multiple antennas (e.g., elements) configured as an antenna array.

The receiver 604 can include one or more components for receiving an RF signal. For example, the receiver 604 may include one or more receiving antennas, such as an Rx antenna (e.g., the Rx antenna 514 of FIG. 5). In some examples, an Rx antenna can be an omnidirectional antenna capable of receiving RF signals from multiple directions, or a directional antenna that is configured to receive signals from a particular direction. In further examples, the Rx antenna can include multiple antennas (e.g., elements) configured as an antenna array.

The receiver 604 may also include an RF receiver (e.g., RF receiver 510 of FIG. 5) coupled to the Rx antenna. The RF receiver may include one or more hardware components for receiving an RF waveform such as a Wi-Fi signal, a Bluetooth™ signal, a 5G/NR signal, or any other RF signal. The output of the RF receiver can be coupled to at least one processor (e.g., the at least one processor 522 of FIG. 5). The processor(s) may be configured to process a received waveform (e.g., Rx waveform 618).

In one or more examples, transmitter 600 can implement RF sensing techniques, for example bistatic sensing techniques, by causing a Tx waveform 616 to be transmitted from a Tx antenna. It should be noted that although the Tx waveform 616 is illustrated as a single line, in some cases, the Tx waveform 616 can be transmitted in all directions by an omnidirectional Tx antenna.

In one or more aspects, one or more parameters associated with the Tx waveform 616 may be used to increase or decrease RF sensing resolution. The parameters may include frequency, bandwidth, number of spatial streams, the number of antennas configured to transmit Tx waveform 616, the number of antennas configured to receive a reflected RF signal (e.g., Rx waveform 618) corresponding to the Tx waveform 616, the number of spatial links (e.g., number of spatial streams multiplied by number of antennas configured to receive an RF signal), the sampling rate, or any combination thereof. The transmitted waveform (e.g., Tx waveform 616) and the received waveform (e.g., the Rx waveform 618) can include one or more radar RF sensing signals (also referred to as RF sensing RSs).

During operation, the receiver 604 (e.g., which operates as a receive sensing node) can receive signals that correspond to Tx waveform 616, which is transmitted by the transmitter 600 (e.g., which operates as a transmit sensing node). For example, the receiver 604 can receive signals that are reflected from objects or people that are within range of the Tx waveform 616, such as Rx waveform 618 reflected from target 602. In some cases, the Rx waveform 618 can include multiple sequences that correspond to multiple copies of a sequence that are included in the Tx waveform 616. In some examples, the receiver 604 may combine the multiple sequences that are received to improve the SNR.

In some examples, RF sensing data can be used by at least one processor within the receiver 604 to calculate distances, angles of arrival, or other characteristics that correspond to reflected waveforms, such as the Rx waveform 618. In other examples, RF sensing data can also be used to detect motion, determine location, detect changes in location or motion patterns, or any combination thereof. In some cases, the distance and angle of arrival of the reflected signals can be used to identify the size, position, movement, and/or orientation of targets (e.g., target 602) in the surrounding environment in order to detect target presence/proximity.

The processor(s) of the receiver 604 can calculate distances and angles of arrival corresponding to reflected waveforms (e.g., the distance and angle of arrival corresponding to the Rx waveform 618) by using signal processing, machine learning algorithms, any other suitable technique, or any combination thereof. In other examples, the receiver 604 can transmit or send the RF sensing data to at least one processor of another computing device, such as a server, that can perform the calculations to obtain the distance and angle of arrival corresponding to the Rx waveform 618 or other reflected waveforms.

In one or more examples, the angle of arrival of the Rx waveform 618 can be calculated by a processor(s) of the receiver 604 by measuring the time difference of arrival of the Rx waveform 618 between individual elements of a receive antenna array of the receiver 604. In some examples, the time difference of arrival can be calculated by measuring the difference in received phase at each element in the receive antenna array.

In some cases, the distance and the angle of arrival of the Rx waveform 618 can be used by the processor(s) of the receiver 604 to determine the distance between the receiver 604 and the target 602 as well as the position of target 602 relative to the receiver 604. The distance and the angle of arrival of the Rx waveform 618 can also be used to determine presence, movement, proximity, identity, or any combination thereof, of the target 602. For example, the processor(s) of the receiver 604 may use the calculated distance and angle of arrival corresponding to the Rx waveform 618 to determine that the target 602 is moving towards the receiver 604.

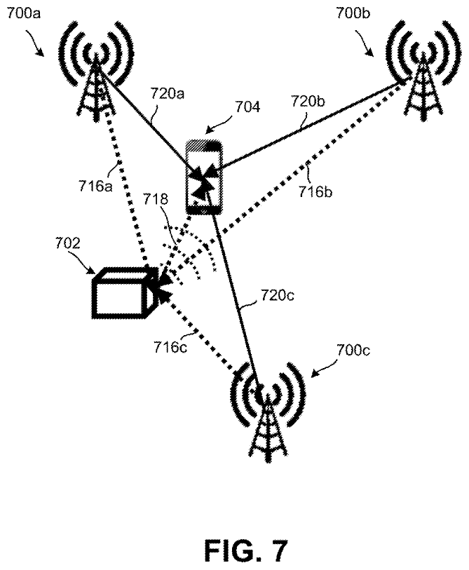

FIG. 7 is a diagram illustrating an example of a receiver 704, in the form of a smart phone, utilizing RF bistatic sensing techniques with multiple transmitters (including a transmitter 700a, a transmitter 700b, and a transmitter 700c), which may be employed to determine one or more characteristics (e.g., location, velocity or speed, heading, etc.) of a target 702 object. For example, the receiver 704 may use RF bistatic sensing to detect a presence and location of a target 702 (e.g., an object, user, or vehicle). The target 702 is depicted in FIG. 7 in the form of an object that does not have communications capabilities (which can be referred to as a device-free object), such as a person, a vehicle (e.g., a vehicle without the ability to transmit and receive messages, such as using C-V2X or DSRC protocols), or other device-free object. The bistatic radar system of FIG. 7 is similar to the bistatic radar system of FIG. 6, except that the bistatic radar system of FIG. 7 has multiple transmitters 700a, 700b, 700c, while the bistatic radar system of FIG. 6 has only one transmitter 600.

The bistatic radar system of FIG. 7 includes multiple transmitters 700a, 700b, 700c (e.g., transmit sensing nodes), which are illustrated to be in the form of base stations. The bistatic radar system of FIG. 7 also includes a receiver 704 (e.g., a receive sensing node), which is depicted in the form of a smart phone. The each of the transmitters 700a, 700b, 700c is separated from the receiver 704 by a distance comparable to the expected distance from the target 702. Similar to the bistatic system of FIG. 6, the transmitters 700a, 700b, 700c and the receiver 704 of the bistatic radar system of FIG. 7 are located remote from one another.

In one or more examples, the transmitters 700a, 700b, 700c and/or the receiver 704 may each be a mobile phone, a tablet computer, a wearable device, a vehicle (e.g., a vehicle configured to transmit and receive communications according to C-V2X, DSRC, or other communication protocol), or other device (e.g., device 407 of FIG. 4) that includes at least one RF interface. In some examples, the transmitters 700a, 700b, 700c and/or the receiver 704 may each be a device that provides connectivity for a user device (e.g., for IoT device 407 of FIG. 4), such as a base station (e.g., a gNB, eNB, etc.), a wireless access point (AP), or other device that includes at least one RF interface.

The transmitters 700a, 700b, 700c may include one or more components for transmitting an RF signal. Each of the transmitters 700a, 700b, 700c may include at least one processor (e.g., the processor(s) 522 of FIG. 5) that is capable of determining signals (e.g., determining the waveforms for the signals) to be transmitted. Each of the transmitters 700a, 700b, 700c can also include an RF transmitter (e.g., the RF transmitter 506 of FIG. 5) for transmission of Tx signals comprising Tx waveforms 716a, 716b, 716c, 720a, 720b, 720c. In one or more examples, Tx waveforms 716a, 716b, 716c are RF sensing signals, and Tx waveforms 720a, 720b, 720c are communications signals. In one or more examples, the Tx waveforms 720a, 720b, 720c are communications signals that may be used for scheduling transmitters (e.g., transmitters 700a, 700b, 700c) and receivers (e.g., receiver 704) for performing RF sensing of a target (e.g., target 702) to obtain location information regarding the target. The RF transmitter can be a transmitter configured to transmit cellular or telecommunication signals (e.g., a transmitter configured to transmit 5G/NR signals, 4G/LTE signals, or other cellular/telecommunication signals, etc.), a Wi-Fi transmitter, a Bluetooth™ transmitter, any combination thereof, or any other transmitter capable of transmitting an RF signal.

The RF transmitter may be coupled to one or more transmitting antennas, such as a Tx antenna (e.g., the TX antenna 512 of FIG. 5). In one or more examples, a Tx antenna can be an omnidirectional antenna that is capable of transmitting an RF signal in all directions, or a directional antenna that transmits an RF signal in a particular direction. The Tx antenna may include multiple antennas (e.g., elements) configured as an antenna array.

The receiver 704 of FIG. 7 may include one or more components for receiving an RF signal. For example, the receiver 704 can include one or more receiving antennas, such as an Rx antenna (e.g., the Rx antenna 514 of FIG. 5). In one or more examples, an Rx antenna can be an omnidirectional antenna capable of receiving RF signals from multiple directions, or a directional antenna that is configured to receive signals from a particular direction. In some examples, the Rx antenna may include multiple antennas (e.g., elements) configured as an antenna array (e.g., a phase antenna array).

The receiver 704 can also include an RF receiver (e.g., RF receiver 510 of FIG. 5) coupled to the Rx antenna. The RF receiver may include one or more hardware components for receiving an RF waveform such as a Wi-Fi signal, a Bluetooth™ signal, a 5G/NR signal, or any other RF signal. The output of the RF receiver can be coupled to at least one processor (e.g., the processor(s) 522 of FIG. 5). The processor(s) may be configured to process a received waveform (e.g., Rx waveform 718, which is a reflection (echo) RF sensing signal).

In some examples, the transmitters 700a, 700b, 700c can implement RF sensing techniques, for example bistatic sensing techniques, by causing Tx waveforms 716a, 716b, 716c (e.g., radar sensing signals) to be transmitted from a Tx antenna associated with each of the transmitters 700a, 700b, 700c. Although the Tx waveforms 716a, 716b, 716c are illustrated as single lines, in some cases, the Tx waveforms 716a, 716b, 716c may be transmitted in all directions (e.g., by an omnidirectional Tx antenna associated with each of the transmitters 700a, 700b, 700c).

In one or more aspects, one or more parameters associated with the Tx waveforms 716a, 716b, 716c may be used to increase or decrease RF sensing resolution. The parameters can include, but are not limited to, frequency, bandwidth, number of spatial streams, the number of antennas configured to transmit Tx waveforms 716a, 716b, 716c, the number of antennas configured to receive a reflected (echo) RF signal (e.g., Rx waveform 718) corresponding to each of the Tx waveforms 716a, 716b, 716c, the number of spatial links (e.g., number of spatial streams multiplied by number of antennas configured to receive an RF signal), the sampling rate, or any combination thereof. The transmitted waveforms (e.g., Tx waveforms 716a, 716b, 716c) and the received waveforms (e.g., the Rx waveform 718) may include one or more radar RF sensing signals (also referred to as RF sensing RSs). It should be noted that although only one reflected sensing signal (e.g., Rx waveform 718) is shown in FIG. 7, it is understood that a separate reflection (echo) sensing signal will be generated by each sensing signal (e.g., Tx waveforms 716a, 716b, 716c) reflecting off of the target 702.

During operation of the system of FIG. 7, the receiver 704 (e.g., which operates as a receive sensing node) can receive signals that correspond to Tx waveforms 716a, 716b, 716c, which are transmitted by the transmitters 700a, 700b, 700c (e.g., which each operate as a transmit sensing node). The receiver 704 can receive signals that are reflected from objects or people that are within range of the Tx waveforms 716a, 716b, 716c, such as Rx waveform 718 reflected from the target 702. In one or more examples, the Rx waveform 718 may include multiple sequences that correspond to multiple copies of a sequence that are included in its corresponding Tx waveform 716a, 716b, 716c. In some examples, the receiver 704 may combine the multiple sequences that are received to improve the SNR.

In some examples, RF sensing data can be used by at least one processor within the receiver 704 to calculate distances, angles of arrival (AOA), TDOA, angle of departure (AoD), or other characteristics that correspond to reflected waveforms (e.g., Rx waveform 718). In further examples, RF sensing data can also be used to detect motion, determine location, detect changes in location or motion patterns, or any combination thereof. In one or more examples, the distance and angle of arrival of the reflected signals can be used to identify the size, position, movement, and/or orientation of targets (e.g., target 702) in order to detect target presence/proximity.

The processor(s) of the receiver 704 can calculate distances and angles of arrival corresponding to reflected waveforms (e.g., the distance and angle of arrival corresponding to the Rx waveform 718) by using signal processing, machine learning algorithms, any other suitable technique, or any combination thereof. In one or more examples, the receiver 704 can transmit or send the RF sensing data to at least one processor of another computing device, such as a server, that can perform the calculations to obtain the distance and angle of arrival corresponding to the Rx waveform 718 or other reflected waveforms (not shown).

In one or more examples, a processor(s) of the receiver 704 can calculate the angle of arrival (AOA) of the Rx waveform 718 by measuring the TDOA of the Rx waveform 718 between individual elements of a receive antenna array of the receiver 704. In some examples, the TDOA can be calculated by measuring the difference in received phase at each element in the receive antenna array. In one illustrative example, to determine TDOA, the processor(s) can determine the difference time of arrival of the Rx waveform 718 to the receive antenna array elements, using one of them as a reference. The time difference is proportional to distance differences.

In some cases, the processor(s) of the receiver 704 can use the distance, the AOA, the TDOA, other measured information (e.g., AoD, etc.), any combination thereof, of the Rx waveform 718 to determine the distance between the receiver 704 and the target 702, and determine the position of target 702 relative to the receiver 704. In one example, the processor(s) can apply a multilateration or other location-based algorithm using the distance, AOA, and/or TDOA information as input to determine a position (e.g., 3D position) of the target 702. In other examples, the processor(s) can use the distance, the AOA, and/or the TDOA of the Rx waveform 718 to determine a presence, movement (e.g., velocity or speed, heading or direction or movement, etc.), proximity, identity, any combination thereof, or other characteristic of the target 702. For instance, the processor(s) of the receiver 704 may use the distance, the AOA, and/or the TDOA corresponding to the Rx waveform 718 to determine that the target is moving towards the receiver 704.

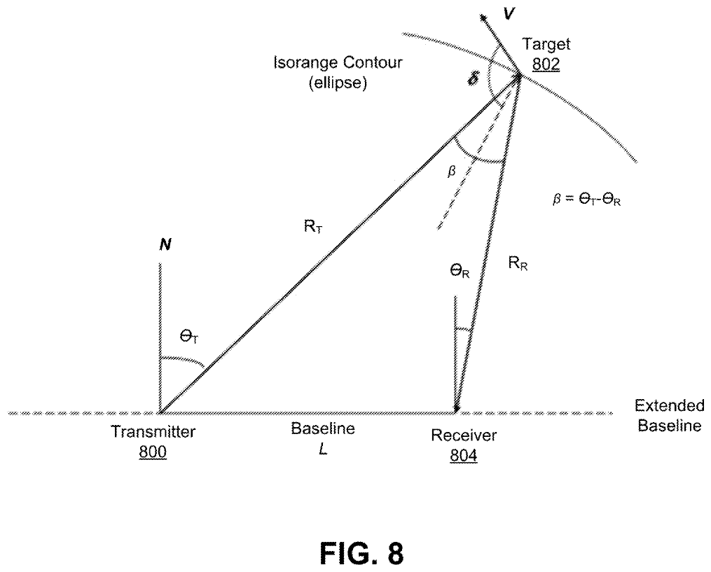

FIG. 8 is a diagram illustrating geometry for bistatic (or monostatic) sensing. FIG. 8 shows a bistatic radar North-reference coordinate system in two-dimensions. In particular, FIG. 8 shows a coordinate system and parameters defining bistatic radar operation in a plane (referred to as a bistatic plane) containing a transmitter 800, a receiver 804, and a target 802. A bistatic triangle lies in the bistatic plane. The transmitter 800, the target 802, and the receiver 804 are shown in relation to one another. The transmitter 800 and the receiver 804 are separated by a baseline distance L. The extended baseline is defined as continuing the baseline distance L beyond either the transmitter 800 or the receiver 804. The target 802 and the transmitter 800 are separated by a distance RT, and the target 802 and the receiver 804 are separated by a distance RR.

Angles θ_{T} and θ_{R} are, respectively, the transmitter 800 and receiver 804 look angles, which are taken as positive when measured clockwise from North (N). The angles θ_{T} and θ_{R} are also referred to as angles of arrival (AOA) or lines of sight (LOS). A bistatic angle (β) is the angle subtended between the transmitter 800, the target 802, and the receiver 804 in the radar. In particular, the bistatic angle is the angle between the transmitter 800 and the receiver 804 with the vertex located at the target 802. The bistatic angle is equal to the transmitter 800 look angle minus the receiver 804 look angle θ_{R} (e.g., β=θ_{T}−θ_{R}).

When the bistatic angle is exactly zero (0), the radar is considered to be a monostatic radar; when the bistatic angle is close to zero, the radar is considered to be pseudo-monostatic; and when the bistatic angle is close to 180 degrees, the radar is considered to be a forward scatter radar. Otherwise, the radar is simply considered to be, and referred to as, a bistatic radar. The bistatic angle (β) can be used in determining the radar cross section of the target.

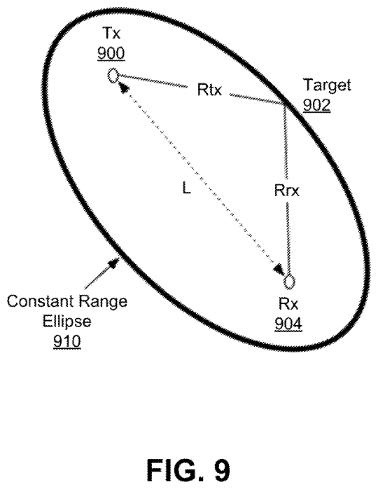

FIG. 9 is a diagram illustrating an example of a bistatic range 910 of bistatic sensing. In this figure, a transmitter (Tx) 900, a target 902, and a receiver (Rx) 904 of a radar are shown in relation to one another. The transmitter 900 and the receiver 904 are separated by a baseline distance L, the target 902 and the transmitter 900 are separated by a distance Rtx, and the target 902 and the receiver 904 are separated by a distance Rrx.

Bistatic range 910 (shown as an ellipse) refers to the measurement range made by radar with a separate transmitter 900 and receiver 904 (e.g., the transmitter 900 and the receiver 904 are located remote from one another). The receiver 904 measures the time of arrival from when the signal is transmitted by the transmitter 900 to when the signal is received by the receiver 904 from the transmitter 900 via the target 902. The bistatic range 910 defines an ellipse of constant bistatic range, referred to an iso-range contour, on which the target 902 lies, with foci centered on the transmitter 900 and the receiver 904. If the target 902 is at range Rrx from the receiver 904 and range Rtx from the transmitter 900, and the receiver 904 and the transmitter 900 are located a distance L apart from one another, then the bistatic range is equal to Rrx+Rtx−L. It should be noted that motion of the target 902 causes a rate of change of bistatic range, which results in bistatic Doppler shift.

Generally, constant bistatic range points draw an ellipsoid, with the transmitter 900 and the receiver 904 positions as the focal points. The bistatic iso-range contours are where the ground slices the ellipsoid. When the ground is flat, this intercept forms an ellipse (e.g., bistatic range 910). Note that except when the two platforms have equal altitude, these ellipses are not centered on a specular point.

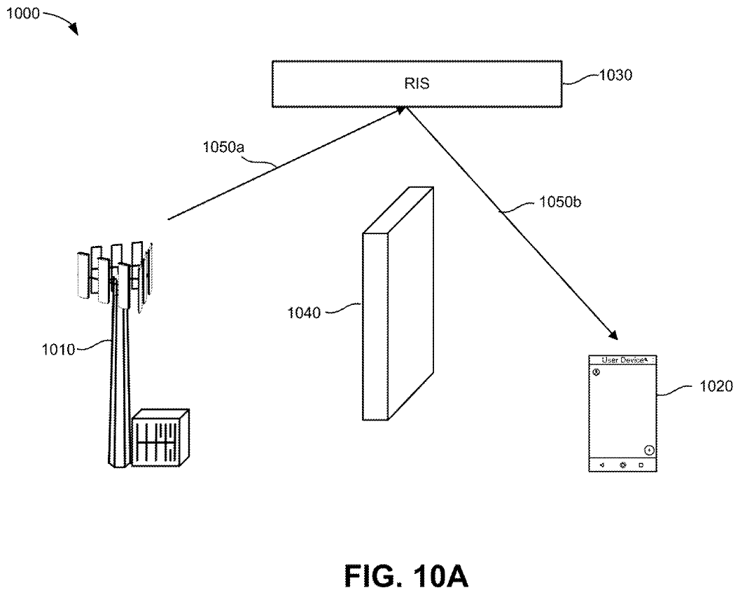

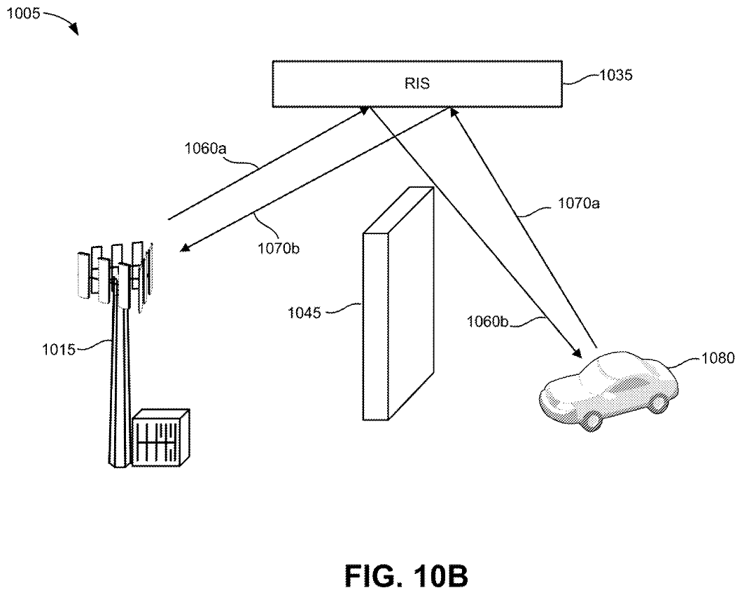

As previously mentioned, a RIS (e.g., RIS 1030 of FIGS. 10A) may be employed for sensing and/or communications. RISs have traditionally been utilized for communications, however RISs may also be employed to assist in sensing for ISAC systems. RIS-assisted sensing requires a higher accuracy (e.g., higher precision) of the RIS position than needed for RIS-assisted communication.

FIG. 10A is a diagram illustrating an example of a system 1000 for performing RIS-assisted communication. In FIG. 10A, the system 1000 is shown to include a network device 1020 in the form of a UE that may be operating as a communications receiver. Also shown is a network device 1010 in the form of a base station (e.g., gNB or a portion of a gNB, such as a CU, DU, RU, Near-RT RIC, Non-RT RIC, etc.) that may be operating as a communications transmitter. The system 1000 also includes a RIS 1030. In some cases, an obstruction 1040 (e.g., in the form of a building) may be obstructing the line of sight (LOS) from the network device 1010 (e.g., gNB) to the network device 1020 (e.g., UE).

The system 1000 may include more or less network devices, than as shown in FIG. 10A. In addition, the system 1000 may include different types of network devices (e.g., vehicles) than as shown in FIG. 10A. In one or more examples, the network devices 1020 (e.g., UE) and 1010 (e.g., gNB) may be equipped with heterogeneous capability, which may include, but is not limited to, 4G/5G cellular connectivity, GPS capability, camera capability, radar capability, and/or LIDAR capability. The network devices 1020, 1010 may be capable of performing wireless communications with each other via communications signals (e.g., signals 1050a, 1050b).

The RIS 1030 may passively operate as a relay by reflecting signals (e.g., communication signals) radiated from one network device (e.g., network device 1010 in the form of a gNB) in a direction towards another network device (e.g., network device 1020 in the form of a UE). For example, during operation of the system 1000 for RIS-assisted communication, since there is an obstruction 1040 (e.g., building) located within the LOS between the network device 1010 (e.g., gNB) and the network device 1020 (e.g., UE), the network device 1010 (e.g., gNB) may transmit a communication signal (e.g., signal 1050a) towards the RIS 1030. The communication signal (e.g., signal 1050a) can reflect off of the RIS 1030 to produce a reflection communication signal (e.g., signal 1050b). Elements of the RIS 1030 can cause the reflection communication signal (e.g., signal 1050b) to be radiated in a direction towards the network device 1020 (e.g., UE), which can then receive the reflection communication signal (e.g., signal 1050b).

FIG. 10B is a diagram illustrating an example of a system 1005 for performing RIS-assisted sensing. In FIG. 10B, the system 1005 is shown to include a network device 1015 in the form of a base station (e.g., gNB or a portion of a gNB, such as a CU, DU, RU, Near-RT RIC, Non-RT RIC, etc.). The network device 1015 (e.g., gNB) can operate as a radar transmitter (Tx) and/or a radar receiver (Rx) for sensing purposes (e.g., for monostatic or bistatic sensing of a target, such as target 1080). The system 1005 also includes a RIS 1035. There can be also an obstruction 1045 (e.g., in the form of a building), which is obstructing the LOS from the network device 1015 (e.g., gNB) to the target 1080, which is shown in the form of a vehicle.

The system 1005 may include more or less network devices, than as shown in FIG. 10B. In addition, the system 1005 may include different types of network devices (e.g., mobile phones and/or vehicles), than as shown in FIG. 10B. In one or more examples, the network device 1015 (e.g., gNB) may be equipped with heterogeneous capability, which may include, but is not limited to, 4G/5G cellular connectivity, GPS capability, camera capability, radar capability, and/or LIDAR capability. The network device 1015 (e.g., gNB) may be capable of performing wireless communications with other network devices via communications signals.

In one or more examples, the network device 1015 (e.g., gNB) may be capable of transmitting and receiving sensing signals of some kind (e.g., camera, RF sensing signals, optical sensing signals, etc.). In some cases, the network device 1015 (e.g., gNB) may transmit and receive sensing signals (e.g., RF sensing signals 1060a, 1070b) for using one or more sensors to detect nearby targets (e.g., target 1080, which is in the form of a vehicle). In some cases, the network device 1015 (e.g., gNB) can detect nearby targets based on one or more images or frames captured using one or more cameras.

The network device 1015 (e.g., gNB), which may operate as a radar Tx and/or radar Rx, may perform RF sensing (e.g., bistatic sensing or monostatic sensing) of at least one target (e.g., target 1080) to obtain RF sensing measurements (e.g., Doppler, RTT, TOA, and/or TDOA measurements) of the target(s) (e.g., target 1080). The RF sensing measurements of the target(s) (e.g., target 1080) can be used (e.g., by at least one processor(s) of the network device 1015) to determine one or more characteristics (e.g., speed, location, distance, movement, heading, size, and/or other characteristics) of the target(s) (e.g., target 1080).

The RIS 1035 may passively operate as a relay by reflecting signals (e.g., sensing signals) radiated from the network device (e.g., network device 1015 in the form of a gNB) in a direction towards a target (e.g., target 1080 in the form of a vehicle). The RIS 1035 may also passively operate as a relay by reflecting signals (e.g., reflection sensing signals) from a target (e.g., target 1080) in a direction towards a network device (e.g., network device 1015).

For example, during operation of the system 1005 for RIS-assisted sensing, for example when performing monostatic sensing of a target (e.g., target 1080), since there is an obstruction 1045 (e.g., building) located within the LOS between the network device 1015 (e.g., gNB) and the target 1080 (e.g., vehicle), the network device 1015 (e.g., gNB), operating as a radar Tx, may transmit an RF sensing signal 1060a towards the RIS 1035. The RF sensing signal 1060a may be included within communication signals and sensing signals multiplexed (e.g., via time division multiplexing and/or frequency division multiplexing) together for joint communications and sensing purposes. The sensing signal 1060a can reflect off of the RIS 1035 to produce a reflection sensing signal (e.g., signal 1060b). Elements of the RIS 1035 can cause the reflection sensing signal (e.g., signal 1060b) to be radiated in a direction towards the target 1080.

The sensing signal 1060b can reflect off of the target 1080 to produce an RF reflection sensing signal 1070a, which may be reflected back towards the RIS 1035. The sensing signal 1070a can reflect off of the RIS 1035 to produce a reflection sensing signal (e.g., signal 1070b). Elements of the RIS 1035 can cause the reflection sensing signal (e.g., signal 1070b) to be radiated in a direction towards the network device 1015 (e.g., gNB).

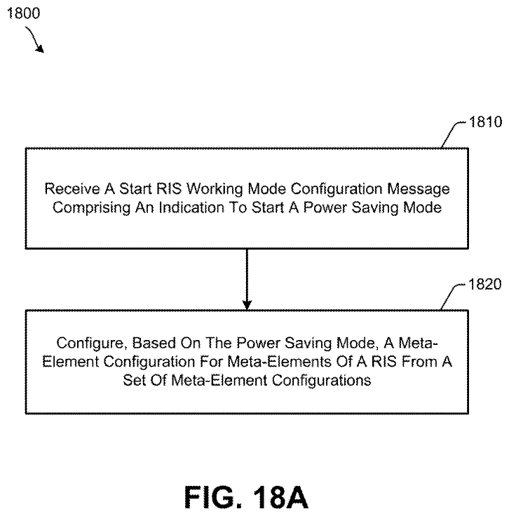

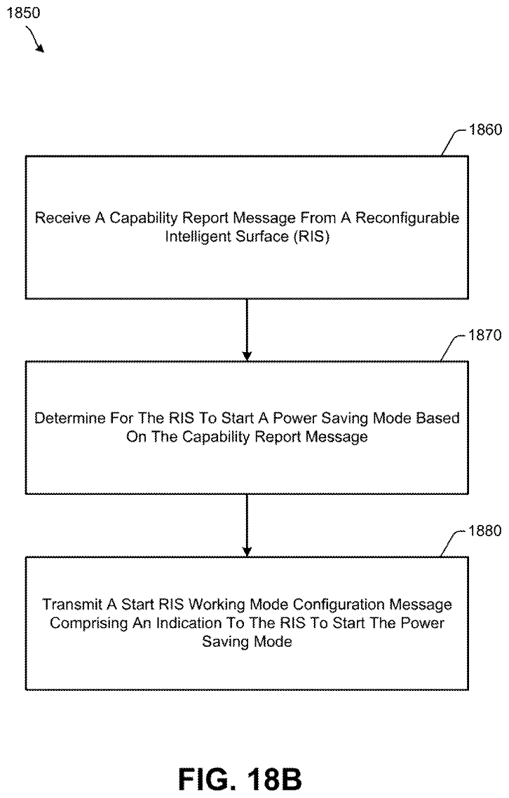

The network device 1015 (e.g., gNB), operating as a radar Rx, can receive the reflection sensing signal 1070b. After the network device 1015 (e.g., gNB) receives the reflection sensing signal 1070b, the network device 1015 (e.g., gNB) can obtain measurements (e.g., Doppler, RTT, TOA, and/or TDOA measurements) of the reflection sensing signal 1070b. At least one processor (e.g., processor 1810 of FIG. 18) of the network device 1015 (e.g., gNB) may then determine or compute the characteristics (e.g., speed, location, distance, movement, heading, size, etc.) of the target 1080 by using sensing measurements (e.g., Doppler, RTT, TOA, and/or TDOA measurements) from the received reflection sensing signal 1070b.

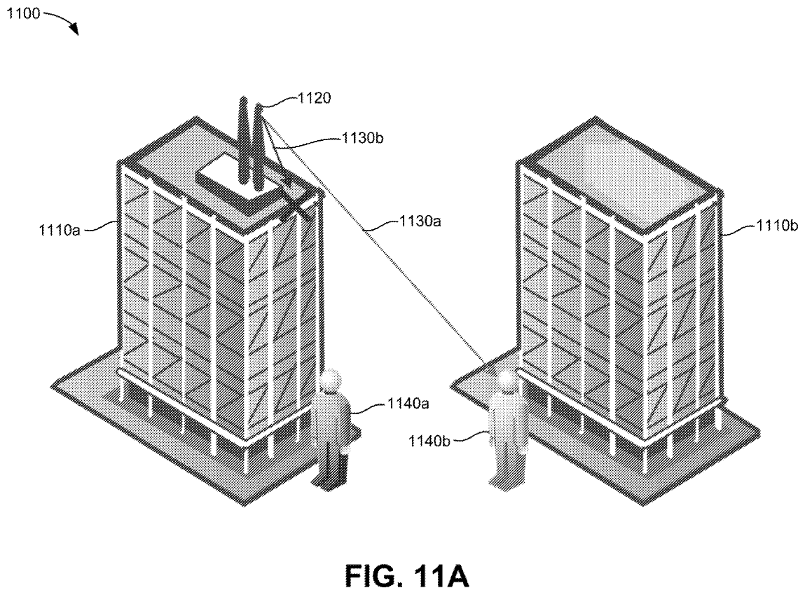

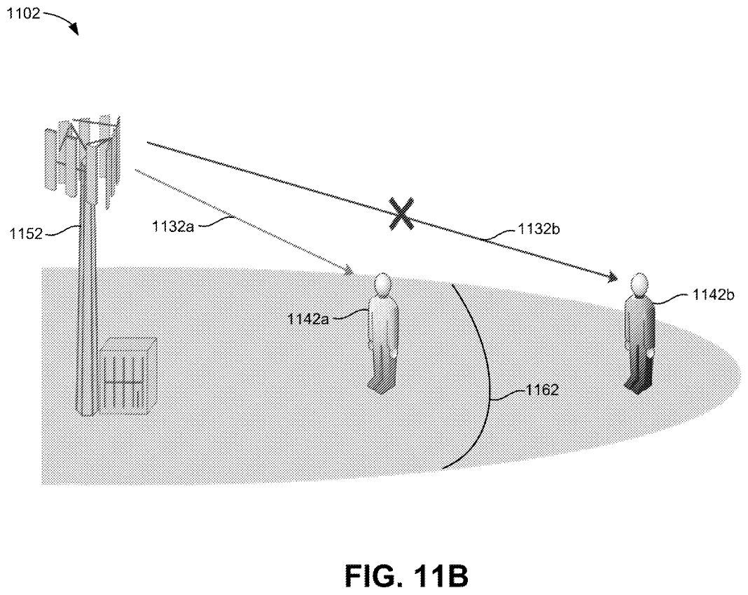

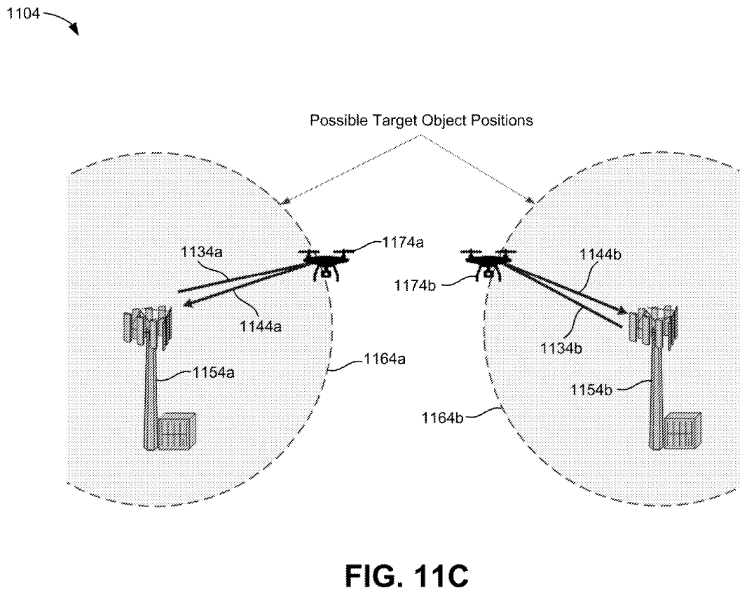

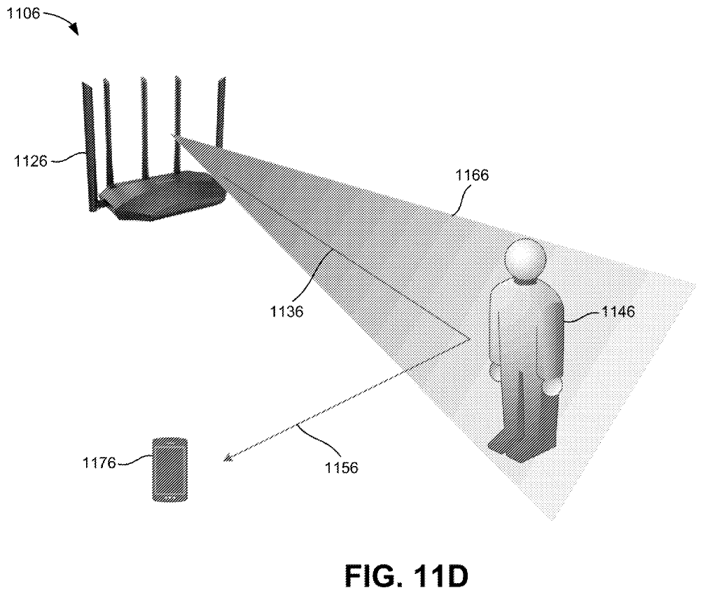

In one or more aspects, when sensing only relies on using a base station (e.g., gNB) and a UE (e.g., smart phone or drone), some issues may occur, such as, but not limited, to LOS blockage, insufficient coverage, insufficient reference anchor points, and/or insufficient spatial resolution. Adding additional base stations (e.g., gNBs) can help to ameliorate these issues. However, adding more base stations (e.g., gNBs) can result in a high cost in deployment, hardware, radio resources, and network power consumption. FIGS. 11A, 11B, 11C, and 11D show examples of sensing systems with LOS blockage, insufficient coverage, insufficient reference anchor points, and insufficient spatial resolution, respectively.

FIG. 11A is a diagram illustrating an example of a system 1100 for sensing with a line of sight (LOS) blockage. In FIG. 11A, the system 1100 is shown to include two buildings 1110a, 1110b and two target objects 1140a, 1140b (e.g., each in the form of a person). The system 1100 is also shown to include a network device 1120, which may be in the form of a base station (e.g., gNB or a portion of a gNB, such as a CU, DU, RU, Near-RT RIC, Non-RT RIC, etc.), located on the building 1110a. The network device 1120 (e.g., gNB) can operate as a radar Tx and/or a radar Rx for sensing purposes (e.g., for monostatic or bistatic sensing of a target, such as the targets 1140a, 1140b, each in the form of a person). The building 1110a may be obstructing the LOS from the network device 1120 (e.g., gNB) to the target 1140a, which is shown in the form of a person.

The system 1100 may include more or less network devices, than as shown in FIG. 11A. In addition, the system 1100 may include different types of network devices (e.g., mobile phones and/or vehicles), than as shown in FIG. 11A. In one or more examples, the network device 1120 (e.g., gNB) may be equipped with heterogeneous capability, which may include, but is not limited to, 4G/5G cellular connectivity, GPS capability, camera capability, radar capability, and/or LIDAR capability. The network device 1120 (e.g., gNB) may be capable of performing wireless communications with other network devices via communications signals.

In one or more examples, the network device 1120 (e.g., gNB) may be capable of transmitting and receiving sensing signals of some kind (e.g., camera, RF sensing signals, optical sensing signals, etc.). In some cases, the network device 1120 (e.g., gNB) may transmit and receive sensing signals (e.g., RF sensing signals 1130a, 1130b) for using one or more sensors to detect nearby targets (e.g., targets 1140a, 1140b). In some cases, the network device 1120 (e.g., gNB) can detect nearby targets based on one or more images or frames captured using one or more cameras.

The network device 1120 (e.g., gNB), which may operate as a radar Tx and/or radar Rx, may perform RF sensing (e.g., bistatic sensing or monostatic sensing) of at least one target (e.g., targets 1140a, 1140b) to obtain RF sensing measurements (e.g., Doppler, RTT, TOA, and/or TDOA measurements) of the targets (e.g., targets 1140a, 1140b). The RF sensing measurements of the targets (e.g., targets 1140a, 1140b) can be used (e.g., by at least one processor(s) of the network device 1120) to determine one or more characteristics (e.g., speed, location, distance, movement, heading, size, and/or other characteristics) of the targets (e.g., target 1140a, 1140b).

During operation of the system 1100 for sensing, for example when performing monostatic sensing of a target (e.g., targets 1140a, 1140b), the network device 1120 (e.g., gNB), operating as a radar Tx, may transmit an RF sensing signal 1130b towards the target 1140a. The RF sensing signal 1130b may be included within communication signals and sensing signals multiplexed (e.g., via time division multiplexing and/or frequency division multiplexing) together for joint communications and sensing purposes. However, since the LOS from the network device 1120 to the target 1140a is obstructed by the building 1110a, the sensing signal 1130b may not reach the target 1140a.

Also during operation of the system 1100, the network device 1120 (e.g., gNB), operating as a radar Tx, may transmit an RF sensing signal 1130a towards the target 1140b. The RF sensing signal 1130a may be included within communication signals and sensing signals multiplexed (e.g., via time division multiplexing and/or frequency division multiplexing) together for joint communications and sensing purposes. The sensing signal 1130a can reflect off of the target 1140b to produce a reflection sensing signal radiated in a direction back towards the network device 1120.

The network device 1120 (e.g., gNB), operating as a radar Rx, can receive the reflection sensing signal. After the network device 1120 (e.g., gNB) receives the reflection sensing signal, the network device 1120 (e.g., gNB) can obtain measurements (e.g., Doppler, RTT, TOA, and/or TDOA measurements) of the reflection sensing signal. At least one processor (e.g., processor 1810 of FIG. 18) of the network device 1120 (e.g., gNB) may then determine or compute the characteristics (e.g., speed, location, distance, movement, heading, size, etc.) of the target 1140b by using sensing measurements (e.g., Doppler, RTT, TOA, and/or TDOA measurements) from the received reflection sensing signal.

FIG. 11B is a diagram illustrating an example of a system 1102 for sensing with insufficient coverage. In FIG. 11B, the system 1102 is shown to include two target objects 1142a, 1142b (e.g., each in the form of a person). The system 1102 is also shown to include a network device 1152, which may be in the form of a base station (e.g., gNB or a portion of a gNB, such as a CU, DU, RU, Near-RT RIC, Non-RT RIC, etc.). The network device 1152 (e.g., gNB) may operate as a radar Tx and/or a radar Rx for sensing purposes (e.g., for monostatic or bistatic sensing of a target, such as targets 1142a, 1142b, each in the form of a person). The target object 1142a may be located inside of a boundary 1162 of the antenna coverage area of the network device 1152. However, the target object 1142b may be located outside of the boundary 1162 of the antenna coverage area of the network device 1152. As such, the system 1102 does not provide sufficient coverage for sensing the target 1142b.

The system 1102 can include more or less network devices, than as shown in FIG. 11B. In addition, the system 1102 can include different types of network devices (e.g., mobile phones and/or vehicles), than as shown in FIG. 11B. In one or more examples, the network device 1152 (e.g., gNB) may be equipped with heterogeneous capability, which can include, but is not limited to, 4G/5G cellular connectivity, GPS capability, camera capability, radar capability, and/or LIDAR capability. The network device 1152 (e.g., gNB) can be capable of performing wireless communications with other network devices via communications signals.

In one or more examples, the network device 1152 (e.g., gNB) can be capable of transmitting and receiving sensing signals of some kind (e.g., camera, RF sensing signals, optical sensing signals, etc.). In some cases, the network device 1152 (e.g., gNB) can transmit and receive sensing signals (e.g., RF sensing signals 1132a, 1132b) for using one or more sensors to detect nearby targets (e.g., targets 1142a, 1142b). In some cases, the network device 1152 (e.g., gNB) can detect nearby targets based on one or more images or frames captured using one or more cameras.

The network device 1152 (e.g., gNB), which may operate as a radar Tx and/or radar Rx, may perform RF sensing (e.g., bistatic sensing or monostatic sensing) of at least one target (e.g., targets 1142a, 1142b) to obtain RF sensing measurements (e.g., Doppler, RTT, TOA, and/or TDOA measurements) of the targets (e.g., targets 1142a, 1142b). The RF sensing measurements of the targets (e.g., targets 1142a, 1142b) can be used (e.g., by at least one processor(s) of the network device 1152) to determine one or more characteristics (e.g., speed, location, distance, movement, heading, size, and/or other characteristics) of the targets (e.g., targets 1142a, 1142b).

During operation of the system 1102 for sensing, for example when performing monostatic sensing of a target (e.g., targets 1142a, 1142b), the network device 1152 (e.g., gNB), operating as a radar Tx, may transmit an RF sensing signal 1132b towards the target 1142b. The RF sensing signal 1132b may be included within communication signals and sensing signals multiplexed (e.g., via time division multiplexing and/or frequency division multiplexing) together for joint communications and sensing purposes. However, since the target object 1142b may be located outside of the boundary 1162 of the antenna coverage area of the network device 1152, the sensing signal 1132b may not reach the target 1142b.

Also during operation of the system 1102, the network device 1152 (e.g., gNB), operating as a radar Tx, may transmit an RF sensing signal 1132a towards the target 1142a. The RF sensing signal 1132a may be included within communication signals and sensing signals multiplexed (e.g., via time division multiplexing and/or frequency division multiplexing) together for joint communications and sensing purposes. The sensing signal 1132a can reflect off of the target 1142a to produce a reflection sensing signal radiated in a direction back towards the network device 1152.

The network device 1152 (e.g., gNB), operating as a radar Rx, can receive the reflection sensing signal. After the network device 1152 (e.g., gNB) receives the reflection sensing signal, the network device 1152 (e.g., gNB) may obtain measurements (e.g., Doppler, RTT, TOA, and/or TDOA measurements) of the reflection sensing signal. At least one processor (e.g., processor 1810 of FIG. 18) of the network device 1152 (e.g., gNB) can then determine or compute the characteristics (e.g., speed, location, distance, movement, heading, size, etc.) of the target 1142a by using sensing measurements (e.g., Doppler, RTT, TOA, and/or TDOA measurements) from the received reflection sensing signal.

FIG. 11C is a diagram illustrating an example of a system 1104 for sensing with insufficient reference anchor points. In FIG. 11C, the system 1104 is shown to include two target objects 1174a, 1174b (e.g., each in the form of a drone). The system 1104 is also shown to include two network devices 1154a, 1154b, which may each be in the form of a base station (e.g., gNB or a portion of a gNB, such as a CU, DU, RU, Near-RT RIC, Non-RT RIC, etc.). The network devices 1154a, 1154b (e.g., gNBs) can each operate as a radar Tx and/or a radar Rx for sensing purposes (e.g., for monostatic or bistatic sensing of a target, such as the targets 1174a, 1174b, each in the form of a drone).

When using the TOA sensing method as previously discussed, in monostatic sensing, one network device (e.g., network device 1154a or 1154b, such as a gNB) can determine a circle (e.g., circle 1164a or 1164b) for possible target positions (e.g., each of the targets 1174a or 1174b may be located at a point on their respective circle). For example, in FIG. 11C, target 1174a may be located on a point on circle 1164a, and target 1174b may be located on a point on circle 1164b. Since there are many locations (e.g., many points on each circle) that each target may be located, the system 1104 provides an insufficient number of reference anchor points (e.g., network devices 1154a, 1154b) for each target object so as to narrow the number of possible locations for each target object.

The system 1104 can include more or less network devices, than as shown in FIG. 11C. In addition, the system 1104 can include different types of network devices (e.g., mobile phones and/or vehicles), than as shown in FIG. 11C. In one or more examples, the network devices 1154a, 1154b (e.g., gNBs) may each be equipped with heterogeneous capability, which may include, but is not limited to, 4G/5G cellular connectivity, GPS capability, camera capability, radar capability, and/or LIDAR capability. The network devices 1154a, 1154b (e.g., gNBs) may be capable of performing wireless communications with other network devices via communications signals.

In one or more examples, the network devices 1154a, 1154b (e.g., gNBs) may each be capable of transmitting and receiving sensing signals of some kind (e.g., camera, RF sensing signals, optical sensing signals, etc.). In some cases, the network devices 1154a, 1154b (e.g., gNBs) may each transmit and receive sensing signals (e.g., RF sensing signals 1134a, 1134b) for using one or more sensors to detect nearby targets (e.g., targets 1174a, 1174b). In some cases, the network devices 1154a, 1154b (e.g., gNBs) can detect nearby targets based on one or more images or frames captured using one or more cameras.

The network devices 1154a, 1154b (e.g., gNBs), which may each operate as a radar Tx and/or radar Rx, may perform RF sensing (e.g., bistatic sensing or monostatic sensing) of at least one target (e.g., targets 1174a, 1174b) to obtain RF sensing measurements (e.g., Doppler, RTT, TOA, and/or TDOA measurements) of the targets (e.g., targets 1174a, 1174b). The RF sensing measurements of the targets (e.g., targets 1174a, 1174b) may be used (e.g., by at least one processor(s) of the network devices 1154a, 1154b) to determine one or more characteristics (e.g., speed, location, distance, movement, heading, size, and/or other characteristics) of the targets (e.g., targets 1174a, 1174b).

During operation of the system 1104 for sensing, for example when performing monostatic sensing of a target (e.g., targets 1174a, 1174b), the network device 1154a (e.g., gNB), operating as a radar Tx, may transmit an RF sensing signal 1134a towards the target 1174a. The RF sensing signal 1134a may be included within communication signals and sensing signals multiplexed (e.g., via time division multiplexing and/or frequency division multiplexing) together for joint communications and sensing purposes. The sensing signal 1134a can reflect off of the target 1174a to produce a reflection sensing signal 1144a radiated in a direction back towards the network device 1154a.

The network device 1154a (e.g., gNB), operating as a radar Rx, can receive the reflection sensing signal 1144a. After the network device 1154a (e.g., gNB) receives the reflection sensing signal 1144a, the network device 1154a (e.g., gNB) can obtain measurements (e.g., Doppler, RTT, TOA, and/or TDOA measurements) of the reflection sensing signal 1144a. At least one processor (e.g., processor 1810 of FIG. 18) of the network device 1154a (e.g., gNB) may then determine or compute the characteristics (e.g., speed, location, distance, movement, heading, size, etc.) of the target 1174a by using sensing measurements (e.g., Doppler, RTT, TOA, and/or TDOA measurements) from the received reflection sensing signal 1144a. The network device 1154a (e.g., gNB) can determine a circle 1164a for possible target positions (e.g., the target 1174a may be located at a point on the circle 1164a).

Similarly, also during operation of the system 1104 for sensing, the network device 1154b (e.g., gNB), operating as a radar Tx, may transmit an RF sensing signal 1134b towards the target 1174b. The RF sensing signal 1134b may be included within communication signals and sensing signals multiplexed (e.g., via time division multiplexing and/or frequency division multiplexing) together for joint communications and sensing purposes. The sensing signal 1134b can reflect off of the target 1174b to produce a reflection sensing signal 1144b radiated in a direction back towards the network device 1154b.

The network device 1154b (e.g., gNB), operating as a radar Rx, can receive the reflection sensing signal 1144b. After the network device 1154b (e.g., gNB) receives the reflection sensing signal 1144b, the network device 1154b (e.g., gNB) may obtain measurements (e.g., Doppler, RTT, TOA, and/or TDOA measurements) of the reflection sensing signal 1144b. At least one processor (e.g., processor 1810 of FIG. 18) of the network device 1154b (e.g., gNB) can then determine or compute the characteristics (e.g., speed, location, distance, movement, heading, size, etc.) of the target 1174b by using sensing measurements (e.g., Doppler, RTT, TOA, and/or TDOA measurements) from the received reflection sensing signal 1144b. The network device 1154b (e.g., gNB) may determine a circle 1164b for possible target positions (e.g., the target 1174b may be located at a point on the circle 1164b).

FIG. 11D is a diagram illustrating an example of a system 1106 for sensing with insufficient spatial resolution. In FIG. 11D, the system 1106 is shown to include a target object 1146 (e.g., in the form of a person). The system 1106 is also shown to include two network devices 1126, 1176. The network device 1126 may be in the form of a base station (e.g., gNB or a portion of a gNB, such as a CU, DU, RU, Near-RT RIC, Non-RT RIC, etc.). The network device 1176 may be in the form of UE, such as a smart phone. The network devices 1126, 1176 may each operate as a radar Tx and/or a radar Rx for sensing purposes (e.g., for monostatic or bistatic sensing of a target, such as the target 1146 in the form of a person). The network device 1126, operating as a radar Tx, may transmit a sensing signal 1136, which has a wide beam 1166, towards the target 1146 for sensing of the target 1146. Since the sensing signal 1136 is a wide beam 1166, the resolution of the sensing of the target 1146 will be low such that the target object 1146 shape and hand and/or body gesture may not be recognized.

The system 1106 may include more or less network devices, than as shown in FIG. 11D. In addition, the system 1106 may include different types of network devices (e.g., vehicles), than as shown in FIG. 11D. In one or more examples, the network devices 1126, 1176 may each be equipped with heterogeneous capability, which may include, but is not limited to, 4G/5G cellular connectivity, GPS capability, camera capability, radar capability, and/or LIDAR capability. The network devices 1126, 1176 may each be capable of performing wireless communications with each other and/or other network devices via communications signals.

In one or more examples, the network devices 1126, 1176 may each be capable of transmitting and receiving sensing signals of some kind (e.g., camera, RF sensing signals, optical sensing signals, etc.). In some cases, the network devices 1126, 1176 may each transmit and receive sensing signals (e.g., RF sensing signal 1136) for using one or more sensors to detect nearby targets (e.g., target 1146). In some cases, the network devices 1126, 1176 can each detect nearby targets based on one or more images or frames captured using one or more cameras.

The network devices 1126, 1176, which may each operate as a radar Tx and/or radar Rx, may perform RF sensing (e.g., bistatic sensing or monostatic sensing) of at least one target (e.g., target 1146) to obtain RF sensing measurements (e.g., Doppler, RTT, TOA, and/or TDOA measurements) of the target(s) (e.g., target 1146). The RF sensing measurements of the target(s) (e.g., target 1146) can be used (e.g., by at least one processor(s) of the network devices 1126, 1176) to determine one or more characteristics (e.g., speed, location, distance, movement, heading, size, and/or other characteristics) of the target(s) (e.g., target 1146).

During operation of the system 1106 for sensing, for example when performing bistatic sensing of a target (e.g., target 1146), the network device 1126 (e.g., gNB), operating as a radar Tx, may transmit an RF sensing signal 1136 towards the target 1146. The RF sensing signal 1136 may be included within communication signals and sensing signals multiplexed (e.g., via time division multiplexing and/or frequency division multiplexing) together for joint communications and sensing purposes. Since the sensing signal 1136 is a wide beam 1166, the resolution of the sensing of the target 1146 will be low such that the shape and gesture (e.g., hand and/or body gesture) of the target 1146 (e.g., person) may not be recognized.

The sensing signal 1136 can reflect off of the target 1146 to produce a reflection sensing signal 1156 radiated in a direction towards the network device 1176 (e.g., UE). The network device 1176 (e.g., UE), operating as a radar Rx, can receive the reflection sensing signal 1156. After the network device 1176 (e.g., UE) receives the reflection sensing signal 1156, the network device 1176 (e.g., UE) can obtain measurements (e.g., Doppler, RTT, TOA, and/or TDOA measurements) of the reflection sensing signal 1156. At least one processor (e.g., processor 1810 of FIG. 18) of the network device 1176 (e.g., UE) may then determine or compute the characteristics (e.g., speed, location, distance, movement, heading, size, etc.) of the target 1146 by using sensing measurements (e.g., Doppler, RTT, TOA, and/or TDOA measurements) from the received reflection sensing signal 1156.

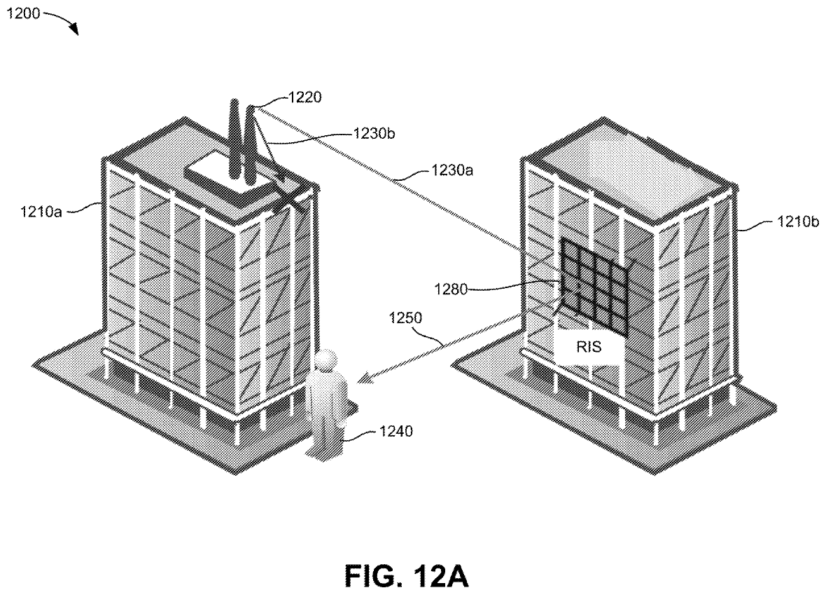

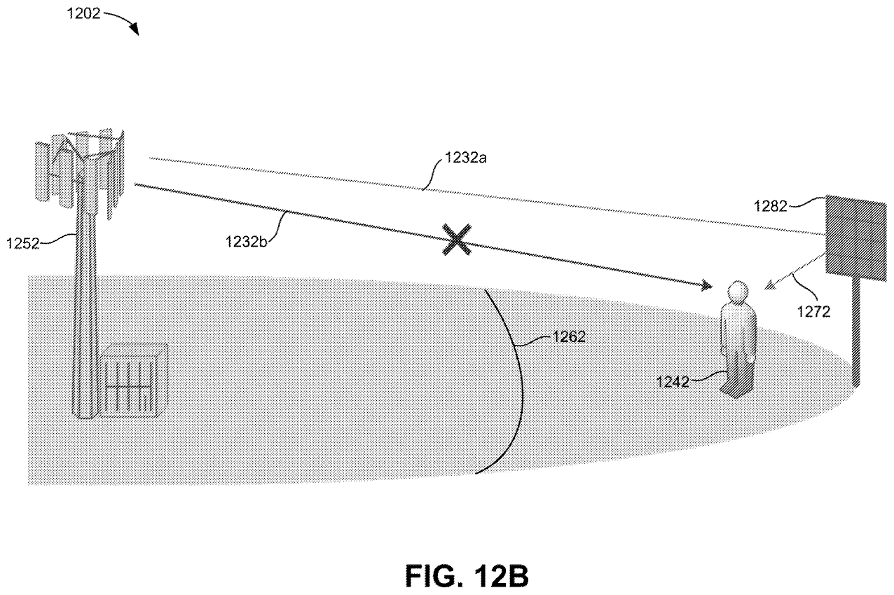

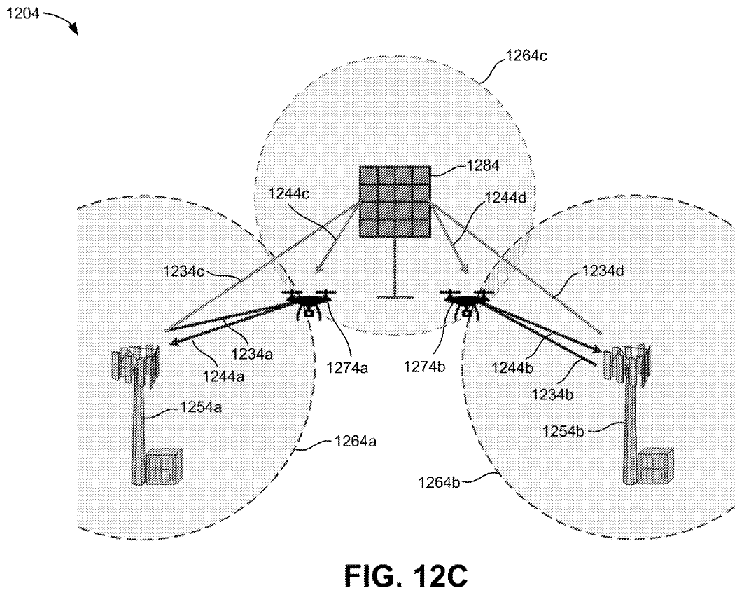

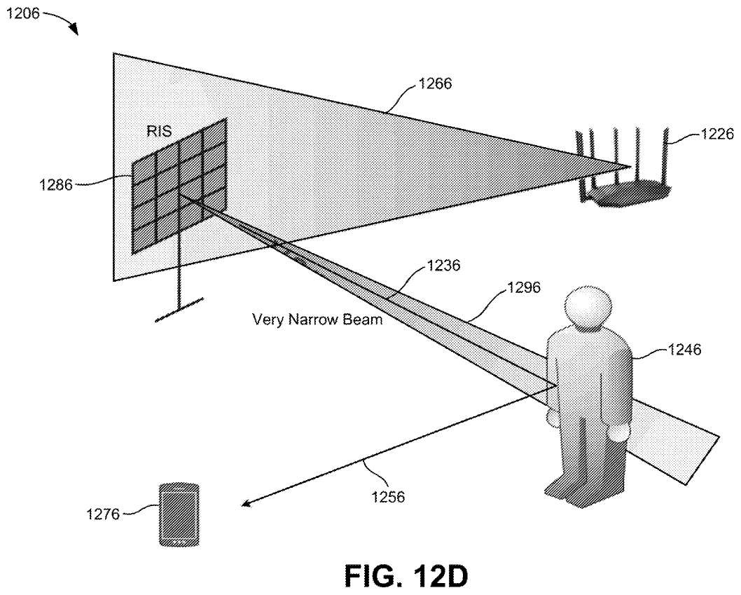

In one or more aspects, RIS-assisted sensing (e.g., adding a RIS to a sensing system, such as shown in FIG. 10B) may be employed to resolve the issues of LOS blockage, insufficient coverage, insufficient reference anchor points, and/or insufficient spatial resolution. FIGS. 12A, 12B, 12C, and 12D show examples of RIS-assisted sensing (e.g., systems employing a RIS for sensing) that overcome the issues of LOS blockage, insufficient coverage, insufficient reference anchor points, and insufficient spatial resolution, respectively. The addition of a RIS to a system (e.g., as compared to adding gNBs to the system) is low cost in deployment, hardware, radio resources, and network power consumption.

FIG. 12A is a diagram illustrating an example of a system 1200 for power saving in RIS-based sensing overcoming a LOS blockage. In FIG. 12A, the system 1200 is shown to include two buildings 1210a, 1210b and a target object 1240 (e.g., in the form of a person). The system 1200 is also shown to include a network device 1220, which may be in the form of a base station (e.g., gNB or a portion of a gNB, such as a CU, DU, RU, Near-RT RIC, Non-RT RIC, etc.), located on the building 1210a. The network device 1220 (e.g., gNB) may operate as a radar Tx and/or a radar Rx for sensing purposes (e.g., for monostatic or bistatic sensing of a target, such as the target 1240, in the form of a person). The system 1200 is also shown to include a RIS 1280 located on a side of the building 1210b. The building 1210a can obstruct the LOS from the network device 1220 (e.g., gNB) to the target 1240, which is shown in the form of a person.

The system 1200 can include more or less network devices, than as shown in FIG. 12A. In addition, the system 1200 can include different types of network devices (e.g., mobile phones and/or vehicles), than as shown in FIG. 12A. In one or more examples, the network device 1220 (e.g., gNB) can be equipped with heterogeneous capability, which may include, but is not limited to, 4G/5G cellular connectivity, GPS capability, camera capability, radar capability, and/or LIDAR capability. The network device 1220 (e.g., gNB) can be capable of performing wireless communications with other network devices via communications signals.

In one or more examples, the network device 1220 (e.g., gNB) can be capable of transmitting and receiving sensing signals of some kind (e.g., camera, RF sensing signals, optical sensing signals, etc.). In some cases, the network device 1220 (e.g., gNB) may transmit and receive sensing signals (e.g., RF sensing signals 1230a, 1230b) for using one or more sensors to detect nearby targets (e.g., target 1240). In some cases, the network device 1220 (e.g., gNB) may detect nearby targets based on one or more images or frames captured using one or more cameras.

The network device 1220 (e.g., gNB), which may operate as a radar Tx and/or radar Rx, can perform RF sensing (e.g., bistatic sensing or monostatic sensing) of at least one target (e.g., target 1240) to obtain RF sensing measurements (e.g., Doppler, RTT, TOA, and/or TDOA measurements) of the target(s) (e.g., target 1240). The RF sensing measurements of the target(s) (e.g., target 1240) can be used (e.g., by at least one processor(s) of the network device 1220) to determine one or more characteristics (e.g., speed, location, distance, movement, heading, size, and/or other characteristics) of the target(s) (e.g., target 1240).

The RIS 1280 may passively operate as a relay by reflecting signals (e.g., sensing signals) radiated from the network device (e.g., network device 1220 in the form of a gNB) in a direction towards a target (e.g., target 1240 in the form of a person). The RIS 1280 may also passively operate as a relay by reflecting signals (e.g., reflection sensing signals) from a target (e.g., target 1240) in a direction towards a network device (e.g., network device 1220).

During operation of the system 1200 for sensing, for example when performing monostatic sensing of a target (e.g., target 1240), the network device 1220 (e.g., gNB), operating as a radar Tx, can transmit an RF sensing signal 1230b towards the target 1240. The RF sensing signal 1230b may be included within communication signals and sensing signals multiplexed (e.g., via time division multiplexing and/or frequency division multiplexing) together for joint communications and sensing purposes. However, since the LOS from the network device 1220 to the target 1240 is obstructed by the building 1210a, the sensing signal 1230b may not reach the target 1240.

Also during operation of the system 1200, the network device 1220 (e.g., gNB), operating as a radar Tx, can transmit an RF sensing signal 1230a towards the RIS 1280. The RF sensing signal 1230a can be included within communication signals and sensing signals multiplexed (e.g., via time division multiplexing and/or frequency division multiplexing) together for joint communications and sensing purposes. The sensing signal 1230a can reflect off of the RIS 1280 to produce a reflection sensing signal 1250. Elements of the RIS 1280 can cause the reflection sensing signal 1250 to be radiated in a direction towards the target 1240.

The reflection sensing signal 1250 can reflect off of the target 1240 to produce a target reflection sensing signal radiated in a direction back towards the RIS 1280. The target reflection signal can reflect off of the RIS 1280 to produce a RIS reflection sensing signal. Elements of the RIS 1280 can cause the RIS reflection sensing signal to be radiated in a direction towards the network device 1220.

The network device 1220 (e.g., gNB), operating as a radar Rx, can receive the RIS reflection sensing signal. After the network device 1220 (e.g., gNB) receives the RIS reflection sensing signal, the network device 1220 (e.g., gNB) can obtain measurements (e.g., Doppler, RTT, TOA, and/or TDOA measurements) of the RIS reflection sensing signal. At least one processor (e.g., processor 1810 of FIG. 18) of the network device 1220 (e.g., gNB) can then determine or compute the characteristics (e.g., speed, location, distance, movement, heading, size, etc.) of the target 1240 by using sensing measurements (e.g., Doppler, RTT, TOA, and/or TDOA measurements) from the received RIS reflection sensing signal.

FIG. 12B is a diagram illustrating an example of a system 1202 for power saving in RIS-based sensing with sufficient coverage. In FIG. 12B, the system 1202 is shown to include a target object 1242 (e.g., in the form of a person). The system 1202 is also shown to include a network device 1252, which may be in the form of a base station (e.g., gNB or a portion of a gNB, such as a CU, DU, RU, Near-RT RIC, Non-RT RIC, etc.). The network device 1252 (e.g., gNB) can operate as a radar Tx and/or a radar Rx for sensing purposes (e.g., for monostatic or bistatic sensing of a target, such as target 1242 in the form of a person). The system 1202 is also shown to include a RIS 1282. The target object 1242 may be located outside of a boundary 1262 of the antenna coverage area of the network device 1252 and, as such, the system 1202 may not provide sufficient coverage for sensing the target 1242.

The system 1202 can include more or less network devices, than as shown in FIG. 12B. In addition, the system 1202 can include different types of network devices (e.g., mobile phones and/or vehicles), than as shown in FIG. 12B. In one or more examples, the network device 1252 (e.g., gNB) can be equipped with heterogeneous capability, which can include, but is not limited to, 4G/5G cellular connectivity, GPS capability, camera capability, radar capability, and/or LIDAR capability. The network device 1252 (e.g., gNB) may be capable of performing wireless communications with other network devices via communications signals.

In one or more examples, the network device 1252 (e.g., gNB) may be capable of transmitting and receiving sensing signals of some kind (e.g., camera, RF sensing signals, optical sensing signals, etc.). In some cases, the network device 1252 (e.g., gNB) may transmit and receive sensing signals (e.g., RF sensing signals 1232a, 1232b) for using one or more sensors to detect nearby targets (e.g., target 1242). In some cases, the network device 1252 (e.g., gNB) may detect nearby targets based on one or more images or frames captured using one or more cameras.

The network device 1252 (e.g., gNB), which may operate as a radar Tx and/or radar Rx, may perform RF sensing (e.g., bistatic sensing or monostatic sensing) of at least one target (e.g., target 1242) to obtain RF sensing measurements (e.g., Doppler, RTT, TOA, and/or TDOA measurements) of the target(s) (e.g., target 1242). The RF sensing measurements of the target(s) (e.g., target 1242) can be used (e.g., by at least one processor(s) of the network device 1252) to determine one or more characteristics (e.g., speed, location, distance, movement, heading, size, and/or other characteristics) of the target(s) (e.g., target 1242).

The RIS 1282 may passively operate as a relay by reflecting signals (e.g., sensing signals) radiated from the network device (e.g., network device 1252 in the form of a gNB) in a direction towards a target (e.g., target 1242 in the form of a person). The RIS 1282 may also passively operate as a relay by reflecting signals (e.g., reflection sensing signals) from a target (e.g., target 1242) in a direction towards a network device (e.g., network device 1252).

During operation of the system 1202 for sensing, for example when performing monostatic sensing of a target (e.g., target 1242), the network device 1252 (e.g., gNB), operating as a radar Tx, may transmit an RF sensing signal 1232b towards the target 1242. The RF sensing signal 1232b may be included within communication signals and sensing signals multiplexed (e.g., via time division multiplexing and/or frequency division multiplexing) together for joint communications and sensing purposes. However, since the target object 1242 may be located outside of the boundary 1262 of the antenna coverage area of the network device 1252, the sensing signal 1232b may not reach the target 1242 for sensing of the target 1242.

Also during operation of the system 1202, the network device 1252 (e.g., gNB), operating as a radar Tx, may transmit an RF sensing signal 1232a towards the RIS 1282. The RF sensing signal 1232a may be included within communication signals and sensing signals multiplexed (e.g., via time division multiplexing and/or frequency division multiplexing) together for joint communications and sensing purposes. The sensing signal 1232a can reflect off of the RIS 1282 to produce a reflection sensing signal 1272. Elements of the RIS 1282 can cause the reflection sensing signal 1272 to be radiated in a direction towards the target 1242.

The reflection sensing signal 1272 can reflect off of the target 1242 to produce a target reflection sensing signal radiated in a direction back towards the RIS 1282. The target reflection signal can reflect off of the RIS 1282 to produce a RIS reflection sensing signal. Elements of the RIS 1282 can cause the RIS reflection sensing signal to be radiated in a direction towards the network device 1252.

The network device 1252 (e.g., gNB), operating as a radar Rx, can receive the RIS reflection sensing signal. After the network device 1252 (e.g., gNB) receives the RIS reflection sensing signal, the network device 1252 (e.g., gNB) may obtain measurements (e.g., Doppler, RTT, TOA, and/or TDOA measurements) of the RIS reflection sensing signal. At least one processor (e.g., processor 1810 of FIG. 18) of the network device 1252 (e.g., gNB) may then determine or compute the characteristics (e.g., speed, location, distance, movement, heading, size, etc.) of the target 1242 by using sensing measurements (e.g., Doppler, RTT, TOA, and/or TDOA measurements) from the received RIS reflection sensing signal.

FIG. 12C is a diagram illustrating an example of a system 1204 for power saving in RIS-based sensing with sufficient reference anchor points. In FIG. 12C, the system 1204 is shown to include two target objects 1274a, 1274b (e.g., each in the form of a drone). The system 1204 is also shown to include two network devices 1254a, 1254b, which can each be in the form of a base station (e.g., gNB or a portion of a gNB, such as a CU, DU, RU, Near-RT RIC, Non-RT RIC, etc.). The network devices 1254a, 1254b (e.g., gNBs) may each operate as a radar Tx and/or a radar Rx for sensing purposes (e.g., for monostatic or bistatic sensing of a target, such as the targets 1274a, 1274b, each in the form of a drone). The system 1204 is also shown to include a RIS 1284.

When using the TOA sensing method as previously discussed, in monostatic sensing, one network device (e.g., network device 1254a or 1254b, such as a gNB) may determine a circle (e.g., circle 1264a or 1264b) for possible target positions (e.g., each of the targets 1274a or 1274b can be located at a point on their respective circle). For example, in FIG. 12C, target 1274a may be located on a point on circle 1264a, and target 1274b may be located on a point on circle 1264b. Since there are many locations (e.g., many points on each circle) that each target 1274a, 1274b may be located, the system 1204 provides an insufficient number of reference anchor points (e.g., network devices 1254a, 1254b) for each target 1274a, 1274b so as to narrow the number of possible locations for each target 1274a, 1274b.

The system 1204 can include more or less network devices, than as shown in FIG. 12C. In addition, the system 1204 can include different types of network devices (e.g., mobile phones and/or vehicles), than as shown in FIG. 12C. In one or more examples, the network devices 1254a, 1254b (e.g., gNBs) may each be equipped with heterogeneous capability, which can include, but is not limited to, 4G/5G cellular connectivity, GPS capability, camera capability, radar capability, and/or LIDAR capability. The network devices 1254a, 1254b (e.g., gNBs) can be capable of performing wireless communications with other network devices via communications signals.

In one or more examples, the network devices 1254a, 1254b (e.g., gNBs) can each be capable of transmitting and receiving sensing signals of some kind (e.g., camera, RF sensing signals, optical sensing signals, etc.). In some cases, the network devices 1254a, 1254b (e.g., gNBs) can each transmit and receive sensing signals (e.g., RF sensing signals 1234a, 1234b) for using one or more sensors to detect nearby targets (e.g., targets 1274a, 1274b). In some cases, the network devices 1254a, 1254b (e.g., gNBs) may detect nearby targets based on one or more images or frames captured using one or more cameras.

The network devices 1254a, 1254b (e.g., gNBs), which can each operate as a radar Tx and/or radar Rx, may perform RF sensing (e.g., bistatic sensing or monostatic sensing) of at least one target (e.g., targets 1274a, 1274b) to obtain RF sensing measurements (e.g., Doppler, RTT, TOA, and/or TDOA measurements) of the targets (e.g., targets 1274a, 1274b). The RF sensing measurements of the targets (e.g., targets 1274a, 1274b) can be used (e.g., by at least one processor(s) of the network devices 1254a, 1254b) to determine one or more characteristics (e.g., speed, location, distance, movement, heading, size, and/or other characteristics) of the targets (e.g., targets 1274a, 1274b).

The RIS 1284 may passively operate as a relay by reflecting signals (e.g., sensing signals) radiated from the network devices (e.g., network devices 1254a, 1254b, each in the form of a gNB) in a direction towards a target (e.g., targets 1274a, 1274b, each in the form of a drone). The RIS 1284 may also passively operate as a relay by reflecting signals (e.g., reflection sensing signals) from a target (e.g., targets 1274a, 1274b) in a direction towards a network device (e.g., network devices 1254a, 1254b).

During operation of the system 1204 for sensing, for example when performing monostatic sensing of a target (e.g., targets 1274a, 1274b), the network device 1254a (e.g., gNB), operating as a radar Tx, may transmit an RF sensing signal 1234a towards the target 1274a. The RF sensing signal 1234a may be included within communication signals and sensing signals multiplexed (e.g., via time division multiplexing and/or frequency division multiplexing) together for joint communications and sensing purposes. The sensing signal 1234a may reflect off of the target 1274a to produce a reflection sensing signal 1244a radiated in a direction back towards the network device 1254a.

The network device 1254a (e.g., gNB), operating as a radar Rx, can receive the reflection sensing signal 1244a. After the network device 1254a (e.g., gNB) receives the reflection sensing signal 1244a, the network device 1254a (e.g., gNB) may obtain measurements (e.g., Doppler, RTT, TOA, and/or TDOA measurements) of the reflection sensing signal 1244a. At least one processor (e.g., processor 1810 of FIG. 18) of the network device 1254a (e.g., gNB) can then determine or compute the characteristics (e.g., speed, location, distance, movement, heading, size, etc.) of the target 1274a by using sensing measurements (e.g., Doppler, RTT, TOA, and/or TDOA measurements) from the received reflection sensing signal 1244a. The network device 1254a (e.g., gNB) can determine a circle 1264a for possible target positions (e.g., the target 1274a may be located at a point on the circle 1264a).

Similarly, also during operation of the system 1204 for sensing, the network device 1254b (e.g., gNB), operating as a radar Tx, can transmit an RF sensing signal 1234b towards the target 1274b. The RF sensing signal 1234b may be included within communication signals and sensing signals multiplexed (e.g., via time division multiplexing and/or frequency division multiplexing) together for joint communications and sensing purposes. The sensing signal 1234b can reflect off of the target 1274b to produce a reflection sensing signal 1244b radiated in a direction back towards the network device 1254b.

The network device 1254b (e.g., gNB), operating as a radar Rx, can receive the reflection sensing signal 1244b. After the network device 1254b (e.g., gNB) receives the reflection sensing signal 1244b, the network device 1254b (e.g., gNB) may obtain measurements (e.g., Doppler, RTT, TOA, and/or TDOA measurements) of the reflection sensing signal 1244b. At least one processor (e.g., processor 1810 of FIG. 18) of the network device 1254b (e.g., gNB) may then determine or compute the characteristics (e.g., speed, location, distance, movement, heading, size, etc.) of the target 1274b by using sensing measurements (e.g., Doppler, RTT, TOA, and/or TDOA measurements) from the received reflection sensing signal 1244b. The network device 1254b (e.g., gNB) can determine a circle 1264b for possible target positions (e.g., the target 1274b can be located at a point on the circle 1264b).

Additionally, during operation of the system 1204, the network device 1254a (e.g., gNB), operating as a radar Tx, may transmit an RF sensing signal 1234c towards the RIS 1284. The RF sensing signal 1234c may be included within communication signals and sensing signals multiplexed (e.g., via time division multiplexing and/or frequency division multiplexing) together for joint communications and sensing purposes. The sensing signal 1234c may reflect off of the RIS 1284 to produce a reflection sensing signal 1244c. Elements of the RIS 1284 can cause the reflection sensing signal 1244c to be radiated in a direction towards the target 1274a.

The reflection sensing signal 1244c can reflect off of the target 1274a to produce a target reflection sensing signal radiated in a direction back towards the RIS 1284. The target reflection signal can reflect off of the RIS 1284 to produce a RIS reflection sensing signal. Elements of the RIS 1284 can cause the RIS reflection sensing signal to be radiated in a direction towards the network device 1254a.

The network device 1254a (e.g., gNB), operating as a radar Rx, can receive the RIS reflection sensing signal. After the network device 1254a (e.g., gNB) receives the RIS reflection sensing signal, the network device 1254a (e.g., gNB) can obtain measurements (e.g., Doppler, RTT, TOA, and/or TDOA measurements) of the RIS reflection sensing signal. At least one processor (e.g., processor 1810 of FIG. 18) of the network device 1254a (e.g., gNB) may then determine or compute the characteristics (e.g., speed, location, distance, movement, heading, size, etc.) of the target 1274a by using sensing measurements (e.g., Doppler, RTT, TOA, and/or TDOA measurements) from the received RIS reflection sensing signal. The network device 1254a (e.g., gNB) can determine a circle 1264c for possible target positions (e.g., the target 1274a can be located at a point on the circle 1264c).

Similarly, during operation of the system 1204, the network device 1254b (e.g., gNB), operating as a radar Tx, may transmit an RF sensing signal 1234d towards the RIS 1284. The RF sensing signal 1234d may be included within communication signals and sensing signals multiplexed (e.g., via time division multiplexing and/or frequency division multiplexing) together for joint communications and sensing purposes. The sensing signal 1234d can reflect off of the RIS 1284 to produce a reflection sensing signal 1244d. Elements of the RIS 1284 can cause the reflection sensing signal 1244d to be radiated in a direction towards the target 1274b.

The reflection sensing signal 1244d may reflect off of the target 1274b to produce a target reflection sensing signal radiated in a direction back towards the RIS 1284. The target reflection signal can reflect off of the RIS 1284 to produce a RIS reflection sensing signal. Elements of the RIS 1284 may cause the RIS reflection sensing signal to be radiated in a direction towards the network device 1254b.

The network device 1254b (e.g., gNB), operating as a radar Rx, can receive the RIS reflection sensing signal. After the network device 1254b (e.g., gNB) receives the RIS reflection sensing signal, the network device 1254b (e.g., gNB) may obtain measurements (e.g., Doppler, RTT, TOA, and/or TDOA measurements) of the RIS reflection sensing signal. At least one processor (e.g., processor 1810 of FIG. 18) of the network device 1254b (e.g., gNB) may then determine or compute the characteristics (e.g., speed, location, distance, movement, heading, size, etc.) of the target 1274b by using sensing measurements (e.g., Doppler, RTT, TOA, and/or TDOA measurements) from the received RIS reflection sensing signal. The network device 1254b (e.g., gNB) may determine the circle 1264c for possible target positions (e.g., the target 1274b can be located at a point on the circle 1264c).

With the determination of two circles for each target (e.g., circles 1264a, 1264c for target 1274a, and circles 1264b, 1264c for target 1274b, the location of each of the targets can be narrowed down to fewer possible locations. For example, the target 1274a can be determined to be located within an intersection area of the circles 1264a, 1264c, and the target 1274b can be determined to be located within an intersection area of the circles 1264b, 1264c.

FIG. 12D is a diagram illustrating an example of a system 1206 for power saving in RIS-based sensing with sufficient spatial resolution. In FIG. 12D, the system 1206 is shown to include a target object 1246 (e.g., in the form of a person). The system 1206 is also shown to include two network devices 1226, 1276. The network device 1226 may be in the form of a base station (e.g., gNB or a portion of a gNB, such as a CU, DU, RU, Near-RT RIC, Non-RT RIC, etc.), and the network device 1276 may be in the form of UE, such as a smart phone. The network devices 1226, 1276 can each operate as a radar Tx and/or a radar Rx for sensing purposes (e.g., for monostatic or bistatic sensing of a target, such as the target 1246 in the form of a person). The system is also shown to include a RIS 1286.

The network device 1226, operating as a radar Tx, may transmit a sensing signal, which has a wide beam 1266, towards the RIS 1286 for sensing of the target 1246. The sensing signal with the wide beam 1266 will reflect off of the RIS 1286 to produce a RIS reflection sensing signal 1236, which has a narrow beam 1296, radiated in a direction towards the target 1246. Since the RIS 1286 concentrates the wide beam 1266 of the sensing signal into the RIS reflection sensing signal 1236 with a narrow beam 1296, the resolution of the sensing of the target 1246 will be high such that the shape and/or gesture (e.g., hand and/or body gesture) of the target 1246 can be recognized.

The system 1206 may include more or less network devices, than as shown in FIG. 12D. In addition, the system 1206 may include different types of network devices (e.g., vehicles), than as shown in FIG. 12D. In one or more examples, the network devices 1226, 1276 can each be equipped with heterogeneous capability, which may include, but is not limited to, 4G/5G cellular connectivity, GPS capability, camera capability, radar capability, and/or LIDAR capability. The network devices 1226, 1276 may each be capable of performing wireless communications with each other and/or other network devices via communications signals.

In one or more examples, the network devices 1226, 1276 can each be capable of transmitting and receiving sensing signals of some kind (e.g., camera, RF sensing signals, optical sensing signals, etc.). In some cases, the network devices 1226, 1276 can each transmit and receive sensing signals (e.g., sensing signals 1266, 1256) for using one or more sensors to detect nearby targets (e.g., target 1246). In some cases, the network devices 1226, 1276 may each detect nearby targets based on one or more images or frames captured using one or more cameras.

The network devices 1226, 1276, which may each operate as a radar Tx and/or radar Rx, can perform RF sensing (e.g., bistatic sensing or monostatic sensing) of at least one target (e.g., target 1246) to obtain RF sensing measurements (e.g., Doppler, RTT, TOA, and/or TDOA measurements) of the target(s) (e.g., target 1246). The RF sensing measurements of the target(s) (e.g., target 1246) may be used (e.g., by at least one processor(s) of the network devices 1226, 1276) to determine one or more characteristics (e.g., speed, location, distance, movement, gesture, heading, size, and/or other characteristics) of the target(s) (e.g., target 1246).

The RIS 1286 can passively operate as a relay by reflecting signals (e.g., sensing signals) radiated from the network device (e.g., network device 1226 in the form of a gNB) in a direction towards a target (e.g., targets 1246 in the form of a person). The RIS 1286 can also passively operate as a relay by reflecting signals (e.g., reflection sensing signals) from a target (e.g., target 1246 in the form of a person) in a direction towards a network device (e.g., network device 1226 in the form of a gNB).

During operation of the system 1206 for sensing, for example when performing bistatic sensing of a target (e.g., target 1246), the network device 1226 (e.g., gNB), operating as a radar Tx, may transmit an RF sensing signal with a wide beam 1266 towards the target 1246. The RF sensing signal with a wide beam 1266 may be included within communication signals and sensing signals multiplexed (e.g., via time division multiplexing and/or frequency division multiplexing) together for joint communications and sensing purposes. The sensing signal with a wide beam 1266 can reflect off of the RIS 1286 to produce a reflection sensing signal 1236. Elements of the RIS 1286 can cause the sensing signal with a wide beam 1266 to produce a reflection sensing signal 1236 with a concentrated narrow beam 1296 that is radiated in a direction towards the target 1246.

The reflection sensing signal 1236 can reflect off of the target 1246 to produce a target reflection sensing signal 1256 radiated in a direction towards the network device 1276 (e.g., UE). The network device 1276 (e.g., UE), operating as a radar Rx, can receive the target reflection sensing signal 1256. After the network device 1276 (e.g., UE) receives the target reflection sensing signal 1256, the network device 1276 (e.g., UE) may obtain measurements (e.g., Doppler, RTT, TOA, and/or TDOA measurements) of the target reflection sensing signal 1256. At least one processor (e.g., processor 1810 of FIG. 18) of the network device 1276 (e.g., UE) can then determine or compute the characteristics (e.g., speed, location, distance, movement, gesture, heading, size, etc.) of the target 1246 by using sensing measurements (e.g., Doppler, RTT, TOA, and/or TDOA measurements) from the received target reflection sensing signal 1256. The network device 1276 (e.g., UE) may use the sensing measurements of the target reflection sensing signal 1256 to determine or compute the shape and/or gesture (e.g., hand and/or body gesture) of the target 1246 in the form of a person.

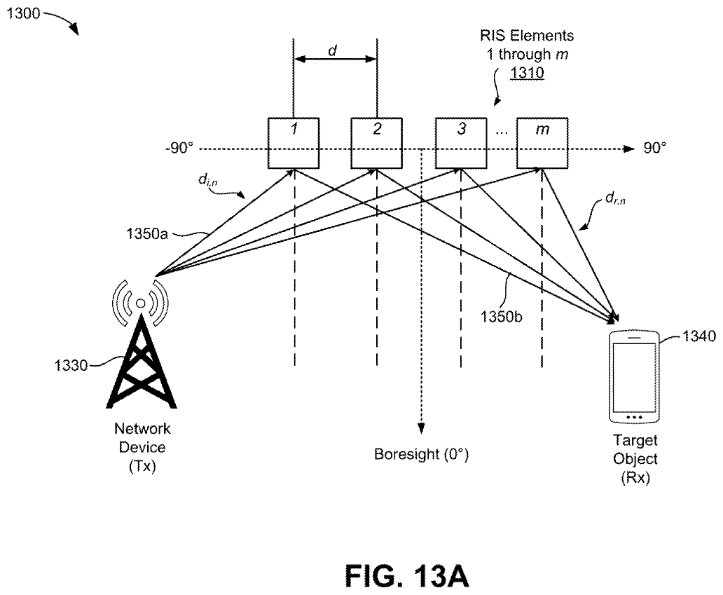

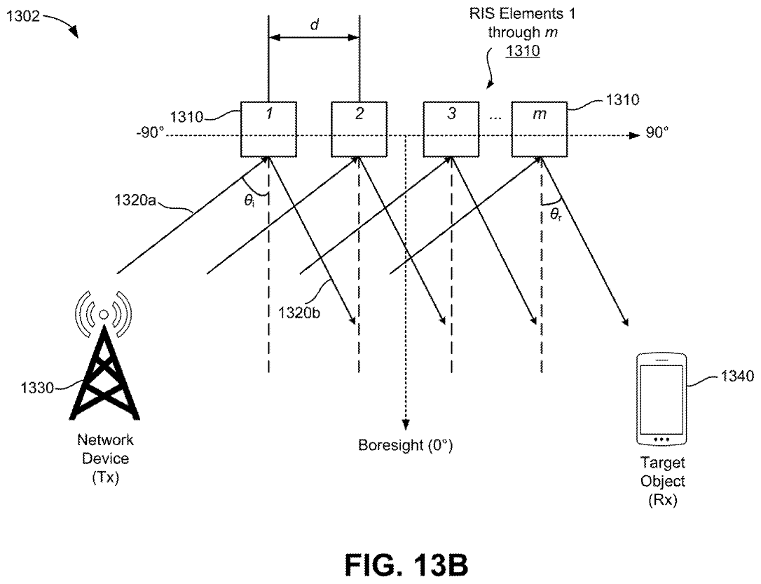

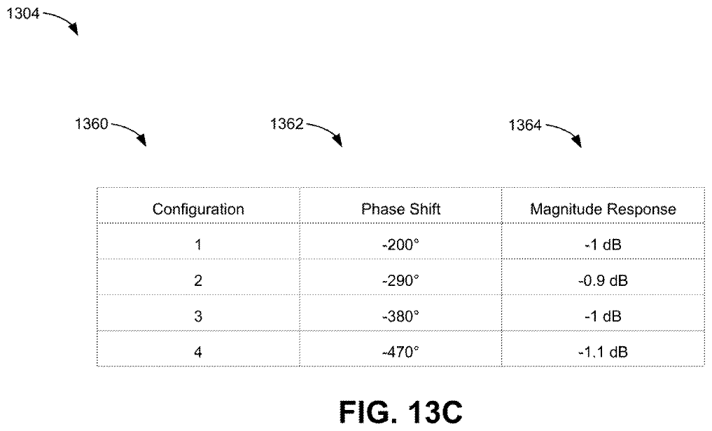

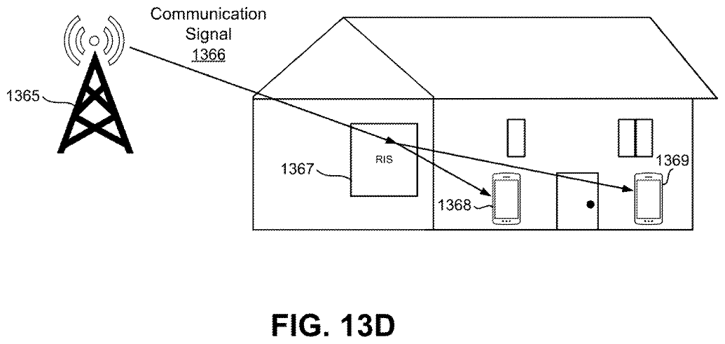

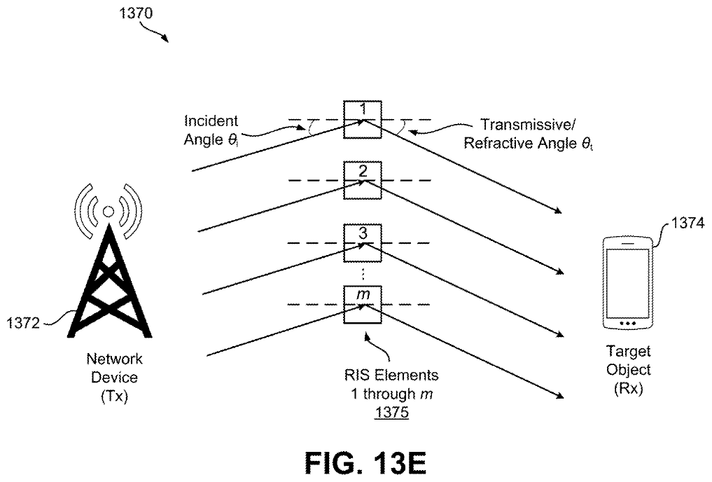

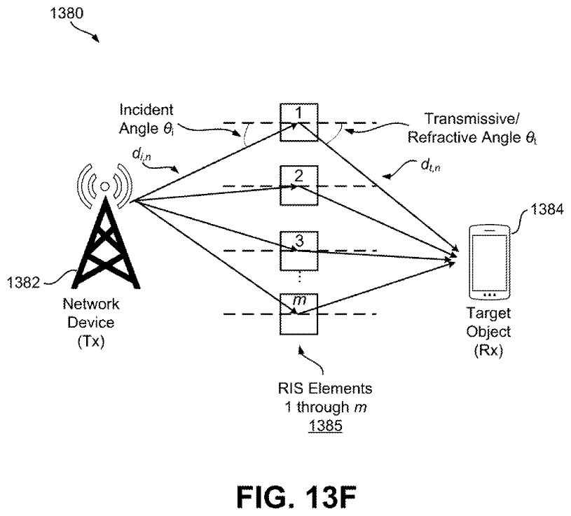

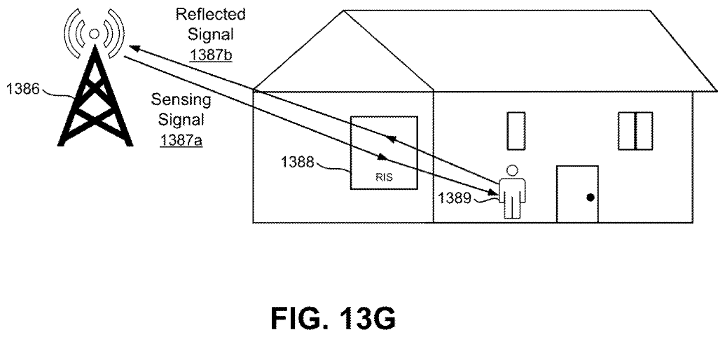

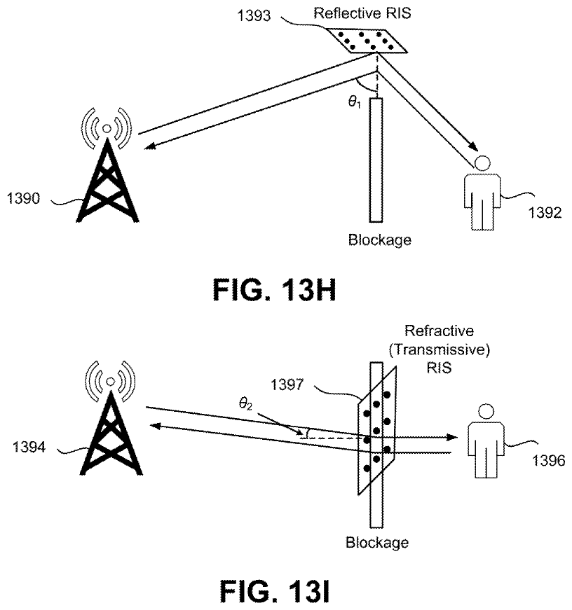

In one or more aspects, FIGS. 13A, 13B, and 13C show models (e.g., a general model and a far-field model) and configurations (e.g., configurations 1, 2, 3, and 4) for reflective beamforming by a RIS. In particular, FIG. 13A is a diagram illustrating an example of general model 1300 for a RIS that may be employed by the disclosed systems and techniques for power saving in RIS-based sensing. As previously mentioned, RISs can shape the wireless environment to a desirable form at low cost. In practice, RISs have three types of implementations, which include reflective (e.g., where signals can be reflected by the RIS), transmissive (e.g., where signals can penetrate the RIS), and hybrid (e.g., where the RIS may have a dual function of reflection and transmission).

A RIS is a programmable array structure that can be used to control the propagation of electromagnetic (EM) waves (e.g., steering the RF beam) by changing the electric and magnetic properties of the surface of the RIS. In FIG. 13A, the RIS includes an array of metamaterial RIS elements 1310, which are composed of ultra-thin surfaces inlaid with multiple wavelength scatters. The electromagnetic properties of the RIS elements 1310 can be dynamically controlled by applying a control signal to tunable elements (e.g., PIN diodes, varactor diodes, and/or other tunable elements) on the RIS elements 1310, which can enable active and intelligent modulation of electromagnetic waves in a programmable manner to form electromagnetic fields with controllable amplitude, phase, polarization, and/or frequency. For example, an electromagnetic response (e.g., a phase shift, which steers the RF beam) of the RIS elements 1310 can be controlled by programmable PIN diodes.

The RIS may passively operate as a relay by reflecting signals (e.g., signal 1350a). The signals (e.g., signal 1350a) may be transmitted from transmitter 1330 (e.g., a network device, for example, in the form of a base station, such as a gNB) towards the RIS at an incident angle with a distance d_{i,n}. The signals (e.g., signal 1350a) can reflect off of the RIS to produce reflection signals (e.g., signal 1350b), which may be reflected at a reflection angle with a distance d_{r,n}. The RIS elements 1310 can cause the reflection signals (e.g., signal 1350b) to be radiated in a specific direction (e.g., in a direction towards a receiver 1340, which may be in the form of a UE, such as a smart phone).

For the general model 1300 for a RIS, the transmitter 1330 and the receiver 1340 may be in the far field or in the near field of the RIS. For this general model 1300 for a RIS, the distance between the transmitter 1330 and the receiver 1340 for each meta-element 1310 of the RIS can be calculated. The left-most meta-element 1310 can be assigned to be meta-element zero. The calculated distances of each of the other meta-elements 1310 can be compared to the calculated distance for meta-element zero.

For the general model 1300, for incident angle {θ_{i,n}} and reflection angle {θ_{r,n}}, the reflection gain by the RIS may be:

$$h = {\sum }_{n = 0}^{N - 1} {e}^{- j \frac{2 π ( ( {d}_{i , n} - {d}_{i , 0} ) + ( {d}_{r , n} - {d}_{r , 0} ) )}{λ}} \cdot {α}_{n} {e}^{j {ϕ}_{n}} ,$$

where αₙe^{jφ}^{ₙ} is the reflective coefficient of meta-element n.

FIG. 13B is a diagram illustrating an example of far-field model 1302 for the RIS of FIG. 13A. The far-field model 1302 for a RIS of FIG. 13B is a simplification of the general model 1300 for a RIS of FIG. 13A. The RIS can passively operate as a relay by reflecting signals (e.g., signal 1320a in FIG. 13B). The signals (e.g., signal 1320a) may be transmitted from a transmitter 1330 (e.g., a network device, such as a base station, for example a gNB) towards the RIS at an incident angle θᵢ. The signals (e.g., signal 1320a) can reflect off of the RIS to produce reflection signals (e.g., signal 1320b in FIG. 13B), which may be reflected at a reflection angle θᵣ. The RIS elements 1310 can cause the reflection signals (e.g., signal 1320b) to be radiated in a specific direction (e.g., in a direction of a receiver 1340, such as a UE, for example a smart phone).

For FIG. 13B, it can be assumed that the network device 1330 (e.g., gNB) and the target object 1340 (e.g., UE) are both located in the far field of the surface of the RIS.

For this far-field model of 1302 for a RIS, for incident angle θᵢ and reflection angle θᵣ, the reflection gain by the RIS may be:

$$h = {\sum }_{n = 0}^{N - 1} {e}^{- j \frac{2 π n d}{λ} ( {sin θ}_{i} + {sin θ}_{r} )} \cdot {α}_{n} {e}^{j {ϕ}_{n}}$$

Optimally, α≡=α,

$${ϕ}_{n} = \frac{2 π n d}{λ} ( sin {θ}_{i} + sin {θ}_{r} ) .$$

Practically, {αₙ, φₙ} is derived from an enumerated set based on meta-element realization, where an is the magnitude response and φₙ is the phase shift.

FIG. 13C is a table 1304 illustrating example phase shifts and magnitude responses for different configurations of the RIS of FIGS. 13A and 13B. FIG. 13C is a table 1304 illustrating example phase shifts 1362 and magnitude responses 1364 for different configurations 1360 of the RIS of FIGS. 13A and 13B. In particular, in FIG. 13C, the corresponding phase shift 1362 and magnitude response 1364 (e.g., amplitude or channel response) for each of four different example configurations 1360 (e.g., configurations 1, 2, 3, and 4) for the RIS are shown in the table 1304. In some aspects, the configuration that has a configured magnitude response closest to a determined channel response h (or hₙ in some cases) is determined to be used for the RIS.

As previously mentioned, a RIS can operate as a passive device (e.g., where the RIS may not consume power in active radio wave radiation). Although the RIS can operate as a passive device, the RIS may consume power in meta-element operations. A varactor-diode-based meta-element (e.g., a unit cell) consumes almost no power. However, a PIN-diode-based meta-element can consume power dependent upon the PIN diode state (e.g., an ON-state or an OFF-state). When the PIN diode state is OFF (e.g., OFF-state), the consumed power can be negligible for each meta-element. When the PIN diode state is ON (e.g., ON-state), the consumed power can be approximately 0.33 mW per meta-element. As such, the total consumed power in the RIS may be approximately 0.33Nₒₙ mW (e.g., if the number of ON-state PIN diodes is Nₒₙ=10,000, then their total consumed power would be approximately 3.3 W). A PIN-diode-based meta-element can have a lower cost than a varactor-based meta-element and, as such, PIN-based-diode meta-elements can be broadly applied in economical RIS implementations.

In one or more aspects, for purposes of “green communication” (e.g., for reducing carbon emissions) or to extend the battery usage time, a “power-saving mode” can be configured for RIS-based sensing. Traditional power saving in an antenna array panel involves using less antenna elements than the total number of antenna elements in the antenna array panel (e.g., by switching off some of the antenna elements within the antenna array panel). However, employing a similar power saving approach in a RIS (e.g., using less meta-elements in the RIS panel, for example, by switching off some of the meta-elements in the RIS) can greatly reduce the beamforming gain (e.g., can reduce the beamforming gain by 3 decibels (dB) for every decreasing half of the meta-elements).

In one or more aspects, solutions for power saving in RIS-based sensing can provide a power saving method for PIN-diode-based meta-elements of a RIS. This power saving method can allow for all of the meta-elements to be utilized, while avoiding a large beamforming gain loss.

In one or more examples of these solutions, in RIS-based sensing, where the RIS is constructed of PIN-diode-based meta-elements, each meta-element may have two working modes (e.g., a normal mode and a power saving mode) based on power consumption values. In the normal mode, all configurations for the meta-elements of the RIS can be available. For example, this mode (e.g., the normal mode) can be used in a target object position measurement phase. In the power saving mode, one set of configurations for the meta-elements with a small number (or percentage) of ON-state PIN diodes can be available, while another set of configurations with a large number (or percentage) of ON-state PIN diodes may be unavailable. For example, this mode (e.g., the power saving mode) can be used in a target object existence detection phase.

In one or more aspects, these solutions can provide a RIS power saving working mode (e.g., only using low-power configurations with a small number or percentage of ON-state PIN diodes) for each meta-element of the RIS. Protocol and signaling designs are also provided for this RIS power saving working mode. Operating a RIS using the RIS power saving working mode can greatly reduce the RIS power consumption with only a slight reflection beamforming gain loss.

In one or more aspects, in RIS-based sensing, where a RIS is constructed of PIN-diode-based meta-elements, each RIS meta-element can have two working modes (e.g., “normal mode” and “power saving mode”) based on the power consumption values. In “normal mode”, all of the configurations are available. In one or more examples, this “normal mode” may be used in a “target object position measurement phase.” In “power saving mode”, one set of the configurations with a small number (or percentage) of “ON-state” PIN diodes may be available, while another set of configurations with a large number (or percentage) of “ON-state” PIN diodes may be unavailable. In one or more examples, this “power saving mode” may be used in a “target object existence detection phase.”

As noted previously, RISs have three types of implementations, which include reflective (e.g., where signals can be reflected by the RIS), transmissive (e.g., where signals can penetrate the RIS), and hybrid (e.g., where the RIS may have a dual function of reflection and transmission). Transmissive RISs can also be referred to as refractive RISs or penetrative RISs. In some case, a refractive RIS can be used in a scenario where a network device (e.g., a base station such as a gNB) is outside of a closed space (e.g., a room, a vehicle, a building, etc.) and a device (e.g., a UE) is inside of the closed space, when the network device is on one side of a wall or panel and the device is on another side of the wall or panel, and/or in other scenarios. FIG. 13D is a diagram illustrating an example of a scene in which a refractive RIS 1367 is used to direct a communication signal 1366 from a network device 1365 (e.g., a gNB) to a first target object 1368 (e.g., a first UE) and a second target object 1369 (e.g., a second UE).

FIG. 13E is a diagram illustrating an example of far-field model 1370 for a refractive (or transmissive) RIS. As shown in FIG. 13E, a network device 1372 (e.g., a base station such as a gNB) and a target object 1374 (e.g., a UE or other object) are both in the far field of a RIS surface including a plurality of RIS elements 1375. The network device 1372 can transmit a signal toward the RIS at an incident angle θᵢ. The equivalent channel response value of the nth RIS element of the RIS at transmissive (or refractive) angle θₜ can be represented as

$${h}_{n} = {e}^{- j \frac{2 π {d}_{n}}{λ} ( {sin θ}_{i} + {sin θ}_{t} )} \cdot {α}_{n} {e}^{j {θ}_{n}} ,$$

where αₙe^{jθ}^{ₙ} is the transmissive (or refractive) coefficient of the nth RIS element, dₙ is the distance between the nth RIS element to the first RIS element (e.g., RIS element 1 shown in FIG. 13E), and λ is wavelength.

The overall equivalent channel response value of the all RIS elements of the RIS at transmissive angle θₜ can be represented as

$$h = {\sum }_{n = 1}^{N} {h}_{n} = {\sum }_{n = 1}^{N} {e}^{- j \frac{2 π {d}_{n}}{λ} ( sin {θ}_{i} + {sin θ}_{t} )} \cdot {α}_{n} {e}^{j {ϕ}_{n}} .$$

In theory, if the transmissive/refractive coefficient satisfies αₙ≡α,

$${ϕ}_{n} = \frac{2 π {d}_{n}}{λ} ( sin {θ}_{i} + sin {θ}_{t} ) ,$$

then the transmissive beam can point in the direction θₜ. In practice, the coefficient amplitude and phase values of each meta-element are from a limited set (e.g., a set denoted as {(a₁, φ₁), (a₂, φ₂), . . . , (a_{M}, φ_{M})}) by different configurations, in which case the actual beam shape may have a certain deviation from the ideal beam (in the direction θₜ). As the number of RIS elements becomes larger, the actual beam shape becomes the closer to the ideal beam and the beam direction is more accurate.

FIG. 13F is a diagram illustrating an example of near-field model 1380 for a refractive (or transmissive) RIS. As shown in FIG. 13F, at least one of a network device 1382 (e.g., a base station such as a gNB) or a target object 1384 (e.g., a UE or other object) are in a near field of a RIS surface including a plurality of RIS elements 1385. The network device 1382 can transmit a signal toward the RIS at an incident angle θᵢ. If network device 1382 (as a transmitter) or the target object 1384 (as a receiver) are located in the near-field of the RIS surface, the incident angles θ_{i,n} or transmissive (or refractive) angles θ_{t,n} of multiple meta-elements are different.

The incident and transmissive angles θ_{i,n} and θ_{t,n} can be calculated based on the meta-element position, the orientation of the RIS, and the position of the network device 1382 (transmitter) and target object 1384 (receiver) relative to the RIS. The selected coefficient amplitude and phase αₙ and φₙ of each meta-element is should thus be related the distances d_{i,n}, d_{t,n} of the network device 1382 (transmitter) and target object 1384 (receiver), respectively, relative to the RIS.

Sensing can be performed based on a refractive/transmissive RIS (e.g., in addition or as alternative to using the RIS for communication). FIG. 13G is an example of a refractive/transmissive RIS 1388 used as an outside radar to sense an object 1389 on the inside of a building. As shown, a network device 1386 (e.g., a base station, such as a gnB) transmits a sensing signal 1387a. The sensing signal 1387a refracts from the RIS 1388 in a direction towards the object 1389. The refracted signal reflects from the object 1389 in a direction towards the RIS 1388. The reflected signal is refracted by the RIS 1388, resulting in a reflected signal 1387b being received by the network device 1386.

In some cases, a RIS can be used for sensing in addition to being used for communication (e.g., a gNB or UE in an integrated sensing and communication (ISAC) system). Such a solution can be used for various applications, such as indoor security (e.g., for intruder detection), safety (e.g., person monitoring), behavior detection (e.g., detecting behaviors such as walking, running, sitting, standing, etc.), status detection (e.g., whether a space is full or empty), among others.

Various differences exist between reflective RIS and refractive/transmissive RIS. FIG. 13H and FIG. 13I are diagrams illustrating differences between reflective and refractive/transmissive RISs. For example, FIG. 13H illustrates a reflective RIS 1393 reflecting signals from a network device 1390 in a direction towards an object 1392. For a reflective RIS, the radar (e.g., the transmitter, such as the network device 1390) is typically far away from a boresight direction, in which case the incident angle (shown as incident angle θ₁ in FIG. 13H) is greatly larger than zero. FIG. 13I illustrates a refractive RIS 1397 (or transmissive RIS) refracting signals from a network device 1394 in a direction towards an object 13926 For a refractive/transmissive RIS, the radar (e.g., the transmitter, such as the network device 1394) can be within or near the boresight direction, and thus the incident angle (shown as incident angle θ₂ in FIG. 13I) can be equal to or slightly larger than zero. Because the reflection/transmissive coefficient gain of each meta-element is proportional to cos 0, the transmissive RIS has higher meta-element radiation power than reflective RIS.

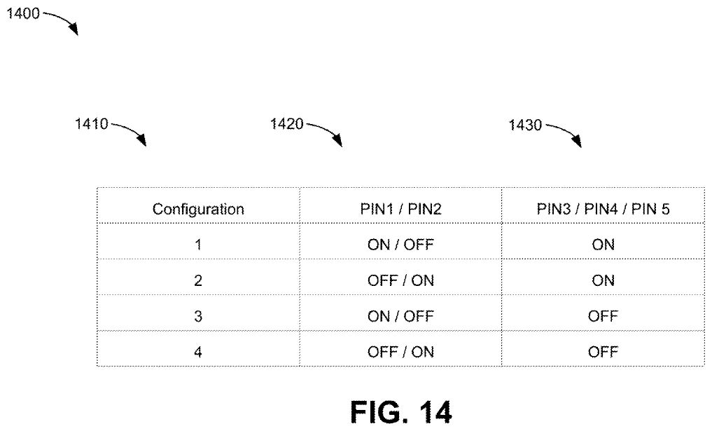

FIG. 14 shows examples of PIN diode states for different configurations 1410 for a RIS (e.g., a reflective RIS, a refractive/transmissive RIS, or hybrid RIS). In particular, FIG. 14 is table 1400 illustrating example states 1420 and 1430 (e.g., “ON-state” and “OFF-state”) of PIN diodes for different configurations of the RIS of FIGS. 13A and 13B. In the table 1400 of FIG. 14, for example, one meta-element may contain five (5) PIN diodes. For Configurations 1 and 2, PIN diodes 3, 4, and 5 may be in an “ON” state. For Configurations 3 and 4, PIN diodes 3, 4, and 5 may be in an “OFF” state.” Therefore, in the “power saving mode”, Configurations 3 and 4 with a small number (e.g., 1) or percentage (e.g., 20%) of “ON-state” PIN diodes are available, while Configurations 1 and 2 with a large number (e.g., 4) or percentage (e.g., 80%) of “ON-state” PIN diodes are unavailable.

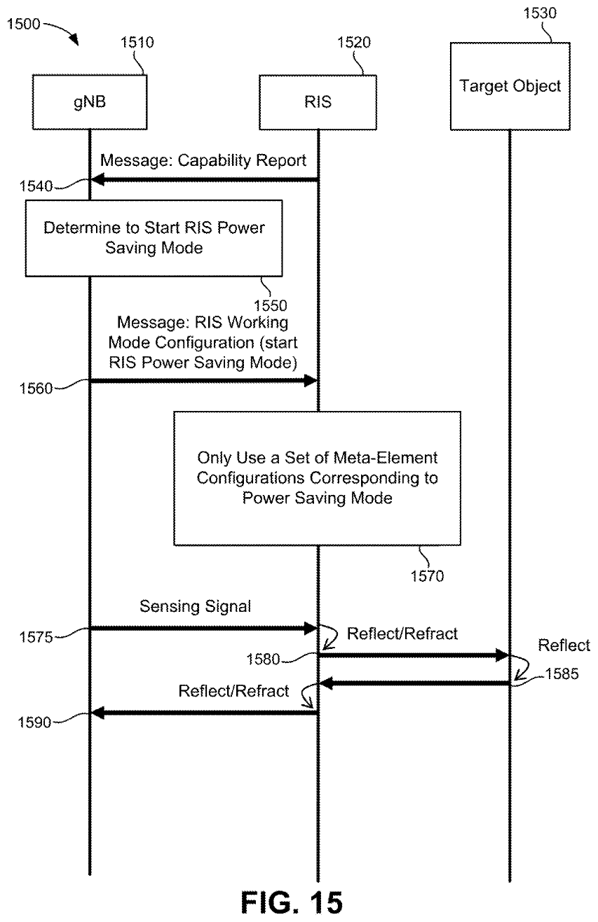

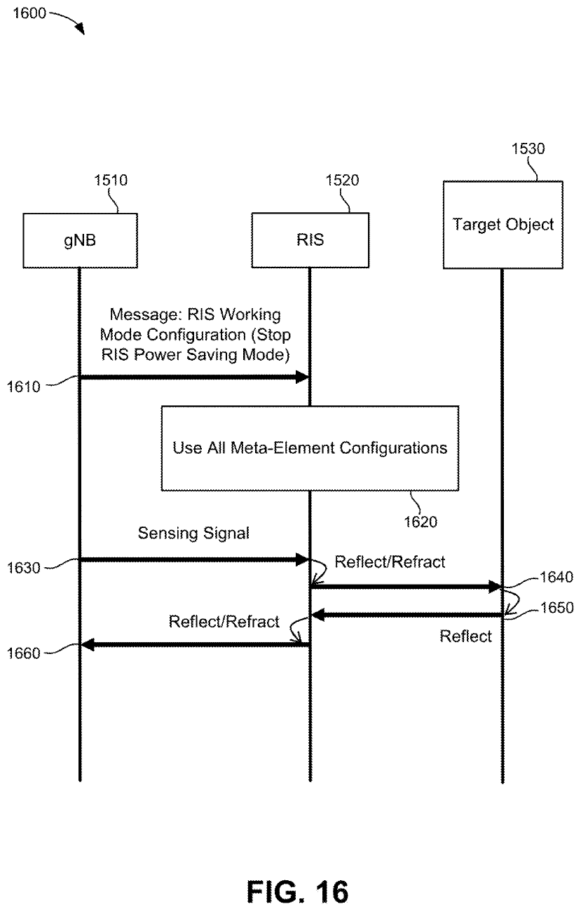

In one or more aspects, various different signaling may be employed for starting the “power saving mode” for a RIS (e.g., signaling 1500 of FIG. 15) and for stopping the “power saving mode” for a RIS (e.g., signaling 1600 of FIG. 16). In particular, FIG. 15 is a diagram showing an example of signaling 1500 that may be utilized for a system for power saving in RIS-based sensing (e.g., using a reflective RIS, a refractive/transmissive RIS, or hybrid RIS), where the signaling 1500 is for starting a RIS power saving mode. In FIG. 15, a RIS 1520 (e.g., RIS 1286 of FIG. 12D) may send a “capability report message” 1540 to a gNB 1510 (e.g., network device 1226 of FIG. 12D). The “capability report message” 1540 may indicate the power saving capability (e.g., whether the gNB is able to support this mode). Additionally, the RIS 1520 may include in the “capability report message” 1540 the type of the power saving (e.g., either utilizing partial meta-elements or partial configurations) and/or the effect of power saving (e.g., how much percentage of power to be saved).

After the gNB 1510 receives the “capability report message” 1540, the gNB 1510 may determine 1550 to start the RIS power saving mode. After determining to start the RIS power saving mode, the gNB 1510 may send a “RIS working mode configuration message” 1560 to the RIS 1520. The “RIS working mode configuration message” 1550 can indicate to the RIS 1520 to configure itself to start the power saving mode.

In one or more examples, there may be various different reasons to start the RIS power saving mode, which may include, but are not limited to, the possibility of a target object appearing is low (e.g., when sensing a target vehicle in the road at night), and only needing to sense the existence of the target object, but not measure its position (e.g., therefore, lower beamforming gain, wider beamwidth, and/or more sidelobes are allowable). In one or more examples, if the RIS 1520 is able to support two or more different types of power saving modes, the gNB 1510 can configure which type of power saving mode is to be used by the RIS 1520.

After the RIS 1520 receives the “RIS working mode configuration message” 1560, the RIS 1502 can only use a set of meta-element configurations (e.g., Configurations 3 or 4 in table 1400 of FIG. 14), corresponding to the power saving mode 1570, with a small number (or percentage) of PIN diodes with an on status (referred to as “ON-status” PIN diodes) in reflecting (in the case of a reflective RIS) and/or refracting (in the case of a refractive or transmissive RIS) the sensing signals. PIN diodes may also have an off status (referred to as “OFF-status” PIN diodes). After the RIS 1520 has configured its meta-elements for power saving mode, the gNB 1510 can transmit a sensing signal 1575 towards the RIS 1520 and the RIS 1520 can produce a sensing signal 1580. In the case of a reflective RIS, the sensing signal 1575 can reflect off of the RIS 1520 to produce a reflection sensing signal (as an example of the sensing signal 1580) radiated in a direction towards a target object 1530 (e.g., target 1246 in FIG. 12D in the form of a person). In the case of a refractive/transmissive RIS, the sensing signal 1575 can refract from the RIS 1520 to produce a refraction sensing signal (as an example of the sensing signal 1580) radiated in a direction towards the target object 1530 (e.g., target 1246 in FIG. 12D in the form of a person). The sensing signal 1580 (as a reflection sensing signal or refraction sensing signal) can reflect off of the target object 1530 to produce a target reflection sensing signal 1585 radiated in a direction back towards the RIS 1520. The target reflection sensing signal 1585 can reflect off of or refract from the RIS 1520 to produce a RIS sensing signal 1590 (which can be a reflection sensing signal in the case of a reflective RIS or a refraction sensing signal in the case of a refractive RIS) radiated in a direction back towards the gNB 1510, which can use the RIS sensing signal 1590 to determine characteristics of the target object 1530.

FIG. 16 is a diagram showing an example of signaling 1600 that may be utilized for a system for power saving in RIS-based sensing (e.g., using a reflective RIS, a refractive/transmissive RIS, or hybrid RIS), where the signaling 1600 is for stopping the RIS power saving mode. In FIG. 16, the gNB 1510 may determine to stop the RIS power saving mode. After the gNB 1510 determines to stop the RIS power saving mode, the gNB 1510 can send a “RIS working configuration mode” message 1610 to the RIS 1520. The “RIS working mode configuration message” 1610 can indicate to the RIS 1520 to configure itself to stop the power saving mode.

In one or more examples, there may be various different reasons to stop the RIS power saving mode, which may include, but are not limited to, the possibility of a target object appearing is high (e.g., sensing a target vehicle in the road in the daytime) and a need to measure the position or speed of a target object, or recognize or distinguish the target object (e.g., therefore, higher beamforming gain, narrower beamwidth, and/or less sidelobes may be required).

After the RIS 1520 receives the “RIS working mode configuration message” 1610, the RIS 1520 can use all of the meta-element configurations 1620 (e.g., Configurations 1, 2, 3, and 4 of table 1400 of FIG. 14) in reflecting and/or refracting the sensing signals. The gNB 1510 can then transmit a sensing signal 1630 towards the RIS 1520. The sensing signal 1630 can reflect off of the RIS 1520 to produce a sensing signal 1640 (which can be a reflection sensing signal in the case of a reflective RIS or a refraction sensing signal in the case of a refractive RIS) radiated in a direction towards a target object 1530. The sensing signal 1640 can reflect off of the target object 1530 to produce a target reflection sensing signal 1650 radiated in a direction back towards the RIS 1520. The target reflection sensing signal 1650 can reflect off of or refract from the RIS 1520 to produce a RIS sensing signal 1660 (which can be a reflection sensing signal in the case of a reflective RIS or a refraction sensing signal in the case of a refractive RIS) radiated in a direction back towards the gNB 1510, which can use the RIS sensing signal 1660 to determine characteristics of the target object 1530.

In one or more examples, a simulation was utilized to evaluate the beamforming gain and power consumption of the traditional “less elements” power saving method and the disclosed “less configurations” power saving method. For the simulation, a Baseline consisted of 32 meta-elements, with 2-bit phase quantization per element, where all configurations (e.g., Configurations 1, 2, 3, and 4 of table 1400 of FIG. 14) are available. A “less configuration” power saving method consisted of 32 meta-elements, with 1-bit phase quantization per element, where limited configurations (e.g., Configurations 3 and 4 of table 1400 of FIG. 14) are available. A traditional “less elements” power saving method consisted of 16 meta-elements, with 2-bit phase quantization per element, where all configurations (e.g., Configurations 1, 2, 3, and 4 of table 1400 of FIG. 14) are available. The simulation showed that the beamforming gain of the “less configuration” power saving method (e.g., which had an average of 13.2 dB) is in between the baseline (e.g., which had an average of 14.6 dB) and the traditional “less elements” power saving method (e.g., which had an average of 11.6 dB). The RIS power consumption (e.g., which may be equivalent to the total number of “ON-state” PIN diodes in the RIS) of the “less configurations” power saving method (e.g., which had an average Nₒₙ=32) is much less than the baseline (e.g., which had an average Nₒₙ=82.2) and quite less than the traditional “less elements” power saving method (e.g., which had an average Nₒₙ=42.2). In summary, the disclosed “less configuration” power saving method can greatly reduce the RIS power consumption (e.g., by 32/82.2=39%), with slight reflection and/or refraction beamforming gain loss (e.g., of 14.6−13.2=1.4 dB). As such, the simulation results show that the RIS power saving mode allows for a large reduction in RIS power consumption with only a minor loss in reflection and/or refraction beamforming gain.

In one or more aspects, in some use cases, the gNB can configure to the RIS, a maximum percentage threshold γₘₐₓ, which means that the RIS should keep the power consumption under (or not above) this percentage threshold compared with the baseline. The baseline refers to the average power consumption, when all of the meta-elements are utilized, and all the meta-element configurations are available. Normally, each meta-element configuration can have equal probability to be used. The RIS may report the power consumption value under the baseline (e.g., the total consumed power).

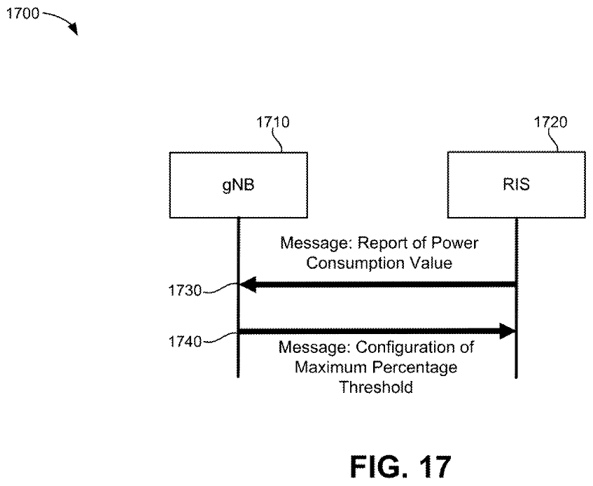

FIG. 17 shows example signaling between a gNB 1710 (e.g., network device 1226 of FIG. 12D) and a RIS 1720 (e.g., RIS 1286 of FIG. 12) for the gNB 1710 to configure to the RIS 1720 a maximum percentage threshold for power consumption. In particular, FIG. 17 is a diagram showing an example of signaling 1700 that may be utilized for a system for power saving in RIS-based sensing, where the signaling 1700 is for configuring a maximum percentage threshold. In FIG. 17, the RIS 1720 may send a “power consumption value report message” 1730 to the gNB 1710. After the gNB 1710 receives the “power consumption value report message” 1730 from the RIS 1720, the gNB 1710 may send a “configuration of maximum percentage threshold message” 1740 to the RIS 1720. The “configuration of maximum percentage threshold message” 1740 may indicate a maximum percentage threshold γₘₐₓ to the RIS such that the RIS should keep its power consumption below (or not above) the maximum percentage threshold as compared to the baseline average power consumption. Based on this maximum percentage threshold, the RIS 1720 can determine two sets of meta-elements (e.g., which may include Set 1 including meta-elements with all available configurations, and Set 2 including meta-elements with only low power configurations), so as to maximize the reflection and/or refraction beamforming gain, while keeping the power consumption to satisfy the requirement.

In one or more examples, the gNB may configure γₘₐₓ=50%. Then, the RIS 1720 can determine the number of two sets. The RIS 1720 can calculate that the average number of “ON-status” PIN diodes for all meta-element configurations (e.g., assuming each configuration has equal possibility) is (4+4+1+1)/4=2.5 and, as such, totally the RIS has 32×2.5=80 ON-status PIN diodes. For each meta-element in Set 1, the maximum number of “ON-status” PIN diodes can be equal to 4. For each meta-element in Set 2, the number of “ON-status” PIN diodes can be equal to 1. As such, to keep the number of “ON-status” PIN diodes not larger than 80×50%=40, among the total 32 meta-elements, the number of meta-elements in Set 1 and Set 2 are N₁=2 and N₂=30, respectively. The number of meta-elements in Set 1 and Set 2 may be calculated using the following formulas:

$${N}_{1} + {N}_{2} = 32$$

$$4 {N}_{1} + {N}_{2} \leq 40$$

The RIS 1720 can properly select N₁ meta-elements to be able to use all of the configurations (e.g., those meta-elements whose optimal phase shift values are the closest to the phase shift values of Configuration 1 or 2 (each with 4 “ON-status” PIN diodes) of table 1400 of FIG. 14). These two configurations can result in the N₁ meta-elements have an improved phase shift.

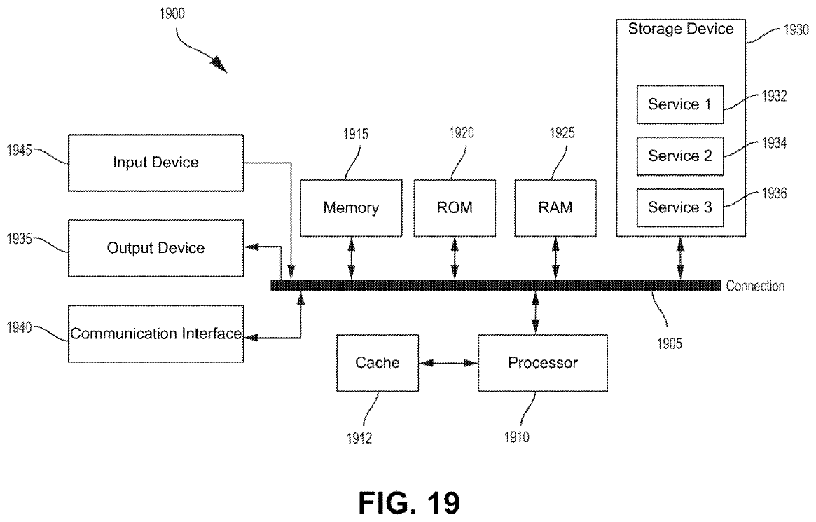

FIG. 18A is a flow chart illustrating an example of a process 1800 for wireless communications utilizing methods for reporting a minimum reflection beam amount in a RIS-based sensing system. The process 1800 can be performed by a RIS (e.g., the RIS 123 of FIG. 1) or by a component or system (e.g., a chipset) of the RIS. The operations of the process 1800 may be implemented as software components that are executed and run on one or more processors (e.g., the processor(s) 484 of FIG. 4, the processor 1910 of FIG. 19, and/or other processor(s)). Further, the transmission and reception of signals by the wireless communications device in the process 1800 may be enabled, for example, by one or more antennas (e.g., the antenna 487 of FIG. 4, and/or other antenna(s)) and/or one or more transceivers such as one or more wireless transceivers (e.g., the wireless transceiver(s) 478 of FIG. 4, the communication interface 1940 of FIG. 9, and/or other transceiver(s)).

At block 1810, the RIS (or component thereof) can receive a start RIS working mode configuration message including an indication to start a power saving mode.

At block 1820, the RIS (or component thereof) can configure, based on the power saving mode, a meta-element configuration for a plurality of meta-elements of the RIS from a set of meta-element configurations. In some aspects, the meta-element configuration indicates, for each of the plurality of meta-elements of the RIS, a low number of PIN diodes with an on status and/or a low percentage of PIN diodes with an on status. In some cases, the RIS (or component thereof) can receive a stop RIS working mode configuration message including an indication to stop the power saving mode.

In some aspects, the RIS (or component thereof) can transmit a capability report message. For example, the capability report message can include an indication of whether the RIS is capable of operating in the power saving mode. Additionally or alternatively, in some cases, the capability report message can include an indication of a type of the power saving mode capable by the RIS and/or an effect of the power saving mode. In some examples, the type of the power saving mode is using partial meta-elements of the RIS and/or using partial configurations for the RIS. In some examples, the effect of the power saving mode is a percentage of power saved.

In some aspects, the RIS (or component thereof) can configure an additional meta-element configuration for the plurality of meta-elements of the RIS from a set of all possible meta-element configurations. In some cases, a number of PIN diodes with an on status in the meta-element configuration is lower than a number of PIN diodes with an on status in the additional meta-element configuration, or wherein a percentage of PIN diodes with an on status in the meta-element configuration is lower than a percentage of PIN diodes with an on status in the additional meta-element configuration.

In some cases, the RIS (e.g., at least one meta-element of the plurality of meta-elements of the RIS) can reflect a sensing signal to produce a reflection sensing signal radiating in a direction towards a target object. In some examples, the RIS (e.g., at least one meta-element of the plurality of meta-elements of the RIS) can reflect a target reflection sensing signal to produce a RIS reflection sensing signal radiating in a direction towards a network device. The network device can be a base station or a portion of a base station (e.g., the CU 211, the DU 231, the RU 241, the Non-RT RIC 217, and/or the Near-RT RIC 227 of the disaggregated base station 201 of FIG. 2). In some cases, the RIS (e.g., at least one meta-element of the plurality of meta-elements of the RIS) can refract a sensing signal to produce a refraction sensing signal radiating in a direction towards a target object. In some cases, the RIS (e.g., at least one meta-element of the plurality of meta-elements of the RIS) can refract a target reflection sensing signal to produce a RIS refraction sensing signal radiating in a direction towards a network device. The target object can include a person, a computing device, a building, or any other object (e.g., target object 1530 (e.g., target 1246 in FIG. 12D in the form of a person).

In some cases, the RIS (or component thereof) can transmit a report of power consumption value message including an indication of a power consumption value under a baseline of total consumed power of the RIS. Additionally or alternatively, in some cases, the RIS (or component thereof) can receive a configuration of maximum percentage threshold message including an indication of a maximum percentage threshold for power consumption of the RIS.

FIG. 18B is a flow chart illustrating an example of a process 1850 for wireless communications utilizing methods for reporting a minimum reflection beam amount in a RIS-based sensing system. The process 1850 can be performed by a network device or by a component or system (e.g., a chipset) of the network device. The network device can include a base station (e.g., the base station 102 of FIG. 1), a portion of a base station having a disaggregated architecture (e.g., the CU 211, the DU 231, the RU 241, the Non-RT RIC 217, and/or the Near-RT RIC 227 of the disaggregated base station 201 of FIG. 2), a UE, or other network device. The operations of the process 1850 may be implemented as software components that are executed and run on one or more processors (e.g., the processor 1910 of FIG. 19 and/or other processor(s)). Further, the transmission and reception of signals by the wireless communications device in the process 1850 may be enabled, for example, by one or more antennas (e.g., the antenna 487 of FIG. 4, and/or other antenna(s)) and/or one or more transceivers such as one or more wireless transceivers (e.g., the wireless transceiver(s) 478 of FIG. 4, the communication interface 1940 of FIG. 9, and/or other transceiver(s)).

At block 1860, the network device (or component thereof) can receive a capability report message from a reconfigurable intelligent surface (RIS). In some aspects, the capability report message includes an indication of whether the RIS is capable of operating in the power saving mode. Additionally or alternatively, in some cases, the capability report message includes a type of the power saving mode and/or an effect of the power saving mode. In some examples, the type of the power saving mode is using partial meta-elements of the RIS and/or using partial configurations for the RIS. In some examples, the effect of the power saving mode is a percentage of power saved.

At block 1870, the network device (or component thereof) can determine for the RIS to start a power saving mode based on the capability report message.

At block 1880, the network device (or component thereof) can transmit a start RIS working mode configuration message including an indication to the RIS to start the power saving mode. In some aspects, the network device (or component thereof) can receive a report of power consumption value message including an indication of a power consumption value under a baseline of total consumed power of the RIS. In some cases, the network device (or component thereof) can transmit a configuration of maximum percentage threshold message including an indication of a maximum percentage threshold for power consumption of the RIS. In some examples, the network device (or component thereof) can transmit a stop RIS working mode configuration message including an indication to the RIS to stop the power saving mode.

In some aspects, the network device (or component thereof) can transmit a sensing signal towards the RIS. In some cases, the network device (or component thereof) can receive a RIS reflection sensing signal from the RIS.

FIG. 19 is a block diagram illustrating an example of a computing system 1900, which may be employed by the disclosed systems and techniques for power saving in RIS-based sensing. In particular, FIG. 19 illustrates an example of computing system 1900, which can be, for example, any computing device making up internal computing system, a remote computing system, a camera, or any component thereof in which the components of the system are in communication with each other using connection 1905. Connection 1905 can be a physical connection using a bus, or a direct connection into processor 1910, such as in a chipset architecture. Connection 1905 can also be a virtual connection, networked connection, or logical connection.

In some aspects, computing system 1900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1900 includes at least one processing unit (CPU or processor) 1910 and connection 1905 that communicatively couples various system components including system memory 1915, such as read-only memory (ROM) 1920 and random access memory (RAM) 1925 to processor 1910. Computing system 1900 can include a cache 1912 of high-speed memory connected directly with, in close proximity to, or integrated as part of processor 1910.

Processor 1910 can include any general purpose processor and a hardware service or software service, such as services 1932, 1934, and 1936 stored in storage device 1930, configured to control processor 1910 as well as a special-purpose processor where software instructions are incorporated into the actual processor design. Processor 1910 may essentially be a completely self-contained computing system, containing multiple cores or processors, a bus, memory controller, cache, etc. A multi-core processor may be symmetric or asymmetric.

To enable user interaction, computing system 1900 includes an input device 1945, which can represent any number of input mechanisms, such as a microphone for speech, a touch-sensitive screen for gesture or graphical input, keyboard, mouse, motion input, speech, etc. Computing system 1900 can also include output device 1935, which can be one or more of a number of output mechanisms. In some instances, multimodal systems can enable a user to provide multiple types of input/output to communicate with computing system 1900.

Computing system 1900 can include communications interface 1940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1940 may also include one or more range sensors (e.g., LIDAR sensors, laser range finders, RF radars, ultrasonic sensors, and infrared (IR) sensors) configured to collect data and provide measurements to processor 1910, whereby processor 1910 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1940 may also include one or more Global Navigation Satellite System (GNSS) receivers or transceivers that are used to determine a location of the computing system 1900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1930 can include software services, servers, services, etc., that when the code that defines such software is executed by the processor 1910, it causes the system to perform a function. In some aspects, a hardware service that performs a particular function can include the software component stored in a computer-readable medium in connection with the necessary hardware components, such as processor 1910, connection 1905, output device 1935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A reconfigurable intelligent surface (RIS) for wireless communication, the RIS comprising: at least one memory; and at least one processor coupled to the at least one memory and configured to: receive a start RIS working mode configuration message comprising an indication to start a power saving mode; and configure, based on the power saving mode, a meta-element configuration for a plurality of meta-elements of the RIS from a set of meta-element configurations.

Aspect 2. The RIS of Aspect 1, wherein the at least one processor is configured to output for transmission a capability report message.

Aspect 3. The RIS of Aspect 2, wherein the capability report message comprises an indication of whether the RIS is capable of operating in the power saving mode.

Aspect 4. The RIS of any of Aspects 2 or 3, wherein the capability report message further comprises an indication of at least one of a type of the power saving mode capable by the RIS or an effect of the power saving mode.

Aspect 5. The RIS of Aspect 4, wherein the type of the power saving mode is at least one of using partial meta-elements of the RIS or using partial configurations for the RIS.

Aspect 6. The RIS of any of Aspects 4 or 5, wherein the effect of the power saving mode is a percentage of power saved.

Aspect 7. The RIS of any of Aspects 1 to 6, wherein the meta-element configuration indicates, for each of the plurality of meta-elements of the RIS, at least one of a low number of PIN diodes with an on status or a low percentage of PIN diodes with an on status.

Aspect 8. The RIS of any of Aspects 1 to 7, wherein the at least one processor is configured to receive a stop RIS working mode configuration message comprising an indication to stop the power saving mode.

Aspect 9. The RIS of Aspect 8, wherein the at least one processor is configured to configure an additional meta-element configuration for the plurality of meta-elements of the RIS from a set of all possible meta-element configurations.

Aspect 10. The RIS of Aspect 9, wherein a number of PIN diodes with an on status in the meta-element configuration is lower than a number of PIN diodes with an on status in the additional meta-element configuration, or wherein a percentage of PIN diodes with an on status in the meta-element configuration is lower than a percentage of PIN diodes with an on status in the additional meta-element configuration.

Aspect 11. The RIS of any of Aspects 1 to 10, further comprising the plurality of meta-elements, wherein at least one meta-element of the plurality of meta-elements is configured to reflect a sensing signal to produce a reflection sensing signal radiating in a direction towards a target object.

Aspect 12. The RIS of any of Aspects 1 to 11, further comprising the plurality of meta-elements, wherein at least one meta-element of the plurality of meta-elements is configured to reflect a target reflection sensing signal to produce a RIS reflection sensing signal radiating in a direction towards a network device.

Aspect 13. The RIS of Aspect 12, wherein the network device is a base station.

Aspect 14. The RIS of any of Aspects 1 to 13, further comprising the plurality of meta-elements, wherein at least one meta-element of the plurality of meta-elements is configured to refract a sensing signal to produce a refraction sensing signal radiating in a direction towards a target object.

Aspect 15. The RIS of any of Aspects 1 to 14, further comprising the plurality of meta-elements, wherein at least one meta-element of the plurality of meta-elements is configured to refract a target reflection sensing signal to produce a RIS refraction sensing signal radiating in a direction towards a network device.

Aspect 16. The RIS of any of Aspects 1 to 15, wherein the at least one processor is configured to output for transmission a report of power consumption value message comprising an indication of a power consumption value under a baseline of total consumed power of the RIS.

Aspect 17. The RIS of any of Aspects 1 to 16, wherein the at least one processor is configured to receive a configuration of maximum percentage threshold message comprising an indication of a maximum percentage threshold for power consumption of the RIS.

Aspect 18. A method of wireless communication performed at a reconfigurable intelligent surface (RIS), the method comprising: receiving, by the RIS, a start RIS working mode configuration message comprising an indication to start a power saving mode; and configuring, by the RIS based on the power saving mode, a meta-element configuration for a plurality of meta-elements of the RIS from a set of meta-element configurations.

Aspect 19. The method of Aspect 18, further comprising transmitting, by the RIS, a capability report message.

Aspect 20. The method of Aspect 19, wherein the capability report message comprises an indication of whether the RIS is capable of operating in the power saving mode.

Aspect 21. The method of any of Aspects 19 or 20, wherein the capability report message further comprises an indication of at least one of a type of the power saving mode capable by the RIS or an effect of the power saving mode.

Aspect 22. The method of Aspect 21, wherein the type of the power saving mode is at least one of using partial meta-elements of the RIS or using partial configurations for the RIS.

Aspect 23. The method of any of Aspects 21 or 22, wherein the effect of the power saving mode is a percentage of power saved.

Aspect 24. The method of any of Aspects 18 to 23, wherein the meta-element configuration indicates, for each of the plurality of meta-elements of the RIS, at least one of a low number of PIN diodes with an on status or a low percentage of PIN diodes with an on status.

Aspect 25. The method of any of Aspects 18 to 24, further comprising receiving, by the RIS, a stop RIS working mode configuration message comprising an indication to stop the power saving mode.

Aspect 26. The method of Aspect 25, further comprising configuring, by the RIS, an additional meta-element configuration for the plurality of meta-elements of the RIS from a set of all possible meta-element configurations.

Aspect 27. The method of Aspect 26, wherein a number of PIN diodes with an on status in the meta-element configuration is lower than a number of PIN diodes with an on status in the additional meta-element configuration, or wherein a percentage of PIN diodes with an on status in the meta-element configuration is lower than a percentage of PIN diodes with an on status in the additional meta-element configuration.

Aspect 28. The method of any of Aspects 18 to 27, further comprising reflecting, using at least one meta-element of the plurality of meta-elements of the RIS, a sensing signal to produce a reflection sensing signal radiating in a direction towards a target object.

Aspect 29. The method of any of Aspects 18 to 28, further comprising reflecting, using at least one meta-element of the plurality of meta-elements of the RIS, a target reflection sensing signal to produce a RIS reflection sensing signal radiating in a direction towards a network device.

Aspect 30. The method of Aspect 29, wherein the network device is a base station.

Aspect 31. The method of any of Aspects 18 to 30, further comprising refracting, using at least one meta-element of the plurality of meta-elements of the RIS, a sensing signal to produce a refraction sensing signal radiating in a direction towards a target object.

Aspect 32. The method of any of Aspects 18 to 31, further comprising refracting, using at least one meta-element of the plurality of meta-elements of the RIS, a target reflection sensing signal to produce a RIS refraction sensing signal radiating in a direction towards a network device.

Aspect 33. The method of any of Aspects 18 to 32, further comprising transmitting, by the RIS, a report of power consumption value message comprising an indication of a power consumption value under a baseline of total consumed power of the RIS.

Aspect 34. The method of any of Aspects 18 to 33, further comprising receiving, by the RIS, a configuration of maximum percentage threshold message comprising an indication of a maximum percentage threshold for power consumption of the RIS.

Aspect 35. A network device for wireless communication, the network device comprising: at least one memory; and at least one processor coupled to the at least one memory and configured to: receive a capability report message from a reconfigurable intelligent surface (RIS); determine for the RIS to start a power saving mode based on the capability report message; and output for transmission a start RIS working mode configuration message comprising an indication to the RIS to start the power saving mode.

Aspect 36. The network device of Aspect 35, wherein the network device is a base station.

Aspect 37. The network device of any of Aspects 35 or 36, wherein the capability report message comprises an indication of whether the RIS is capable of operating in the power saving mode.

Aspect 38. The network device of any of Aspects 35 to 37, wherein the capability report message further comprises at least one of a type of the power saving mode or an effect of the power saving mode.

Aspect 39. The network device of any of Aspects 35 to 38, wherein the at least one processor is configured to output a sensing signal for transmission towards the RIS.

Aspect 40. The network device of any of Aspects 35 to 39, wherein the at least one processor is configured to receive a RIS reflection sensing signal from the RIS.

Aspect 41. The network device of any of Aspects 35 to 40, wherein the at least one processor is configured to output for transmission a stop RIS working mode configuration message comprising an indication to the RIS to stop the power saving mode.

Aspect 42. The network device of any of Aspects 35 to 41, wherein the at least one processor is configured to receive a report of power consumption value message comprising an indication of a power consumption value under a baseline of total consumed power of the RIS.

Aspect 43. The network device of any of Aspects 35 to 42, wherein the at least one processor is configured to output for transmission a configuration of maximum percentage threshold message comprising an indication of a maximum percentage threshold for power consumption of the RIS.

Aspect 44. A method of wireless communication performed at a network device, the method comprising: receiving, by the network device, a capability report message from a reconfigurable intelligent surface (RIS); determining, by the network device, for the RIS to start a power saving mode based on the capability report message; and transmitting, by the network device, a start RIS working mode configuration message comprising an indication to the RIS to start the power saving mode.

Aspect 45. The method of Aspect 44, wherein the network device is a base station.

Aspect 46. The method of any of Aspects 44 or 45, wherein the capability report message comprises an indication of whether the RIS is capable of operating in the power saving mode.

Aspect 47. The method of any of Aspects 44 to 46, wherein the capability report message further comprises at least one of a type of the power saving mode or an effect of the power saving mode.

Aspect 48. The method of any of Aspects 44 to 47, further comprising transmitting, by the network device, a sensing signal towards the RIS.

Aspect 49. The method of any of Aspects 44 to 48, further comprising receiving, by the network device, a RIS reflection sensing signal from the RIS.

Aspect 50. The method of any of Aspects 44 to 49, further comprising transmitting, by the network device, a stop RIS working mode configuration message comprising an indication to the RIS to stop the power saving mode.

Aspect 51. The method of any of Aspects 44 to 50, further comprising receiving, by the network device, a report of power consumption value message comprising an indication of a power consumption value under a baseline of total consumed power of the RIS.

Aspect 52. The method of any of Aspects 44 to 51, further comprising transmitting, by the network device, a configuration of maximum percentage threshold message comprising an indication of a maximum percentage threshold for power consumption of the RIS.

Aspect 53. A non-transitory computer-readable medium having stored thereon instructions that, when executed by one or more processors, cause the one or more processors to perform operations according to any of Aspects 18 to 34.

Aspect 54. An apparatus for wireless communication, the apparatus including one or more means for performing operations according to any of Aspects 18 to 34.

Aspect 55. A non-transitory computer-readable medium having stored thereon instructions that, when executed by one or more processors, cause the one or more processors to perform operations according to any of Aspects 44 to 52.

Aspect 56. An apparatus for wireless communication, the apparatus including one or more means for performing operations according to any of Aspects 44 to 52.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

1. A reconfigurable intelligent surface (RIS) for wireless communication, the RIS comprising:
at least one memory; and
at least one processor coupled to the at least one memory and configured to:
receive a start RIS working mode configuration message comprising an indication to start a power saving mode; and
configure, based on the power saving mode, a meta-element configuration for a plurality of meta-elements of the RIS from a set of meta-element configurations.

2. The RIS of claim 1, wherein the at least one processor is configured to output for transmission a capability report message that comprises an indication of whether the RIS is capable of operating in the power saving mode.

3. (canceled)

4. The RIS of claim 2, wherein the capability report message further comprises an indication of at least one of a type of the power saving mode capable by the RIS or an effect of the power saving mode.

5. The RIS of claim 4, wherein the type of the power saving mode is at least one of using partial meta-elements of the RIS or using partial configurations for the RIS.

6. The RIS of claim 1, wherein the meta-element configuration indicates, for each of the plurality of meta-elements of the RIS, at least one of a low number of PIN diodes with an on status or a low percentage of PIN diodes with an on status.

7. (canceled)

8. The RIS of claim 1, wherein the at least one processor is configured to configure an additional meta-element configuration for the plurality of meta-elements of the RIS from a set of all possible meta-element configurations, wherein a number of PIN diodes with an on status in the meta-element configuration is lower than a number of PIN diodes with an on status in the additional meta-element configuration, or wherein a percentage of PIN diodes with an on status in the meta-element configuration is lower than a percentage of PIN diodes with an on status in the additional meta-element configuration.

9. (canceled)

10. The RIS of claim 1, further comprising the plurality of meta-elements, wherein at least one meta-element of the plurality of meta-elements is configured to reflect a sensing signal to produce a reflection sensing signal radiating in a direction towards a target object, wherein at least one meta-element of the plurality of meta-elements is configured to reflect a target reflection sensing signal to produce a RIS reflection sensing signal radiating in a direction towards a network device.

11. (canceled)

12. The RIS of claim 1, further comprising the plurality of meta-elements, wherein at least one meta-element of the plurality of meta-elements is configured to refract a sensing signal to produce a refraction sensing signal radiating in a direction towards a target object.

13. (canceled)

14. The RIS of claim 1, wherein the at least one processor is configured to output for transmission a report of power consumption value message comprising an indication of a power consumption value under a baseline of total consumed power of the RIS.

15. The RIS of claim 1, wherein the at least one processor is configured to receive a configuration of maximum percentage threshold message comprising an indication of a maximum percentage threshold for power consumption of the RIS.

16. A method of wireless communication performed at a reconfigurable intelligent surface (RIS), the method comprising:
receiving, by the RIS, a start RIS working mode configuration message comprising an indication to start a power saving mode; and
configuring, by the RIS based on the power saving mode, a meta-element configuration for a plurality of meta-elements of the RIS from a set of meta-element configurations.

17. The method of claim 16, further comprising transmitting, by the RIS, a capability report message that comprises an indication of whether the RIS is capable of operating in the power saving mode.

18. (canceled)

19. The method of claim 17, wherein the capability report message further comprises an indication of at least one of a type of the power saving mode capable by the RIS or an effect of the power saving mode.

20. The method of claim 19, wherein the type of the power saving mode is at least one of using partial meta-elements of the RIS or using partial configurations for the RIS.

21. The method of claim 16, wherein the meta-element configuration indicates, for each of the plurality of meta-elements of the RIS, at least one of a low number of PIN diodes with an on status or a low percentage of PIN diodes with an on status.

22. (canceled)

23. The method of claim 16, further comprising configuring, by the RIS, an additional meta-element configuration for the plurality of meta-elements of the RIS from a set of all possible meta-element configurations, wherein a number of PIN diodes with an on status in the meta-element configuration is lower than a number of PIN diodes with an on status in the additional meta-element configuration, or wherein a percentage of PIN diodes with an on status in the meta-element configuration is lower than a percentage of PIN diodes with an on status in the additional meta-element configuration.

24. (canceled)

25. The method of claim 16, further comprising:
reflecting, using at least one meta-element of the plurality of meta-elements of the RIS, a sensing signal to produce a reflection sensing signal radiating in a direction towards a target object; and
reflecting, using at least one meta-element of the plurality of meta-elements of the RIS, a target reflection sensing signal to produce a RIS reflection sensing signal radiating in a direction towards a network device.

26. (canceled)

27. The method of claim 16, further comprising refracting, using at least one meta-element of the plurality of meta-elements of the RIS, a sensing signal to produce a refraction sensing signal radiating in a direction towards a target object.

28. (canceled)

29. The method of claim 16, further comprising transmitting, by the RIS, a report of power consumption value message comprising an indication of a power consumption value under a baseline of total consumed power of the RIS.

30. The method of claim 16, further comprising receiving, by the RIS, a configuration of maximum percentage threshold message comprising an indication of a maximum percentage threshold for power consumption of the RIS.
